(19) United States
(12) Patent Application Publication
(10) Pub. No.: US 2026/0127154 A1
(43) Pub. Date: May 7, 2026

(54) LOADING DATA VIA A DATABASE SYSTEM BASED ON IMPLEMENTING A CONTINUOUS PIPELINE

(71) Applicant: Ocient Holdings LLC, Chicago, IL (US)

(72) Inventors: Haoxuan Li, Westminster, CO (US); Owen Pang, Austin, TX (US); Thomas E. Smith, Ann Arbor, MI (US)

(73) Assignee: Ocient Holdings LLC, Chicago, IL (US)

(21) Appl. No.: 18/936,115

(22) Filed: Nov. 4, 2024

(51) Int. Cl. G06F 16/22; G06F 16/215; G06F 16/27

(52) U.S. Cl. CPC G06F 16/2282; G06F 16/215; G06F 16/278

(57) ABSTRACT

A database system is operable to load data for storage via the database system in conjunction with utilizing a continuous pipeline over a temporal period. An event monitor module is implemented based on executing a plurality of polls to a set of event topics of a set of other monitors over the temporal period to poll a plurality of sets of messages from the set of event topics and/or adding a plurality of file data to a table of files over the temporal period based on processing the plurality of sets of messages. A continuous pipeline task execution module is implemented to execute a continuous pipeline task based on dispersing file data of the table of files into a plurality of file work units over the temporal period and/or generating a plurality of extractor tasks to load the data for storage based on collectively processing the plurality of file work units.

### CROSS-REFERENCE TO RELATED APPLICATIONS

None

### STATEMENT REGARDING FEDERALLY SPONSORED RESEARCH OR DEVELOPMENT

Not Applicable.

### INCORPORATION-BY-REFERENCE OF MATERIAL SUBMITTED ON A COMPACT DISC

Not Applicable.

### BACKGROUND OF THE INVENTION

### Technical Field of the Invention

This invention relates generally to computer networking and more particularly to database system and operation.

### Description of Related Art

Computing devices are known to communicate data, process data, and/or store data. Such computing devices range from wireless smart phones, laptops, tablets, personal computers (PC), work stations, and video game devices, to data centers that support millions of web searches, stock trades, or on-line purchases every day. In general, a computing device includes a central processing unit (CPU), a memory system, user input/output interfaces, peripheral device interfaces, and an interconnecting bus structure.

As is further known, a computer may effectively extend its CPU by using “cloud computing” to perform one or more computing functions (e.g., a service, an application, an algorithm, an arithmetic logic function, etc.) on behalf of the computer. Further, for large services, applications, and/or functions, cloud computing may be performed by multiple cloud computing resources in a distributed manner to improve the response time for completion of the service, application, and/or function.

Of the many applications a computer can perform, a database system is one of the largest and most complex applications. In general, a database system stores a large amount of data in a particular way for subsequent processing. In some situations, the hardware of the computer is a limiting factor regarding the speed at which a database system can process a particular function. In some other instances, the way in which the data is stored is a limiting factor regarding the speed of execution. In yet some other instances, restricted co-process options are a limiting factor regarding the speed of execution.

### BRIEF DESCRIPTION OF THE SEVERAL VIEWS OF THE DRAWING(S)

FIG. 1 is a schematic block diagram of an embodiment of a large scale data processing network that includes a database system in accordance with various embodiments;

FIG. 1A is a schematic block diagram of an embodiment of a database system in accordance with various embodiments;

FIG. 2 is a schematic block diagram of an embodiment of an administrative sub-system in accordance with various embodiments;

FIG. 3 is a schematic block diagram of an embodiment of a configuration sub-system in accordance with various embodiments;

FIG. 4 is a schematic block diagram of an embodiment of a parallelized data input sub-system in accordance with various embodiments;

FIG. 5 is a schematic block diagram of an embodiment of a parallelized query and response (Q&R) sub-system in accordance with various embodiments;

FIG. 6 is a schematic block diagram of an embodiment of a parallelized data store, retrieve, and/or process (IO& P) sub-system in accordance with various embodiments;

FIG. 7 is a schematic block diagram of an embodiment of a computing device in accordance with various embodiments;

FIG. 8 is a schematic block diagram of another embodiment of a computing device in accordance with various embodiments;

FIG. 9 is a schematic block diagram of another embodiment of a computing device in accordance with various embodiments;

FIG. 10 is a schematic block diagram of an embodiment of a node of a computing device in accordance with various embodiments;

FIG. 11 is a schematic block diagram of an embodiment of a node of a computing device in accordance with various embodiments;

FIG. 12 is a schematic block diagram of an embodiment of a node of a computing device in accordance with various embodiments;

FIG. 13 is a schematic block diagram of an embodiment of a node of a computing device in accordance with various embodiments;

FIG. 14 is a schematic block diagram of an embodiment of operating systems of a computing device in accordance with various embodiments;

FIGS. 15-23 are schematic block diagrams of an example of processing a table or data set for storage in the database system in accordance with various embodiments;

FIG. 24A is a schematic block diagram of a query execution plan implemented via a plurality of nodes in accordance with various embodiments;

FIGS. 24B-24D are schematic block diagrams of embodiments of a node that implements a query processing module in accordance with various embodiments;

FIG. 24E is an embodiment is schematic block diagrams illustrating a plurality of nodes that communicate via shuffle networks in accordance with various embodiments;

FIG. 24F is a schematic block diagram of a database system communicating with an external requesting entity in accordance with various embodiments;

FIG. 24G is a schematic block diagram of a query processing system in accordance with various embodiments;

FIG. 24H is a schematic block diagram of a query operator execution flow in accordance with various embodiments;

FIG. 24I is a schematic block diagram of a plurality of nodes that utilize query operator execution flows in accordance with various embodiments;

FIG. 24J is a schematic block diagram of a query execution module that executes a query operator execution flow via a plurality of corresponding operator execution modules in accordance with various embodiments;

FIG. 24K illustrates an example embodiment of a plurality of database tables stored in database storage in accordance with various embodiments;

FIG. 24L illustrates an example embodiment of a dataset stored in database storage that includes at least one array field in accordance with various embodiments;

FIG. 24M is a schematic block diagram of a query execution module that implements a plurality of column data streams in accordance with various embodiments;

FIG. 24N illustrates example data blocks of a column data stream in accordance with various embodiments;

FIG. 24O is a schematic block diagram of a query execution module illustrating writing and processing of data blocks by operator execution modules in accordance with various embodiments;

FIG. 24P is a schematic block diagram of a database system that implements a segment generator that generates segments from a plurality of records in accordance with various embodiments;

FIG. 24Q is a schematic block diagram of a segment generator that implements a cluster key-based grouping module, a columnar rotation module, and a metadata generator module in accordance with various embodiments;

FIG. 24R is a schematic block diagram of a query processing system that generates and executes a plurality of IO pipelines to generate filtered records sets from a plurality of segments in conjunction with executing a query in accordance with various embodiments;

FIG. 24S is a schematic block diagram of a query processing system that generates an IO pipeline for accessing a corresponding segment based on predicates of a query in accordance with various embodiments;

FIG. 24T is a schematic block diagram of a database system that includes a plurality of storage clusters that each mediate cluster state data via a plurality of nodes in accordance with a consensus protocol in accordance with various embodiments;

FIG. 24U is a schematic block diagram of a database system that implements a compressed column filter conversion module based on accessing a dictionary structure in accordance with various embodiments;

FIG. 24V is a schematic block diagram of a query execution module that implements a Global Dictionary Compression join via access to a dictionary structure in accordance with various embodiments;

FIG. 24W is a schematic block diagram illustrating communication between database system 10 and a plurality of user entities in accordance with various embodiments;

FIG. 24X is a schematic block diagram of a database system implementing a loading process in accordance with various embodiments;

FIGS. 25A-25B are schematic block diagrams of a database system implementing at least one loading process in accordance with various embodiments;

FIG. 25C is a logic diagram illustrating a method for execution in accordance with various embodiments;

FIG. 26A is a schematic block diagram of a database system implementing a request processing module in accordance with various embodiments;

FIG. 26B illustrates example create continuous pipeline function definition data in accordance with various embodiments;

FIGS. 26C-26D illustrate example parameters of an example parameter set of create continuous pipeline function definition data in accordance with various embodiments;

FIG. 26E is a logic diagram illustrating a method for execution in accordance with various embodiments;

FIG. 27A is a schematic block diagram of a database system that implements at least one system table populator module to populate at least one table stored in system table memory resources in accordance with various embodiments;

FIG. 27B illustrates an example embodiment of a loading tracking table in accordance with various embodiments;

FIG. 27C illustrates an example embodiment of an error tracking table in accordance with various embodiments;

FIG. 27D is a schematic block diagram of a database system that implements a request processing module in accordance with various embodiments; and

FIG. 27E is a logic diagram illustrating a method for execution in accordance with various embodiments.

### DETAILED DESCRIPTION OF THE INVENTION

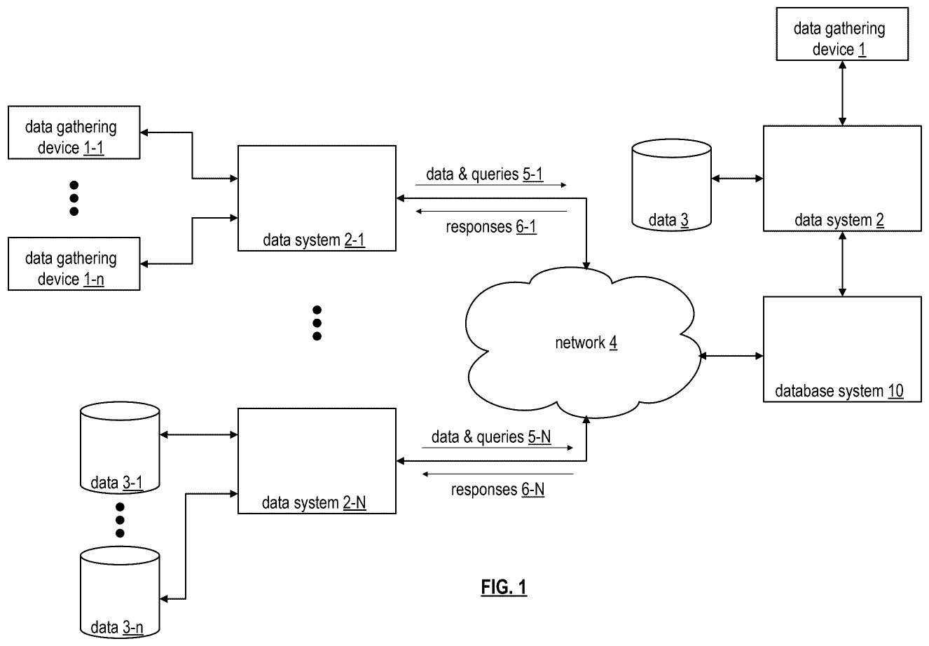

FIG. 1 is a schematic block diagram of an embodiment of a large-scale data processing network that includes data gathering devices (1, 1-1 through 1-n), data systems (2, 2-1 through 2-N), data storage systems (3, 3-1 through 3-n), a network 4, and a database system 10. The data gathering devices are computing devices that collect a wide variety of data and may further include sensors, monitors, measuring instruments, and/or other instrument for collecting data. The data gathering devices collect data in real-time (i.e., as it is happening) and provides it to data system 2-1 for storage and real-time processing of queries 5-1 to produce responses 6-1. As an example, the data gathering devices are computing in a factory collecting data regarding manufacturing of one or more products and the data system is evaluating queries to determine manufacturing efficiency, quality control, and/or product development status.

The data storage systems 3 store existing data. The existing data may originate from the data gathering devices or other sources, but the data is not real time data. For example, the data storage system stores financial data of a bank, a credit card company, or like financial institution. The data system 2-N processes queries 5-N regarding the data stored in the data storage systems to produce responses 6-N.

Data system 2 processes queries regarding real time data from data gathering devices and/or queries regarding non-real time data stored in the data storage system 3. The data system 2 produces responses in regard to the queries. Storage of real time and non-real time data, the processing of queries, and the generating of responses will be discussed with reference to one or more of the subsequent figures.

FIG. 1A is a schematic block diagram of an embodiment of a database system 10 that includes a parallelized data input sub-system 11, a parallelized data store, retrieve, and/or process sub-system 12, a parallelized query and response sub-system 13, system communication resources 14, an administrative sub-system 15, and a configuration sub-system 16. The system communication resources 14 include one or more of wide area network (WAN) connections, local area network (LAN) connections, wireless connections, wireline connections, etc. to couple the sub-systems 11, 12, 13, 15, and 16 together.

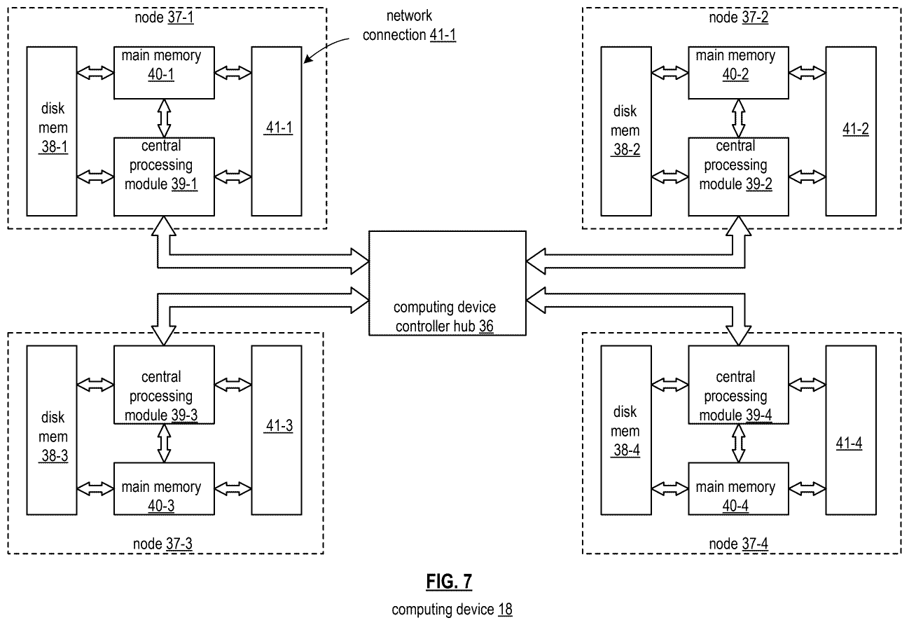

Each of the sub-systems 11, 12, 13, 15, and 16 include a plurality of computing devices; an example of which is discussed with reference to one or more of FIGS. 7-9. Hereafter, the parallelized data input sub-system 11 may also be referred to as a data input sub-system, the parallelized data store, retrieve, and/or process sub-system may also be referred to as a data storage and processing sub-system, and the parallelized query and response sub-system 13 may also be referred to as a query and results sub-system.

In an example of operation, the parallelized data input sub-system 11 receives a data set (e.g., a table) that includes a plurality of records. A record includes a plurality of data fields. As a specific example, the data set includes tables of data from a data source. For example, a data source includes one or more computers. As another example, the data source is a plurality of machines. As yet another example, the data source is a plurality of data mining algorithms operating on one or more computers.

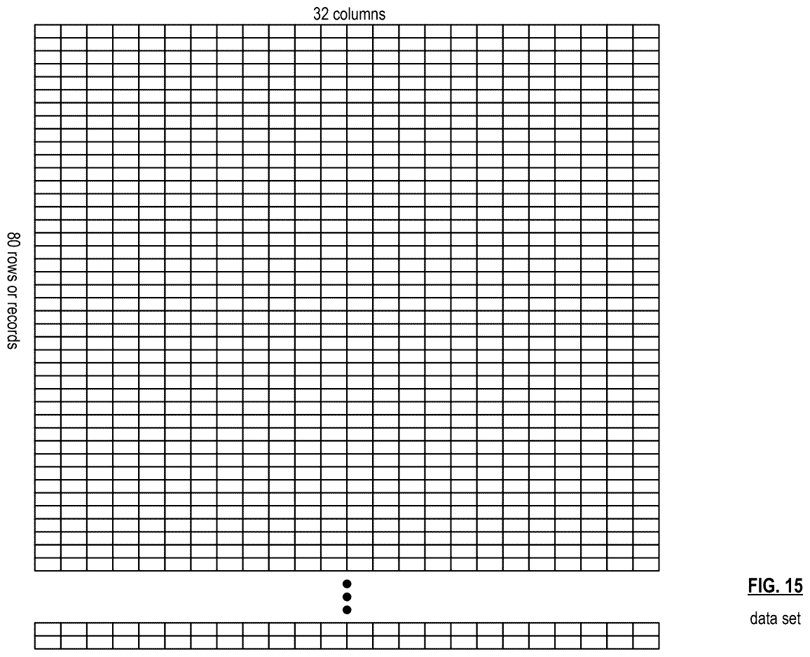

As is further discussed with reference to FIG. 15, the data source organizes its records of the data set into a table that includes rows and columns. The columns represent data fields of data for the rows. Each row corresponds to a record of data. For example, a table includes payroll information for a company's employees. Each row is an employee's payroll record. The columns include data fields for employee name, address, department, annual salary, tax deduction information, direct deposit information, etc.

The parallelized data input sub-system 11 processes a table to determine how to store it. For example, the parallelized data input sub-system 11 divides the data set into a plurality of data partitions. For each partition, the parallelized data input sub-system 11 divides it into a plurality of data segments based on a segmenting factor. The segmenting factor includes a variety of approaches of dividing a partition into segments. For example, the segment factor indicates a number of records to include in a segment. As another example, the segmenting factor indicates a number of segments to include in a segment group. As another example, the segmenting factor identifies how to segment a data partition based on storage capabilities of the data store and processing sub-system. As a further example, the segmenting factor indicates how many segments for a data partition based on a redundancy storage encoding scheme.

As an example of dividing a data partition into segments based on a redundancy storage encoding scheme, assume that it includes a 4 of 5 encoding scheme (meaning any 4 of 5 encoded data elements can be used to recover the data). Based on these parameters, the parallelized data input sub-system 11 divides a data partition into 5 segments: one corresponding to each of the data elements).

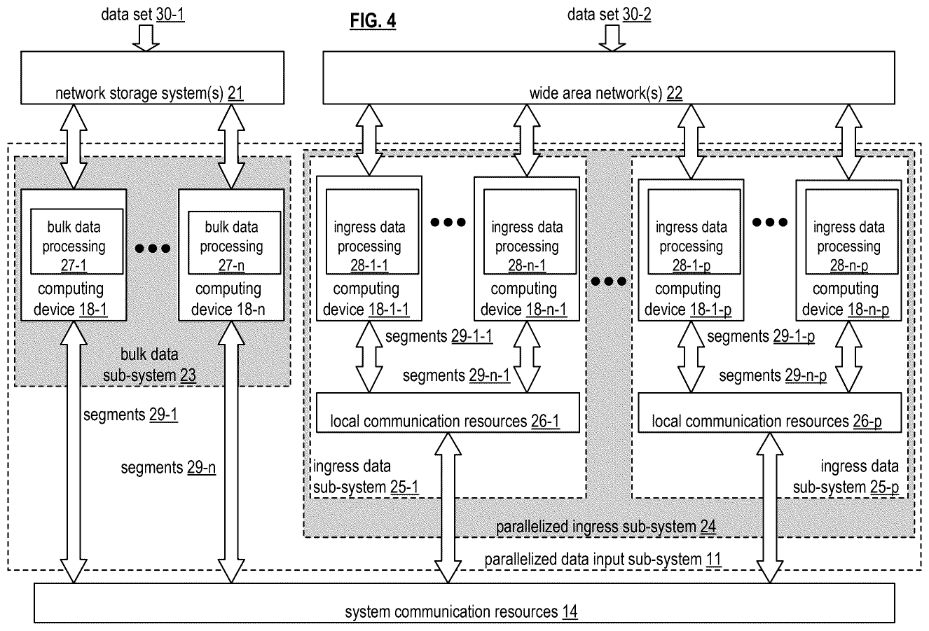

The parallelized data input sub-system 11 restructures the plurality of data segments to produce restructured data segments. For example, the parallelized data input sub-system 11 restructures records of a first data segment of the plurality of data segments based on a key field of the plurality of data fields to produce a first restructured data segment. The key field is common to the plurality of records. As a specific example, the parallelized data input sub-system 11 restructures a first data segment by dividing the first data segment into a plurality of data slabs (e.g., columns of a segment of a partition of a table). Using one or more of the columns as a key, or keys, the parallelized data input sub-system 11 sorts the data slabs. The restructuring to produce the data slabs is discussed in greater detail with reference to FIG. 4 and FIGS. 16-18.

The parallelized data input sub-system 11 also generates storage instructions regarding how sub-system 12 is to store the restructured data segments for efficient processing of subsequently received queries regarding the stored data. For example, the storage instructions include one or more of a naming scheme, a request to store, a memory resource requirement, a processing resource requirement, an expected access frequency level, an expected storage duration, a required maximum access latency time, and other requirements associated with storage, processing, and retrieval of data.

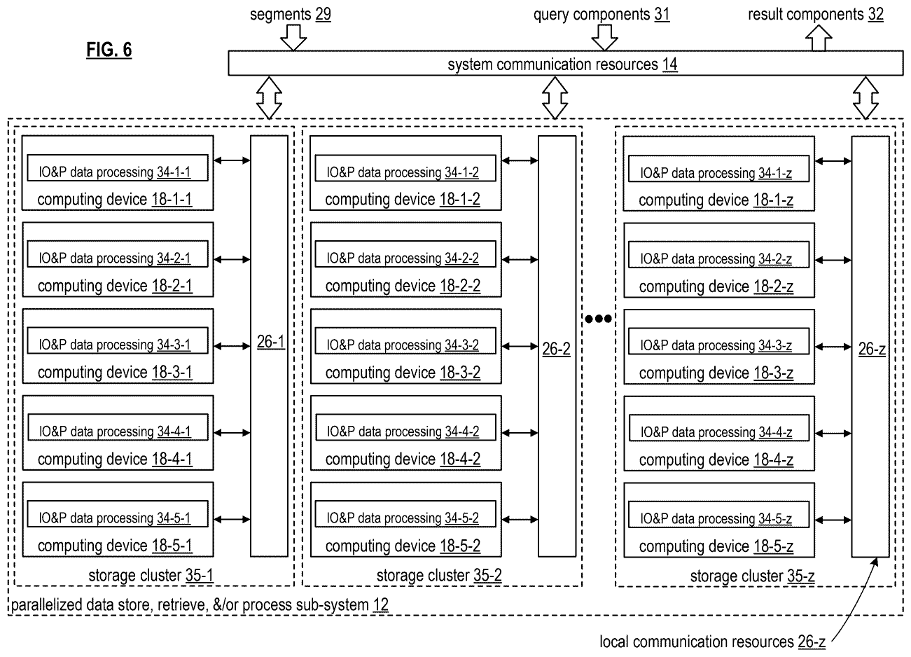

A designated computing device of the parallelized data store, retrieve, and/or process sub-system 12 receives the restructured data segments and the storage instructions. The designated computing device (which is randomly selected, selected in a round robin manner, or by default) interprets the storage instructions to identify resources (e.g., itself, its components, other computing devices, and/or components thereof) within the computing device's storage cluster. The designated computing device then divides the restructured data segments of a segment group of a partition of a table into segment divisions based on the identified resources and/or the storage instructions. The designated computing device then sends the segment divisions to the identified resources for storage and subsequent processing in accordance with a query. The operation of the parallelized data store, retrieve, and/or process sub-system 12 is discussed in greater detail with reference to FIG. 6.

The parallelized query and response sub-system 13 receives queries regarding tables (e.g., data sets) and processes the queries prior to sending them to the parallelized data store, retrieve, and/or process sub-system 12 for execution. For example, the parallelized query and response sub-system 13 generates an initial query plan based on a data processing request (e.g., a query) regarding a data set (e.g., the tables). Sub-system 13 optimizes the initial query plan based on one or more of the storage instructions, the engaged resources, and optimization functions to produce an optimized query plan.

For example, the parallelized query and response sub-system 13 receives a specific query no. 1 regarding the data set no. 1 (e.g., a specific table). The query is in a standard query format such as Open Database Connectivity (ODBC), Java Database Connectivity (JDBC), and/or SPARK. The query is assigned to a node within the parallelized query and response sub-system 13 for processing. The assigned node identifies the relevant table, determines where and how it is stored, and determines available nodes within the parallelized data store, retrieve, and/or process sub-system 12 for processing the query.

In addition, the assigned node parses the query to create an abstract syntax tree. As a specific example, the assigned node converts an SQL (Structured Query Language) statement into a database instruction set. The assigned node then validates the abstract syntax tree. If not valid, the assigned node generates an SQL exception, determines an appropriate correction, and repeats. When the abstract syntax tree is validated, the assigned node then creates an annotated abstract syntax tree. The annotated abstract syntax tree includes the verified abstract syntax tree plus annotations regarding column names, data type(s), data aggregation or not, correlation or not, sub-query or not, and so on.

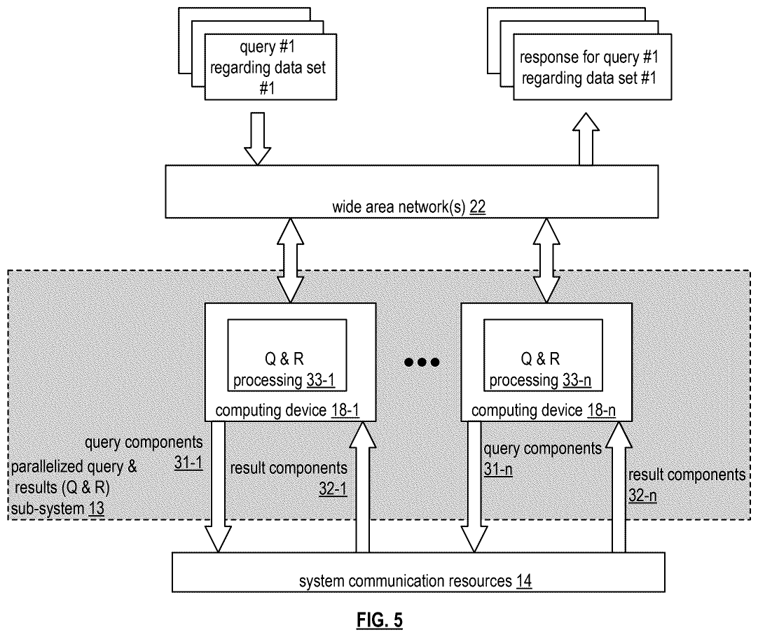

The assigned node then creates an initial query plan from the annotated abstract syntax tree. The assigned node optimizes the initial query plan using a cost analysis function (e.g., processing time, processing resources, etc.) and/or other optimization functions. Having produced the optimized query plan, the parallelized query and response sub-system 13 sends the optimized query plan to the parallelized data store, retrieve, and/or process sub-system 12 for execution. The operation of the parallelized query and response sub-system 13 is discussed in greater detail with reference to FIG. 5.

The parallelized data store, retrieve, and/or process sub-system 12 executes the optimized query plan to produce resultants and sends the resultants to the parallelized query and response sub-system 13. Within the parallelized data store, retrieve, and/or process sub-system 12, a computing device is designated as a primary device for the query plan (e.g., optimized query plan) and receives it. The primary device processes the query plan to identify nodes within the parallelized data store, retrieve, and/or process sub-system 12 for processing the query plan. The primary device then sends appropriate portions of the query plan to the identified nodes for execution. The primary device receives responses from the identified nodes and processes them in accordance with the query plan.

The primary device of the parallelized data store, retrieve, and/or process sub-system 12 provides the resulting response (e.g., resultants) to the assigned node of the parallelized query and response sub-system 13. For example, the assigned node determines whether further processing is needed on the resulting response (e.g., joining, filtering, etc.). If not, the assigned node outputs the resulting response as the response to the query (e.g., a response for query no. 1 regarding data set no. 1). If, however, further processing is determined, the assigned node further processes the resulting response to produce the response to the query. Having received the resultants, the parallelized query and response sub-system 13 creates a response from the resultants for the data processing request.

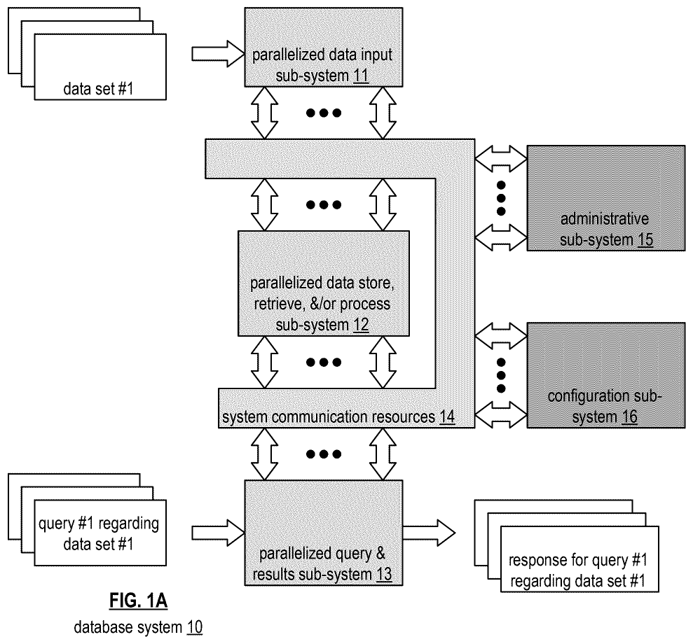

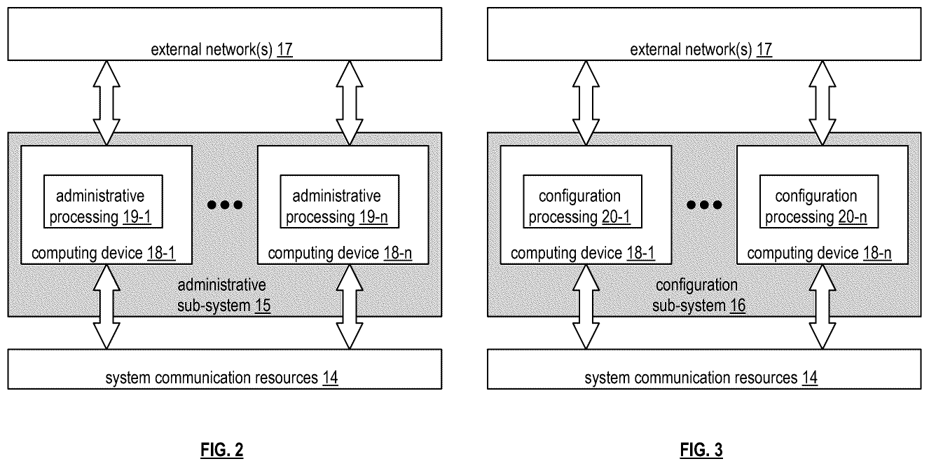

FIG. 2 is a schematic block diagram of an embodiment of the administrative sub-system 15 of FIG. 1A that includes one or more computing devices 18-1 through 18-n. Each of the computing devices executes an administrative processing function utilizing a corresponding administrative processing of administrative processing 19-1 through 19-n (which includes a plurality of administrative operations) that coordinates system level operations of the database system. Each computing device is coupled to an external network 17, or networks, and to the system communication resources 14 of FIG. 1A.

As will be described in greater detail with reference to one or more subsequent figures, a computing device includes a plurality of nodes and each node includes a plurality of processing core resources. Each processing core resource is capable of executing at least a portion of an administrative operation independently. This supports lock free and parallel execution of one or more administrative operations.

The administrative sub-system 15 functions to store metadata of the data set described with reference to FIG. 1A. For example, the storing includes generating the metadata to include one or more of an identifier of a stored table, the size of the stored table (e.g., bytes, number of columns, number of rows, etc.), labels for key fields of data segments, a data type indicator, the data owner, access permissions, available storage resources, storage resource specifications, software for operating the data processing, historical storage information, storage statistics, stored data access statistics (e.g., frequency, time of day, accessing entity identifiers, etc.) and any other information associated with optimizing operation of the database system 10.

FIG. 3 is a schematic block diagram of an embodiment of the configuration sub-system 16 of FIG. 1A that includes one or more computing devices 18-1 through 18-n. Each of the computing devices executes a configuration processing function 20-1 through 20-n (which includes a plurality of configuration operations) that coordinates system level configurations of the database system. Each computing device is coupled to the external network 17 of FIG. 2, or networks, and to the system communication resources 14 of FIG. 1A.

FIG. 4 is a schematic block diagram of an embodiment of the parallelized data input sub-system 11 of FIG. 1A that includes a bulk data sub-system 23 and a parallelized ingress sub-system 24. The bulk data sub-system 23 includes a plurality of computing devices 18-1 through 18-n. A computing device includes a bulk data processing function (e.g., 27-1) for receiving a table from a network storage system 21 (e.g., a server, a cloud storage service, etc.) and processing it for storage as generally discussed with reference to FIG. 1A.

The parallelized ingress sub-system 24 includes a plurality of ingress data sub-systems 25-1 through 25-p that each include a local communication resource of local communication resources 26-1 through 26-p and a plurality of computing devices 18-1 through 18-n. A computing device executes an ingress data processing function (e.g., 28-1) to receive streaming data regarding a table via a wide area network 22 and processing it for storage as generally discussed with reference to FIG. 1A. With a plurality of ingress data sub-systems 25-1 through 25-p, data from a plurality of tables can be streamed into the database system 10 at one time.

In general, the bulk data processing function is geared towards receiving data of a table in a bulk fashion (e.g., the table exists and is being retrieved as a whole, or portion thereof). The ingress data processing function is geared towards receiving streaming data from one or more data sources (e.g., receive data of a table as the data is being generated). For example, the ingress data processing function is geared towards receiving data from a plurality of machines in a factory in a periodic or continual manner as the machines create the data.

FIG. 5 is a schematic block diagram of an embodiment of a parallelized query and results sub-system 13 that includes a plurality of computing devices 18-1 through 18-n. Each of the computing devices executes a query (Q) & response (R) processing function 33-1 through 33-n. The computing devices are coupled to the wide area network 22 to receive queries (e.g., query no. 1 regarding data set no. 1) regarding tables and to provide responses to the queries (e.g., response for query no. 1 regarding the data set no. 1). For example, a computing device (e.g., 18-1) receives a query, creates an initial query plan therefrom, and optimizes it to produce an optimized plan. The computing device then sends components (e.g., one or more operations) of the optimized plan to the parallelized data store, retrieve, &/or process sub- system 12.

Processing resources of the parallelized data store, retrieve, &/or process sub system 12 processes the components of the optimized plan to produce results components 32-1 through 32-n. The computing device of the Q&R sub-system 13 processes the result components to produce a query response.

The Q&R sub-system 13 allows for multiple queries regarding one or more tables to be processed concurrently. For example, a set of processing core resources of a computing device (e.g., one or more processing core resources) processes a first query and a second set of processing core resources of the computing device (or a different computing device) processes a second query.

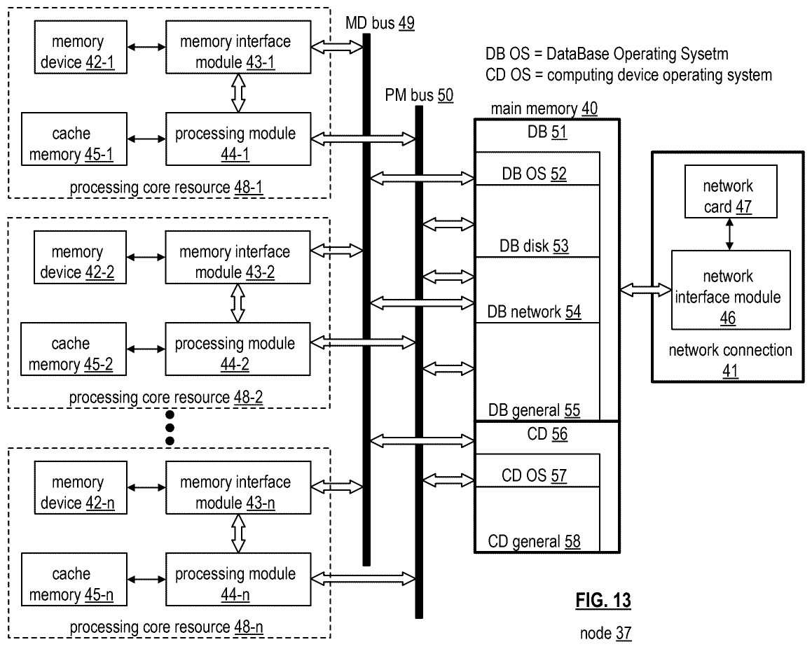

As will be described in greater detail with reference to one or more subsequent figures, a computing device includes a plurality of nodes and each node includes multiple processing core resources such that a plurality of computing devices includes pluralities of multiple processing core resources A processing core resource of the pluralities of multiple processing core resources generates the optimized query plan and other processing core resources of the pluralities of multiple processing core resources generates other optimized query plans for other data processing requests. Each processing core resource is capable of executing at least a portion of the Q & R function. In an embodiment, a plurality of processing core resources of one or more nodes executes the Q & R function to produce a response to a query. The processing core resource is discussed in greater detail with reference to FIG. 13.

FIG. 6 is a schematic block diagram of an embodiment of a parallelized data store, retrieve, and/or process sub-system 12 that includes a plurality of computing devices, where each computing device includes a plurality of nodes and each node includes multiple processing core resources. Each processing core resource is capable of executing at least a portion of the function of the parallelized data store, retrieve, and/or process sub-system 12. The plurality of computing devices is arranged into a plurality of storage clusters. Each storage cluster includes a number of computing devices.

In an embodiment, the parallelized data store, retrieve, and/or process sub-system 12 includes a plurality of storage clusters 35-1 through 35-z. Each storage cluster includes a corresponding local communication resource 26-1 through 26-z and a number of computing devices 18-1 through 18-5. Each computing device executes an input, output, and processing (IO &P) processing function 34-1 through 34-5 to store and process data.

The number of computing devices in a storage cluster corresponds to the number of segments (e.g., a segment group) in which a data partitioned is divided. For example, if a data partition is divided into five segments, a storage cluster includes five computing devices. As another example, if the data is divided into eight segments, then there are eight computing devices in the storage clusters.

To store a segment group of segments 29 within a storage cluster, a designated computing device of the storage cluster interprets storage instructions to identify computing devices (and/or processing core resources thereof) for storing the segments to produce identified engaged resources. The designated computing device is selected by a random selection, a default selection, a round-robin selection, or any other mechanism for selection.

The designated computing device sends a segment to each computing device in the storage cluster, including itself. Each of the computing devices stores their segment of the segment group. As an example, five segments 29 of a segment group are stored by five computing devices of storage cluster 35-1. The first computing device 18-1-1 stores a first segment of the segment group; a second computing device 18-2-1 stores a second segment of the segment group; and so on. With the segments stored, the computing devices are able to process queries (e.g., query components from the Q&R sub-system 13) and produce appropriate result components.

While storage cluster 35-1 is storing and/or processing a segment group, the other storage clusters 35-2 through 35-n are storing and/or processing other segment groups. For example, a table is partitioned into three segment groups. Three storage clusters store and/or process the three segment groups independently. As another example, four tables are independently stored and/or processed by one or more storage clusters. As yet another example, storage cluster 35-1 is storing and/or processing a second segment group while it is storing/or and processing a first segment group.

FIG. 7 is a schematic block diagram of an embodiment of a computing device 18 that includes a plurality of nodes 37-1 through 37-4 coupled to a computing device controller hub 36. The computing device controller hub 36 includes one or more of a chipset, a quick path interconnect (QPI), and an ultra path interconnection (UPI). Each node 37-1 through 37-4 includes a central processing module 39-1 through 39-4, a main memory 40-1 through 40-4 (e.g., volatile memory), a disk memory 38-1 through 38-4 (non-volatile memory), and a network connection 41-1 through 41-4. In an alternate configuration, the nodes share a network connection, which is coupled to the computing device controller hub 36 or to one of the nodes as illustrated in subsequent figures.

In an embodiment, each node is capable of operating independently of the other nodes. This allows for large scale parallel operation of a query request, which significantly reduces processing time for such queries. In another embodiment, one or more node function as co-processors to share processing requirements of a particular function, or functions.

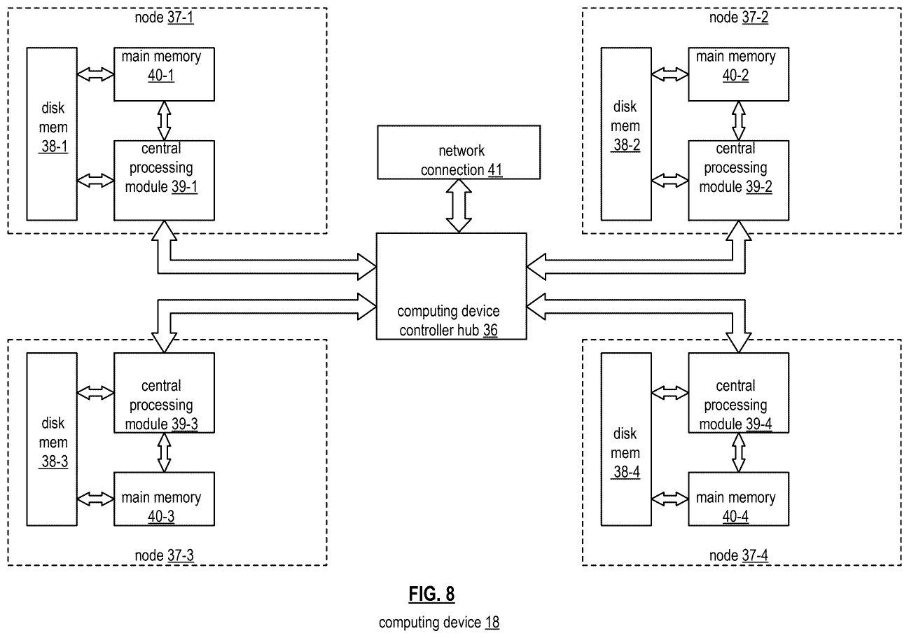

FIG. 8 is a schematic block diagram of another embodiment of a computing device similar to the computing device of FIG. 7 with an exception that it includes a single network connection 41, which is coupled to the computing device controller hub 36. As such, each node coordinates with the computing device controller hub to transmit or receive data via the network connection.

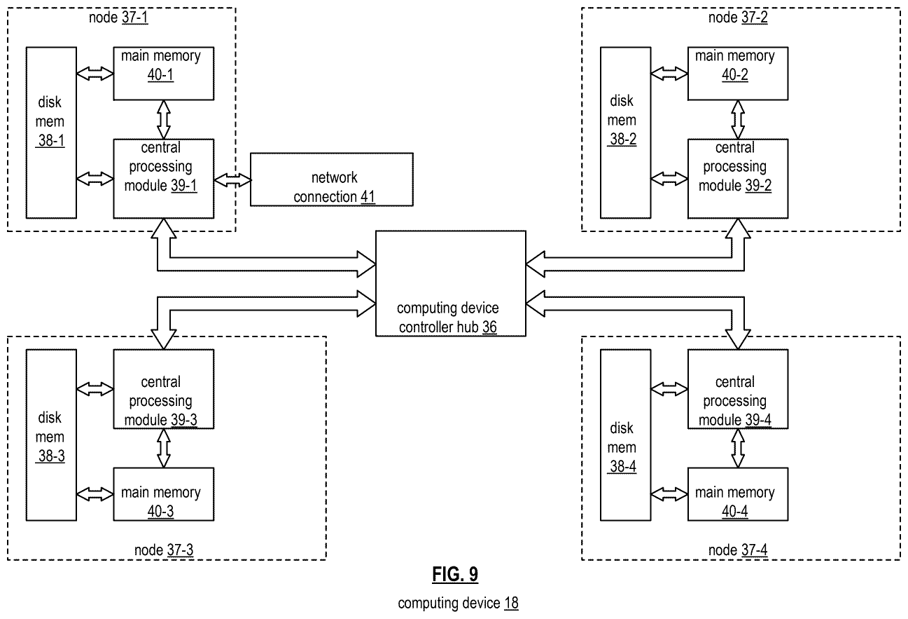

FIG. 9 is a schematic block diagram of another embodiment of a computing device is similar to the computing device of FIG. 7 with an exception that it includes a single network connection 41, which is coupled to a central processing module of a node (e.g., to central processing module 39-1 of node 37-1). As such, each node coordinates with the central processing module via the computing device controller hub 36 to transmit or receive data via the network connection.

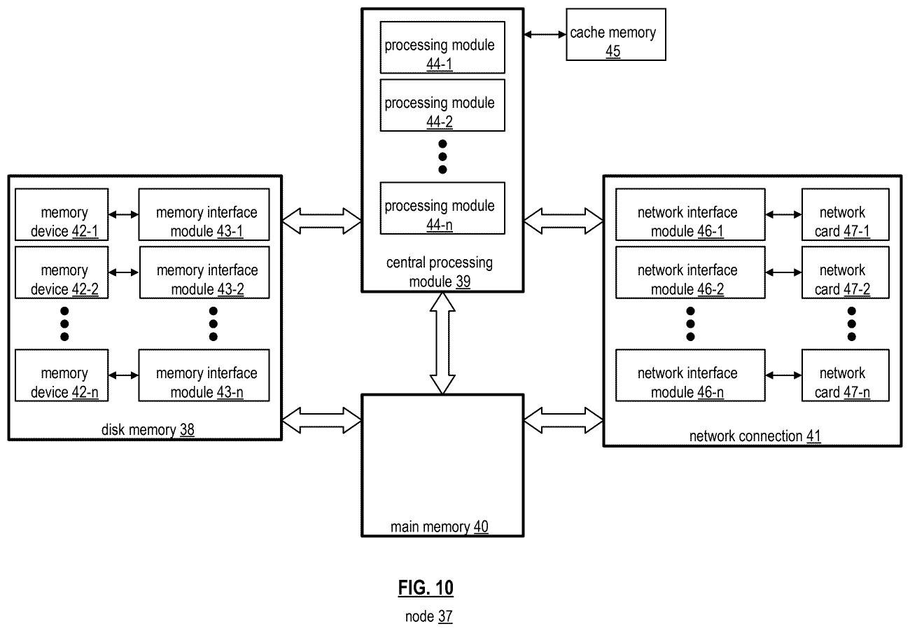

FIG. 10 is a schematic block diagram of an embodiment of a node 37 of computing device 18. The node 37 includes the central processing module 39, the main memory 40, the disk memory 38, and the network connection 41. The main memory 40 includes read only memory (RAM) and/or other form of volatile memory for storage of data and/or operational instructions of applications and/or of the operating system. The central processing module 39 includes a plurality of processing modules 44-1 through 44-n and an associated one or more cache memory 45. A processing module is as defined at the end of the detailed description.

The disk memory 38 includes a plurality of memory interface modules 43-1 through 43-n and a plurality of memory devices 42-1 through 42-n (e.g., non-volatile memory). The memory devices 42-1 through 42-n include, but are not limited to, solid state memory, disk drive memory, cloud storage memory, and other non-volatile memory. For each type of memory device, a different memory interface module 43-1 through 43-n is used. For example, solid state memory uses a standard, or serial, ATA (SATA), variation, or extension thereof, as its memory interface. As another example, disk drive memory devices use a small computer system interface (SCSI), variation, or extension thereof, as its memory interface.

In an embodiment, the disk memory 38 includes a plurality of solid state memory devices and corresponding memory interface modules. In another embodiment, the disk memory 38 includes a plurality of solid state memory devices, a plurality of disk memories, and corresponding memory interface modules.

The network connection 41 includes a plurality of network interface modules 46-1 through 46-n and a plurality of network cards 47-1 through 47-n. A network card includes a wireless LAN (WLAN) device (e.g., an IEEE 802.11n or another protocol), a LAN device (e.g., Ethernet), a cellular device (e.g., CDMA), etc. The corresponding network interface modules 46-1 through 46-n include a software driver for the corresponding network card and a physical connection that couples the network card to the central processing module 39 or other component(s) of the node.

The connections between the central processing module 39, the main memory 40, the disk memory 38, and the network connection 41 may be implemented in a variety of ways. For example, the connections are made through a node controller (e.g., a local version of the computing device controller hub 36). As another example, the connections are made through the computing device controller hub 36.

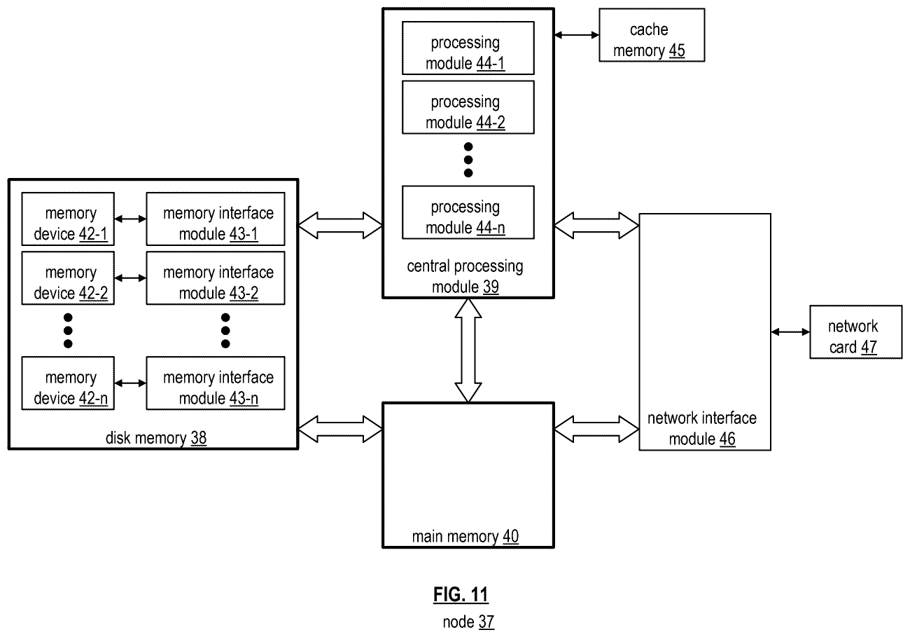

FIG. 11 is a schematic block diagram of an embodiment of a node 37 of a computing device 18 that is similar to the node of FIG. 10, with a difference in the network connection. In this embodiment, the node 37 includes a single network interface module 46 and a corresponding network card 47 configuration.

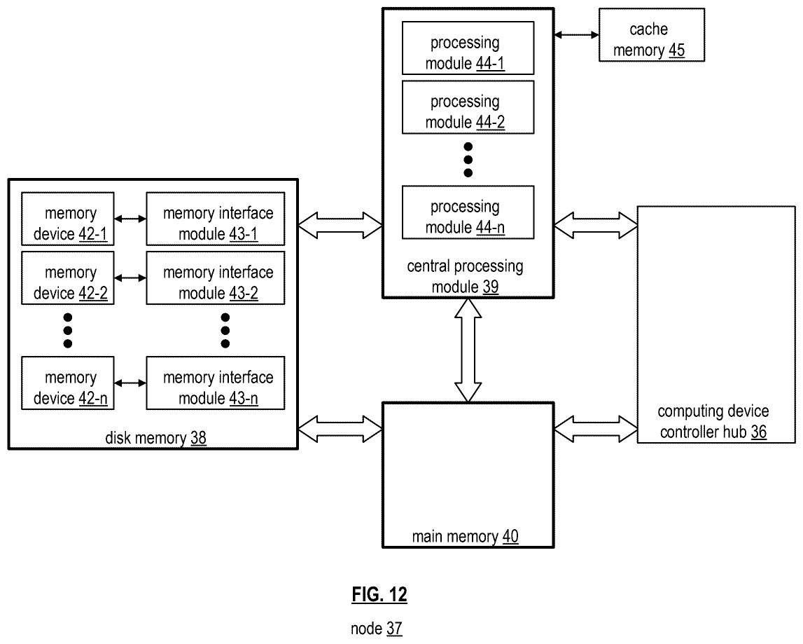

FIG. 12 is a schematic block diagram of an embodiment of a node 37 of a computing device 18 that is similar to the node of FIG. 10, with a difference in the network connection. In this embodiment, the node 37 connects to a network connection via the computing device controller hub 36.

FIG. 13 is a schematic block diagram of another embodiment of a node 37 of computing device 18 that includes processing core resources 48-1 through 48-n, a memory device (MD) bus 49, a processing module (PM) bus 50, a main memory 40 and a network connection 41. The network connection 41 includes the network card 47 and the network interface module 46 of FIG. 10. Each processing core resource 48 includes a corresponding processing module 44-1 through 44-n, a corresponding memory interface module 43-1 through 43-n, a corresponding memory device 42-1 through 42-n, and a corresponding cache memory 45-1 through 45-n. In this configuration, each processing core resource can operate independently of the other processing core resources. This further supports increased parallel operation of database functions to further reduce execution time.

The main memory 40 is divided into a computing device (CD) 56 section and a database (DB) 51 section. The database section includes a database operating system (OS) area 52, a disk area 53, a network area 54, and a general area 55. The computing device section includes a computing device operating system (OS) area 57 and a general area 58. Note that each section could include more or less allocated areas for various tasks being executed by the database system.

In general, the database OS 52 allocates main memory for database operations. Once allocated, the computing device OS 57 cannot access that portion of the main memory 40. This supports lock free and independent parallel execution of one or more operations.

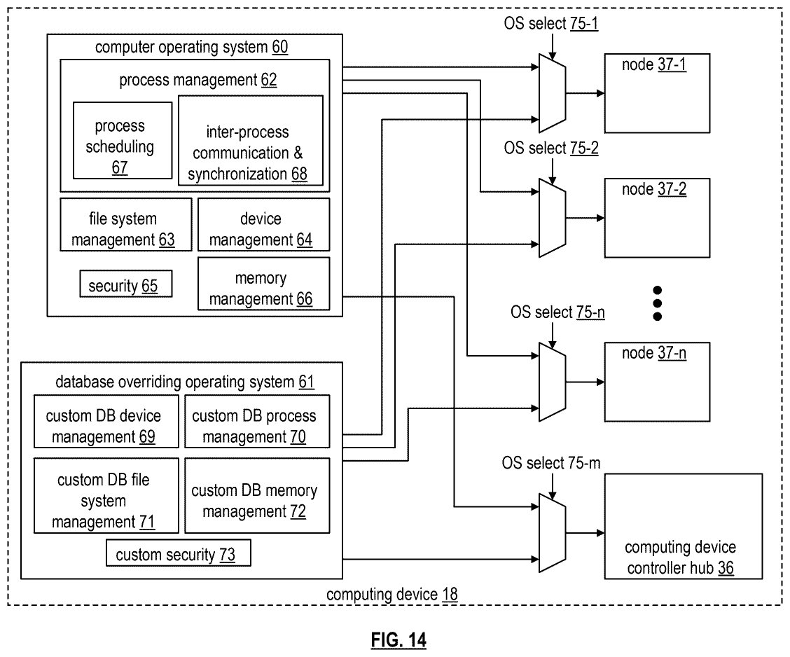

FIG. 14 is a schematic block diagram of an embodiment of operating systems of a computing device 18. The computing device 18 includes a computer operating system 60 and a database overriding operating system (DB OS) 61. The computer OS 60 includes process management 62, file system management 63, device management 64, memory management 66, and security 65. The processing management 62 generally includes process scheduling 67 and inter-process communication and synchronization 68. In general, the computer OS 60 is a conventional operating system used by a variety of types of computing devices. For example, the computer operating system is a personal computer operating system, a server operating system, a tablet operating system, a cell phone operating system, etc.

The database overriding operating system (DB OS) 61 includes custom DB device management 69, custom DB process management 70 (e.g., process scheduling and/or inter-process communication & synchronization), custom DB file system management 71, custom DB memory management 72, and/or custom security 73. In general, the database overriding OS 61 provides hardware components of a node for more direct access to memory, more direct access to a network connection, improved independency, improved data storage, improved data retrieval, and/or improved data processing than the computing device OS.

In an example of operation, the database overriding OS 61 controls which operating system, or portions thereof, operate with each node and/or computing device controller hub of a computing device (e.g., via OS select 75-1 through 75-n when communicating with nodes 37-1 through 37-n and via OS select 75-m when communicating with the computing device controller hub 36). For example, device management of a node is supported by the computer operating system, while process management, memory management, and file system management are supported by the database overriding operating system. To override the computer OS, the database overriding OS provides instructions to the computer OS regarding which management tasks will be controlled by the database overriding OS. The database overriding OS also provides notification to the computer OS as to which sections of the main memory it is reserving exclusively for one or more database functions, operations, and/or tasks. One or more examples of the database overriding operating system are provided in subsequent figures.

The database system 10 can be implemented as a massive scale database system that is operable to process data at a massive scale. As used herein, a massive scale refers to a massive number of records of a single dataset and/or many datasets, such as millions, billions, and/or trillions of records that collectively include many Gigabytes, Terabytes, Petabytes, and/or Exabytes of data. As used herein, a massive scale database system refers to a database system operable to process data at a massive scale. The processing of data at this massive scale can be achieved via a large number, such as hundreds, thousands, and/or millions of computing devices 18, nodes 37, and/or processing core resources 48 performing various functionality of database system 10 described herein in parallel, for example, independently and/or without coordination.

Such processing of data at this massive scale cannot practically be performed by the human mind. In particular, the human mind is not equipped to perform processing of data at a massive scale. Furthermore, the human mind is not equipped to perform hundreds, thousands, and/or millions of independent processes in parallel, within overlapping time spans. The embodiments of database system 10 discussed herein improves the technology of database systems by enabling data to be processed at a massive scale efficiently and/or reliably.

In particular, the database system 10 can be operable to receive data and/or to store received data at a massive scale. For example, the parallelized input and/or storing of data by the database system 10 achieved by utilizing the parallelized data input sub-system 11 and/or the parallelized data store, retrieve, and/or process sub-system 12 can cause the database system 10 to receive records for storage at a massive scale, where millions, billions, and/or trillions of records that collectively include many Gigabytes, Terabytes, Petabytes, and/or Exabytes can be received for storage, for example, reliably, redundantly and/or with a guarantee that no received records are missing in storage and/or that no received records are duplicated in storage. This can include processing real-time and/or near-real time data streams from one or more data sources at a massive scale based on facilitating ingress of these data streams in parallel. To meet the data rates required by these one or more real-time data streams, the processing of incoming data streams can be distributed across hundreds, thousands, and/or millions of computing devices 18, nodes 37, and/or processing core resources 48 for separate, independent processing with minimal and/or no coordination. The processing of incoming data streams for storage at this scale and/or this data rate cannot practically be performed by the human mind. The processing of incoming data streams for storage at this scale and/or this data rate improves database system by enabling greater amounts of data to be stored in databases for analysis and/or by enabling real-time data to be stored and utilized for analysis. The resulting richness of data stored in the database system can improve the technology of database systems by improving the depth and/or insights of various data analyses performed upon this massive scale of data.

Additionally, the database system 10 can be operable to perform queries upon data at a massive scale. For example, the parallelized retrieval and processing of data by the database system 10 achieved by utilizing the parallelized query and results sub-system 13 and/or the parallelized data store, retrieve, and/or process sub-system 12 can cause the database system 10 to retrieve stored records at a massive scale and/or to and/or filter, aggregate, and/or perform query operators upon records at a massive scale in conjunction with query execution, where millions, billions, and/or trillions of records that collectively include many Gigabytes, Terabytes, Petabytes, and/or Exabytes can be accessed and processed in accordance with execution of one or more queries at a given time, for example, reliably, redundantly and/or with a guarantee that no records are inadvertently missing from representation in a query resultant and/or duplicated in a query resultant. To execute a query against a massive scale of records in a reasonable amount of time such as a small number of seconds, minutes, or hours, the processing of a given query can be distributed across hundreds, thousands, and/or millions of computing devices 18, nodes 37, and/or processing core resources 48 for separate, independent processing with minimal and/or no coordination. The processing of queries at this massive scale and/or this data rate cannot practically be performed by the human mind. The processing of queries at this massive scale improves the technology of database systems by facilitating greater depth and/or insights of query resultants for queries performed upon this massive scale of data.

Furthermore, the database system 10 can be operable to perform multiple queries concurrently upon data at a massive scale. For example, the parallelized retrieval and processing of data by the database system 10 achieved by utilizing the parallelized query and results sub-system 13 and/or the parallelized data store, retrieve, and/or process sub-system 12 can cause the database system 10 to perform multiple queries concurrently, for example, in parallel, against data at this massive scale, where hundreds and/or thousands of queries can be performed against the same, massive scale dataset within a same time frame and/or in overlapping time frames. To execute multiple concurrent queries against a massive scale of records in a reasonable amount of time such as a small number of seconds, minutes, or hours, the processing of a multiple queries can be distributed across hundreds, thousands, and/or millions of computing devices 18, nodes 37, and/or processing core resources 48 for separate, independent processing with minimal and/or no coordination. A given computing devices 18, nodes 37, and/or processing core resources 48 may be responsible for participating in execution of multiple queries at a same time and/or within a given time frame, where its execution of different queries occurs within overlapping time frames. The processing of many concurrent queries at this massive scale and/or this data rate cannot practically be performed by the human mind. The processing of concurrent queries improves the technology of database systems by facilitating greater numbers of users and/or greater numbers of analyses to be serviced within a given time frame and/or over time.

FIGS. 15-23 are schematic block diagrams of an example of processing a table or data set for storage in the database system 10. FIG. 15 illustrates an example of a data set or table that includes 32 columns and 80 rows, or records, that is received by the parallelized data input-subsystem. This is a very small table, but is sufficient for illustrating one or more concepts regarding one or more aspects of a database system. The table is representative of a variety of data ranging from insurance data, to financial data, to employee data, to medical data, and so on.

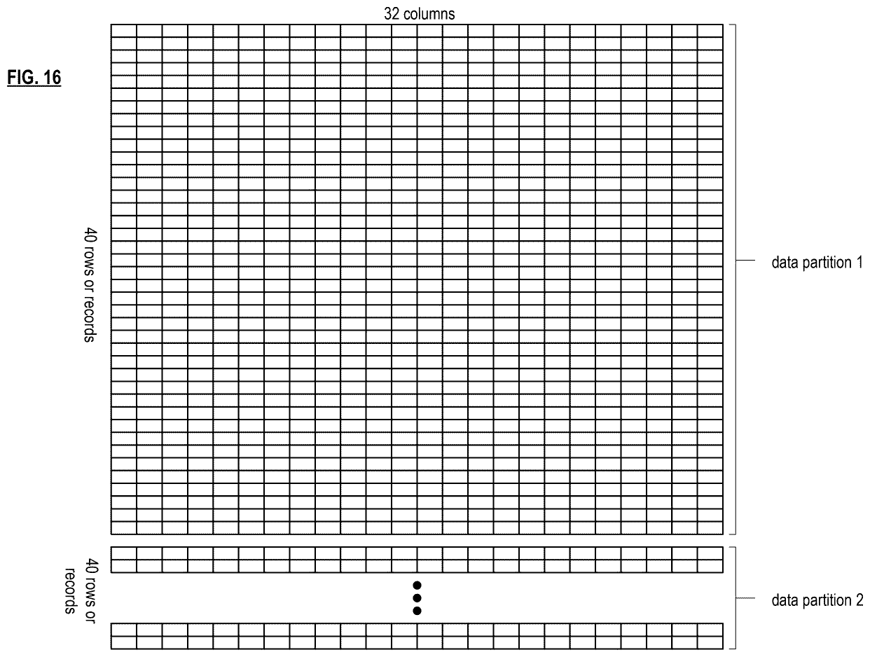

FIG. 16 illustrates an example of the parallelized data input-subsystem dividing the data set into two partitions. Each of the data partitions includes 40 rows, or records, of the data set. In another example, the parallelized data input-subsystem divides the data set into more than two partitions. In yet another example, the parallelized data input-subsystem divides the data set into many partitions and at least two of the partitions have a different number of rows.

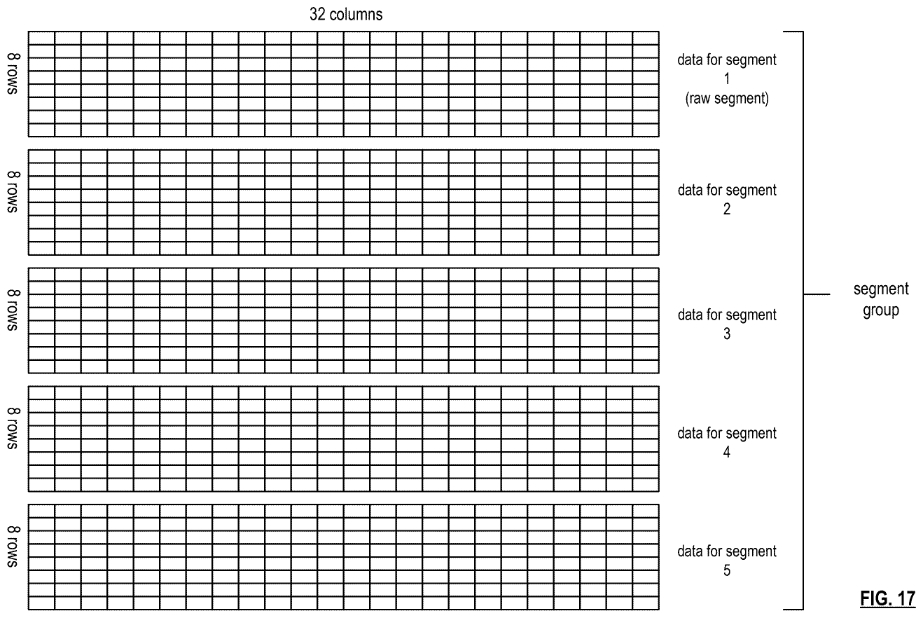

FIG. 17 illustrates an example of the parallelized data input-subsystem dividing a data partition into a plurality of segments to form a segment group. The number of segments in a segment group is a function of the data redundancy encoding. In this example, the data redundancy encoding is single parity encoding from four data pieces; thus, five segments are created. In another example, the data redundancy encoding is a two parity encoding from four data pieces; thus, six segments are created. In yet another example, the data redundancy encoding is single parity encoding from seven data pieces; thus, eight segments are created.

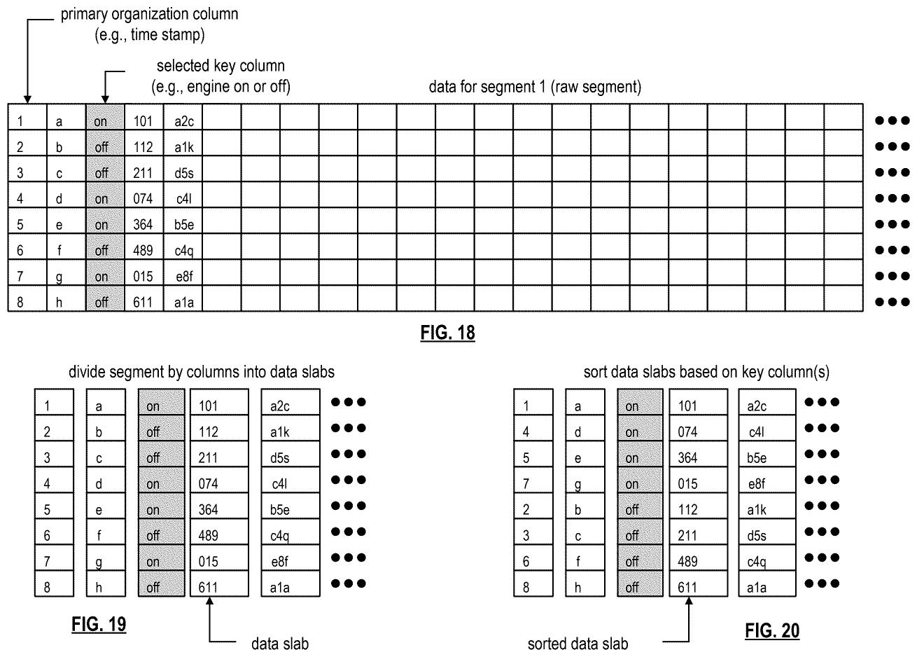

FIG. 18 illustrates an example of data for segment 1 of the segments of FIG. 17. The segment is in a raw form since it has not yet been key column sorted. As shown, segment 1 includes 8 rows and 32 columns. The third column is selected as the key column and the other columns store various pieces of information for a given row (i.e., a record). The key column may be selected in a variety of ways. For example, the key column is selected based on a type of query (e.g., a query regarding a year, where a data column is selected as the key column). As another example, the key column is selected in accordance with a received input command that identified the key column. As yet another example, the key column is selected as a default key column (e.g., a date column, an ID column, etc.)

As an example, the table is regarding a fleet of vehicles. Each row represents data regarding a unique vehicle. The first column stores a vehicle ID, the second column stores make and model information of the vehicle. The third column stores data as to whether the vehicle is on or off. The remaining columns store data regarding the operation of the vehicle such as mileage, gas level, oil level, maintenance information, routes taken, etc.

With the third column selected as the key column, the other columns of the segment are to be sorted based on the key column. Prior to being sorted, the columns are separated to form data slabs. As such, one column is separated out to form one data slab.

FIG. 19 illustrates an example of the parallelized data input-subsystem dividing segment 1 of FIG. 18 into a plurality of data slabs. A data slab is a column of segment 1. In this figure, the data of the data slabs has not been sorted. Once the columns have been separated into data slabs, each data slab is sorted based on the key column. Note that more than one key column may be selected and used to sort the data slabs based on two or more other columns.

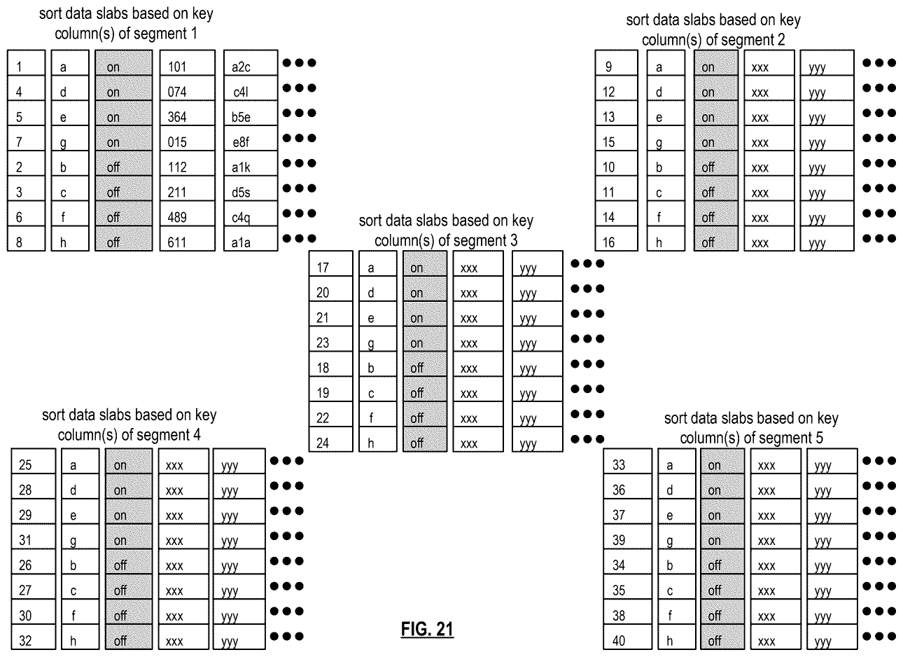

FIG. 20 illustrates an example of the parallelized data input-subsystem sorting the each of the data slabs based on the key column. In this example, the data slabs are sorted based on the third column which includes data of “on” or “off”. The rows of a data slab are rearranged based on the key column to produce a sorted data slab. Each segment of the segment group is divided into similar data slabs and sorted by the same key column to produce sorted data slabs.

FIG. 21 illustrates an example of each segment of the segment group sorted into sorted data slabs. The similarity of data from segment to segment is for the convenience of illustration. Note that each segment has its own data, which may or may not be similar to the data in the other sections.

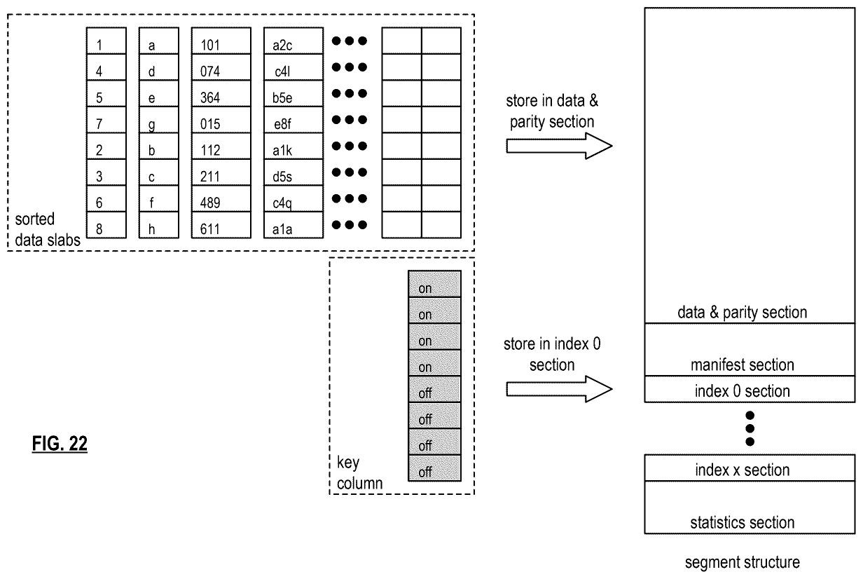

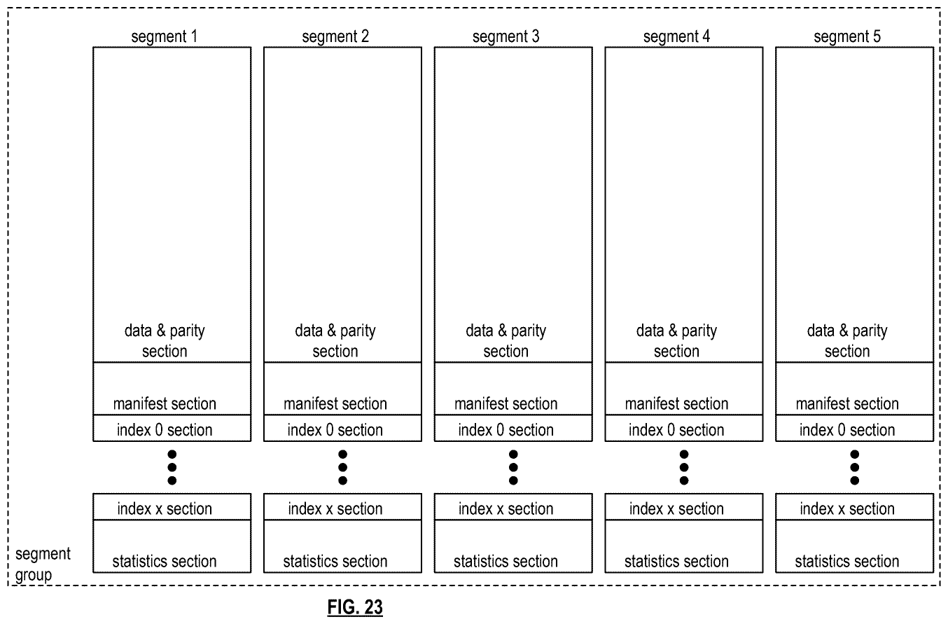

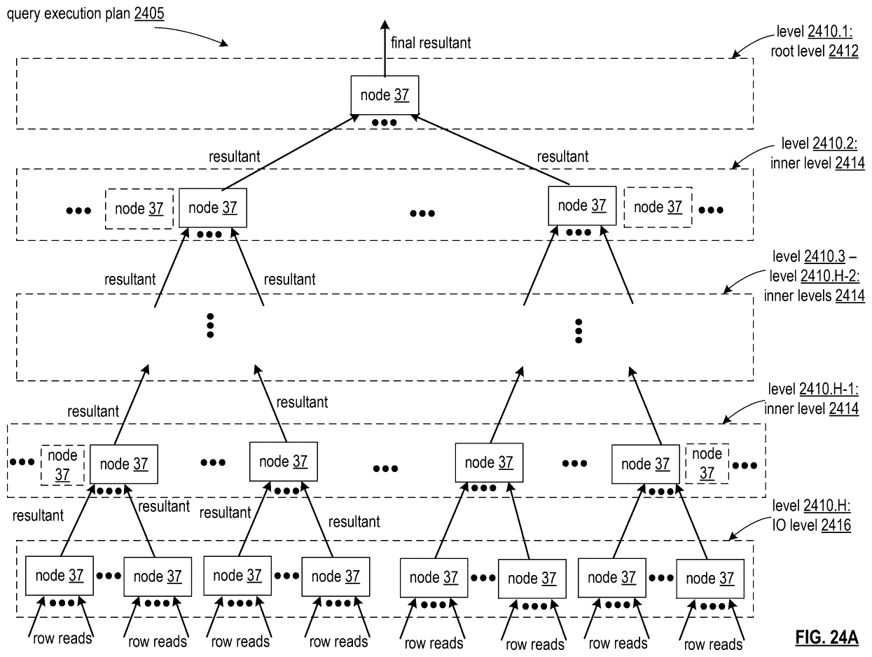

FIG. 22 illustrates an example of a segment structure for a segment of the segment group. The segment structure for a segment includes the data & parity section, a manifest section, one or more index sections, and a statistics section. The segment structure represents a storage mapping of the data (e.g., data slabs and parity data) of a segment and associated data (e.g., metadata, statistics, key column(s), etc.) regarding the data of the segment. The sorted data slabs of FIG. 16 of the segment are stored in the data & parity section of the segment structure. The sorted data slabs are stored in the data & parity section in a compressed format or as raw data (i.e., non-compressed format). Note that a segment structure has a particular data size (e.g., 32 Giga-Bytes) and data is stored within coding block sizes (e.g., 4 Kilo-Bytes).

Before the sorted data slabs are stored in the data & parity section, or concurrently with storing in the data & parity section, the sorted data slabs of a segment are redundancy encoded. The redundancy encoding may be done in a variety of ways. For example, the redundancy encoding is in accordance with RAID 5, RAID 6, or RAID 10. As another example, the redundancy encoding is a form of forward error encoding (e.g., Reed Solomon, Trellis, etc.). As another example, the redundancy encoding utilizes an erasure coding scheme.

The manifest section stores metadata regarding the sorted data slabs. The metadata includes one or more of, but is not limited to, descriptive metadata, structural metadata, and/or administrative metadata. Descriptive metadata includes one or more of, but is not limited to, information regarding data such as name, an abstract, keywords, author, etc. Structural metadata includes one or more of, but is not limited to, structural features of the data such as page size, page ordering, formatting, compression information, redundancy encoding information, logical addressing information, physical addressing information, physical to logical addressing information, etc. Administrative metadata includes one or more of, but is not limited to, information that aids in managing data such as file type, access privileges, rights management, preservation of the data, etc.

The key column is stored in an index section. For example, a first key column is stored in index #0. If a second key column exists, it is stored in index #1. As such, for each key column, it is stored in its own index section. Alternatively, one or more key columns are stored in a single index section.

The statistics section stores statistical information regarding the segment and/or the segment group. The statistical information includes one or more of, but is not limited, to number of rows (e.g., data values) in one or more of the sorted data slabs, average length of one or more of the sorted data slabs, average row size (e.g., average size of a data value), etc. The statistical information includes information regarding raw data slabs, raw parity data, and/or compressed data slabs and parity data.

FIG. 23 illustrates the segment structures for each segment of a segment group having five segments. Each segment includes a data & parity section, a manifest section, one or more index sections, and a statistic section. Each segment is targeted for storage in a different computing device of a storage cluster. The number of segments in the segment group corresponds to the number of computing devices in a storage cluster. In this example, there are five computing devices in a storage cluster. Other examples include more or less than five computing devices in a storage cluster.

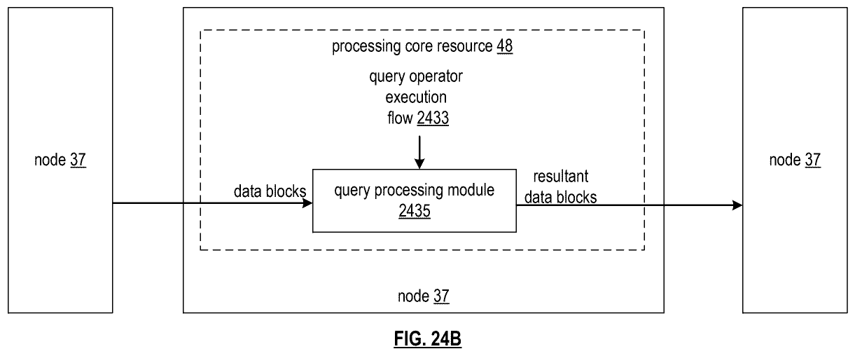

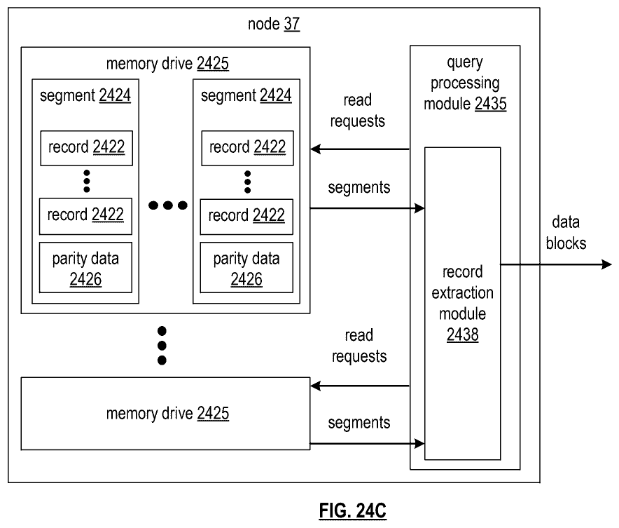

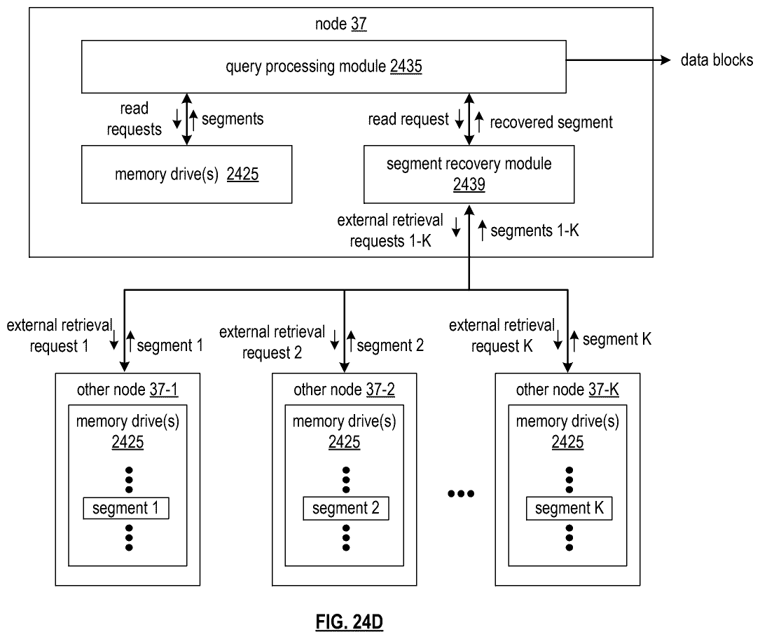

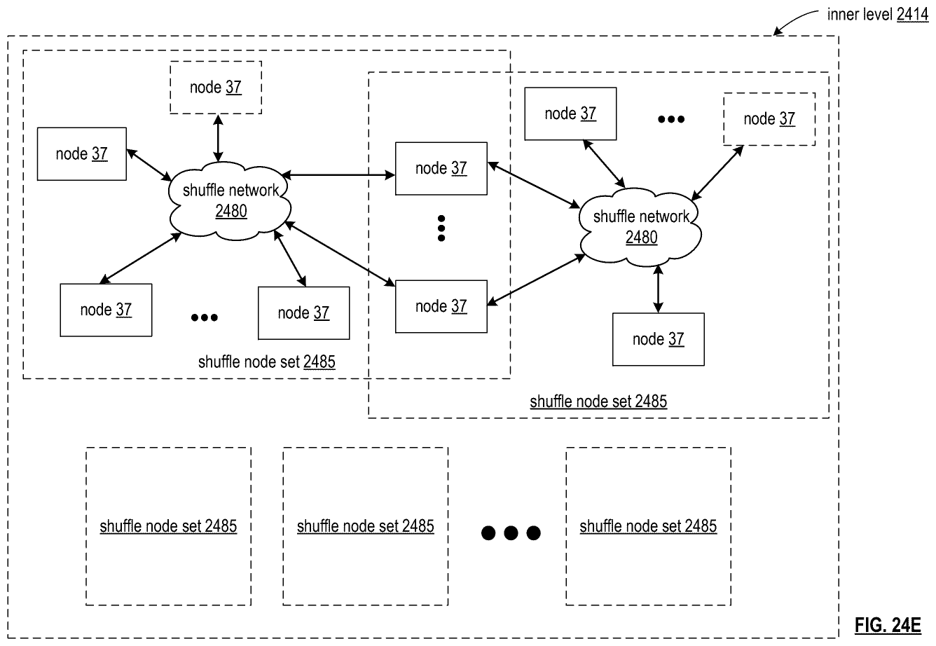

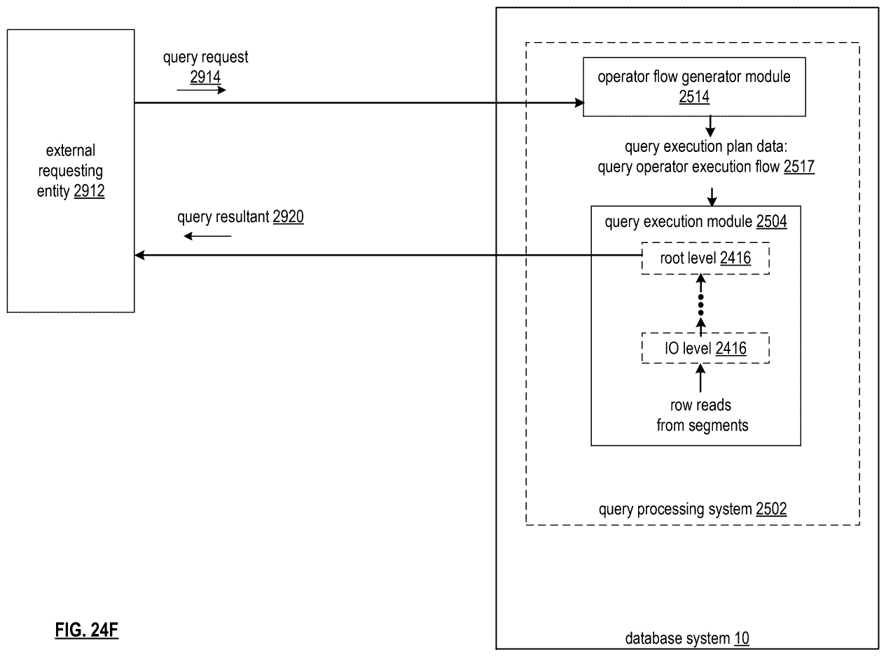

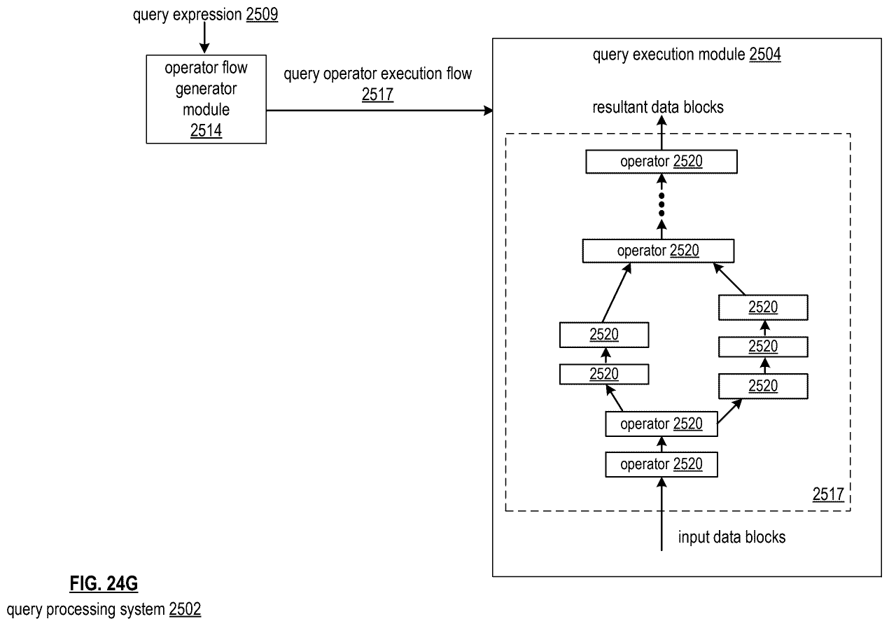

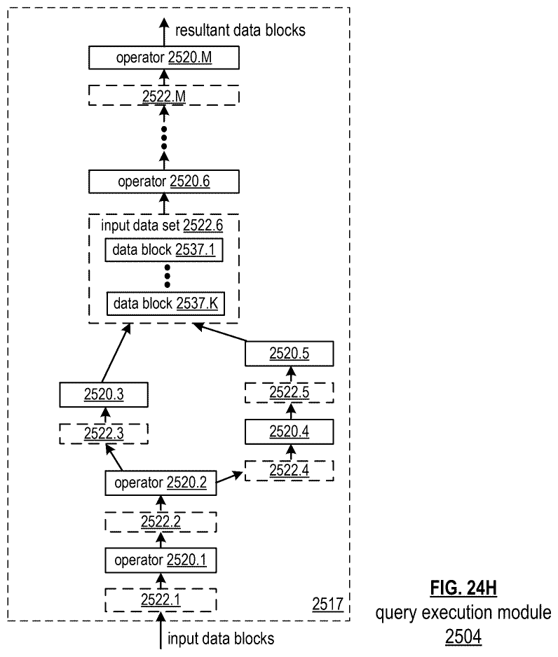

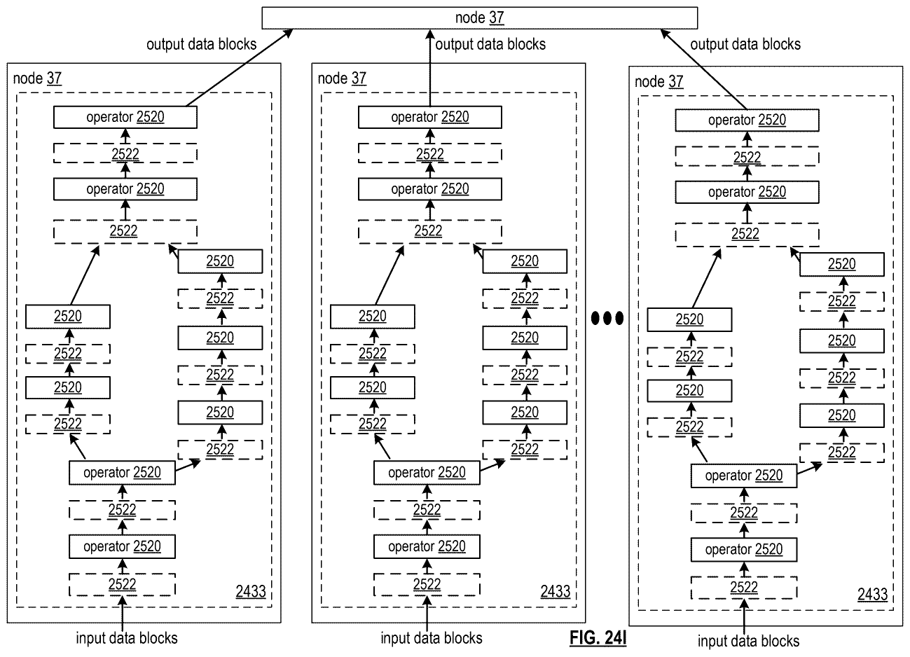

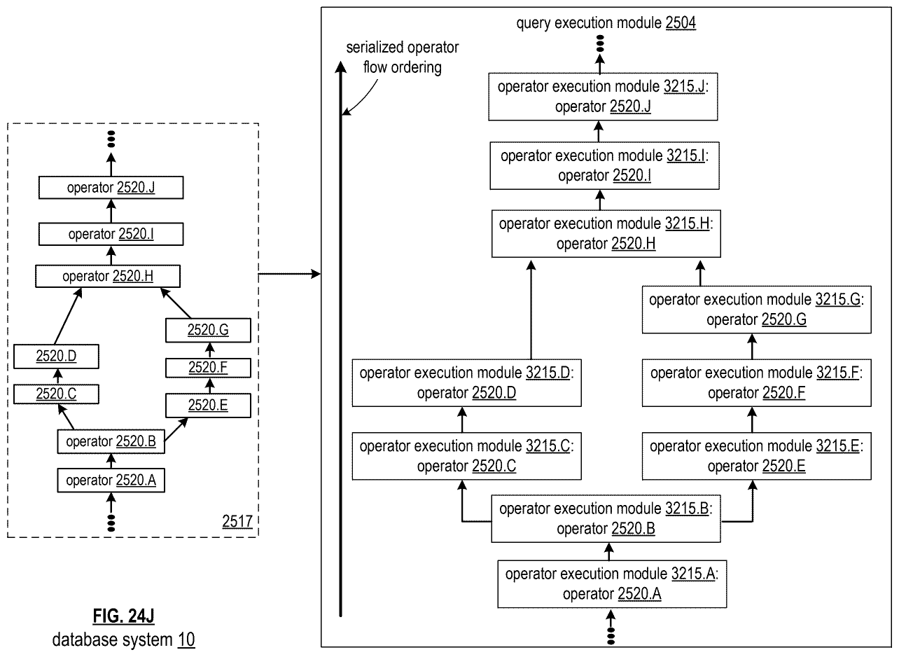

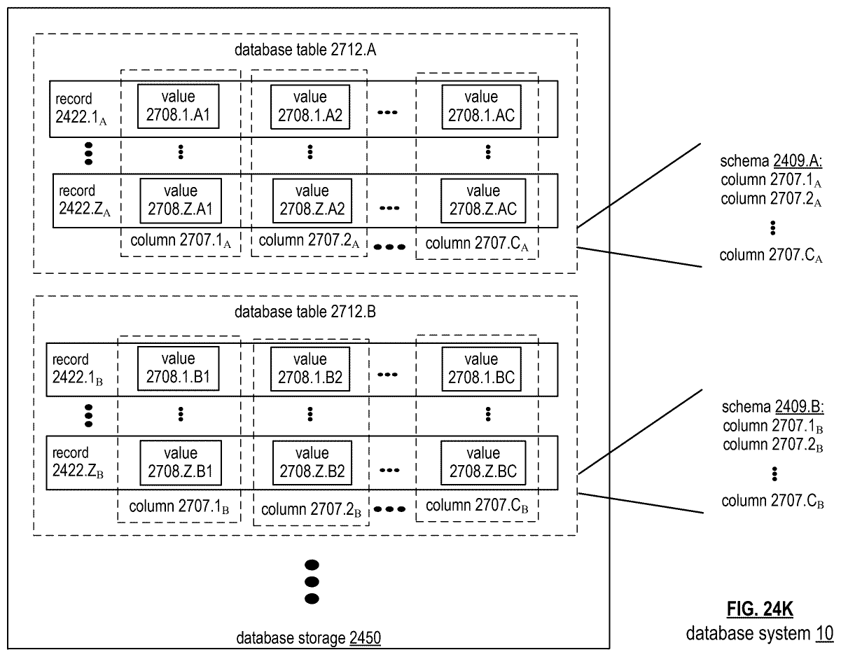

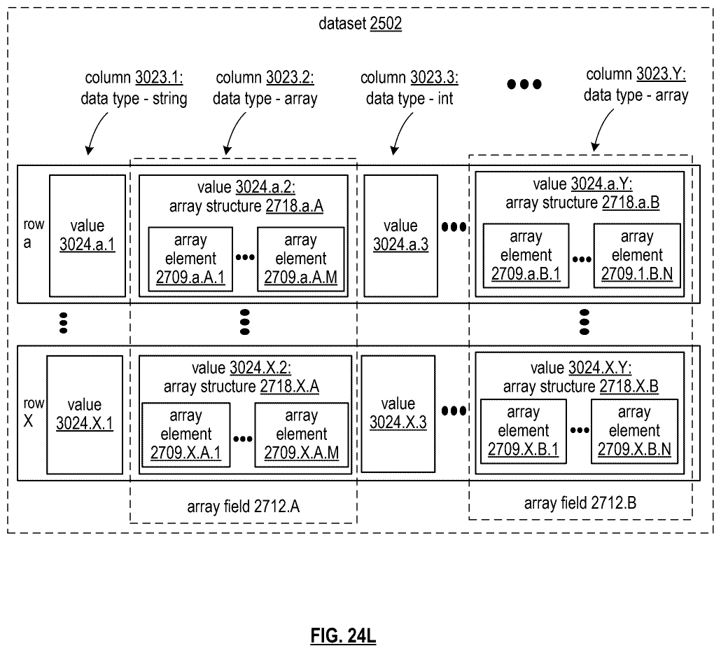

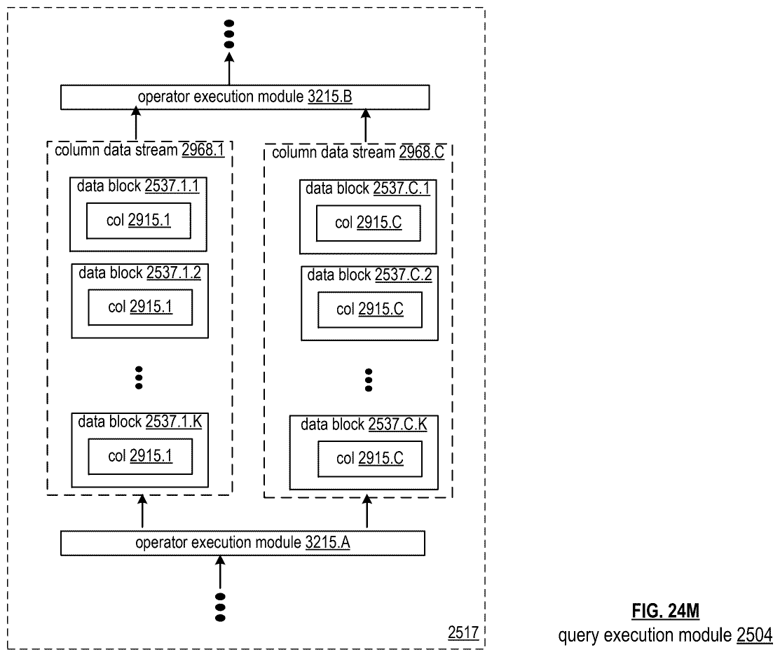

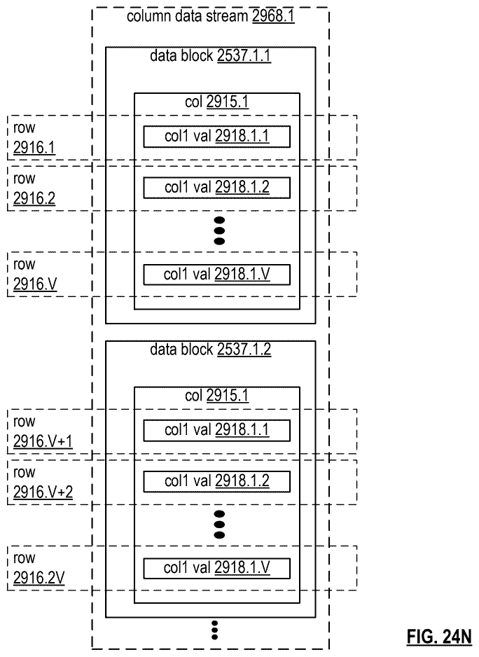

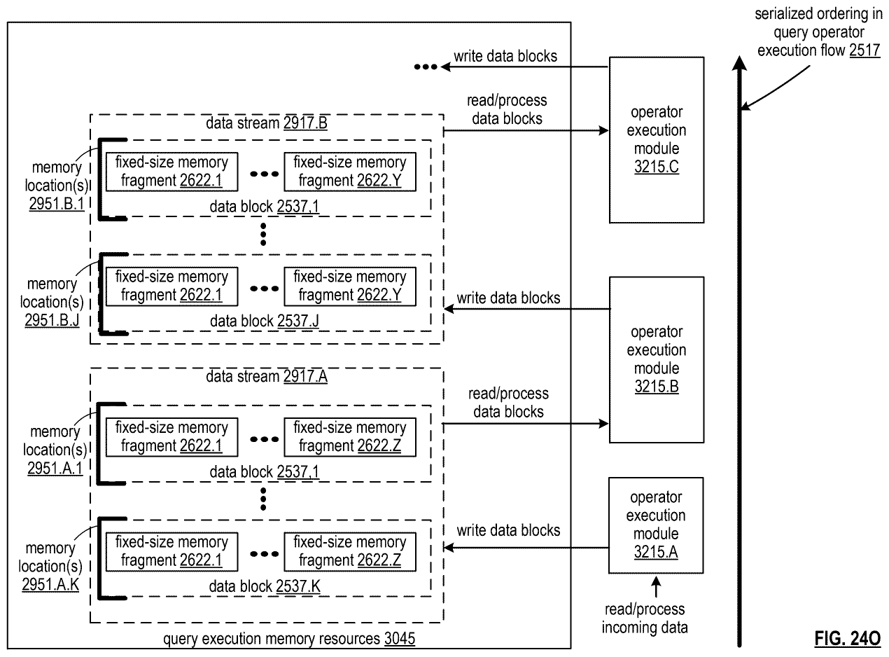

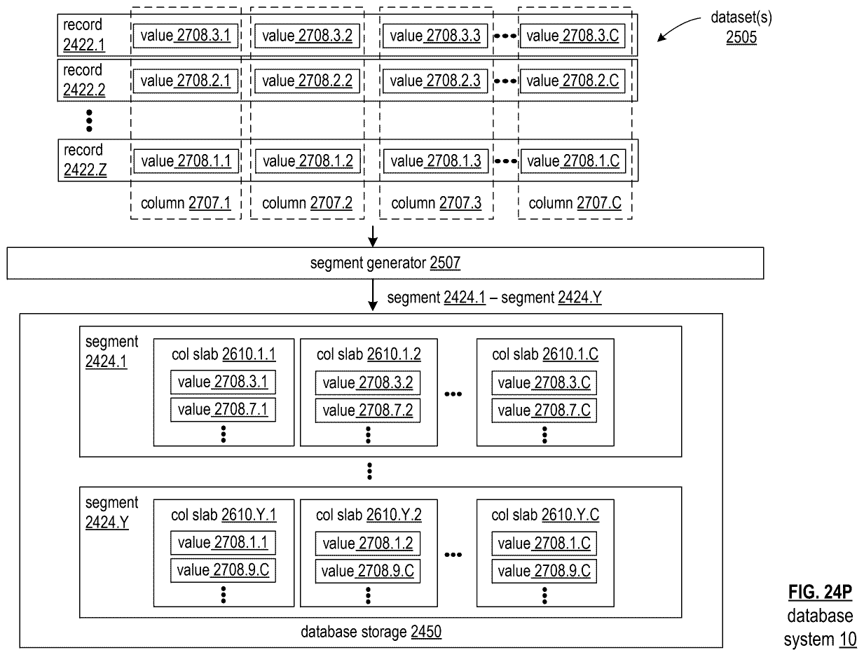

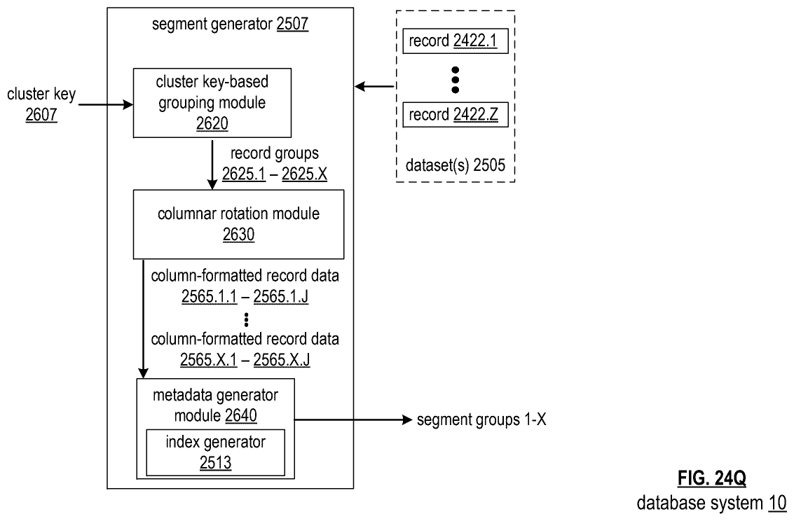

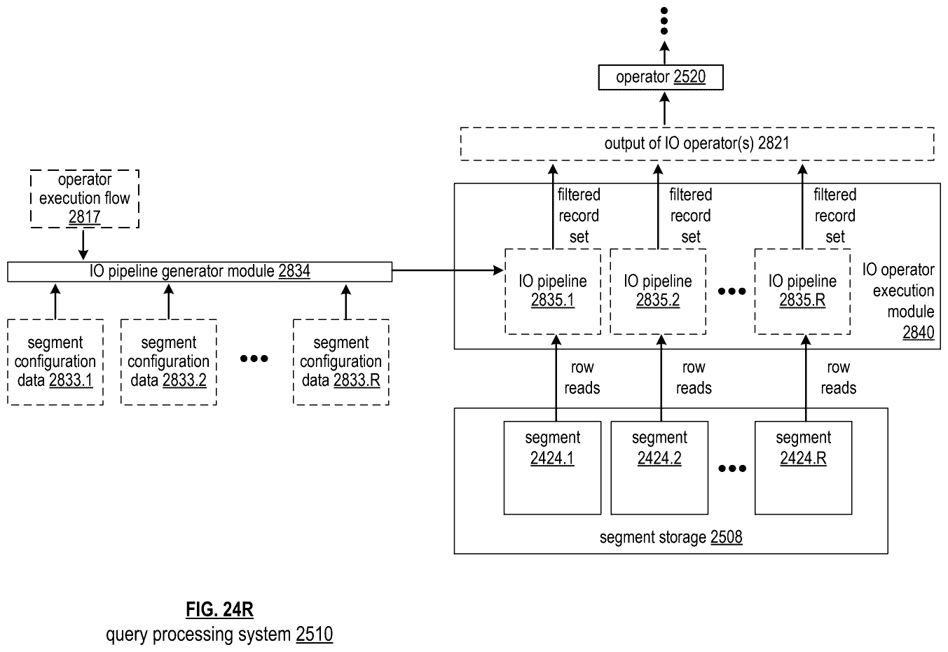

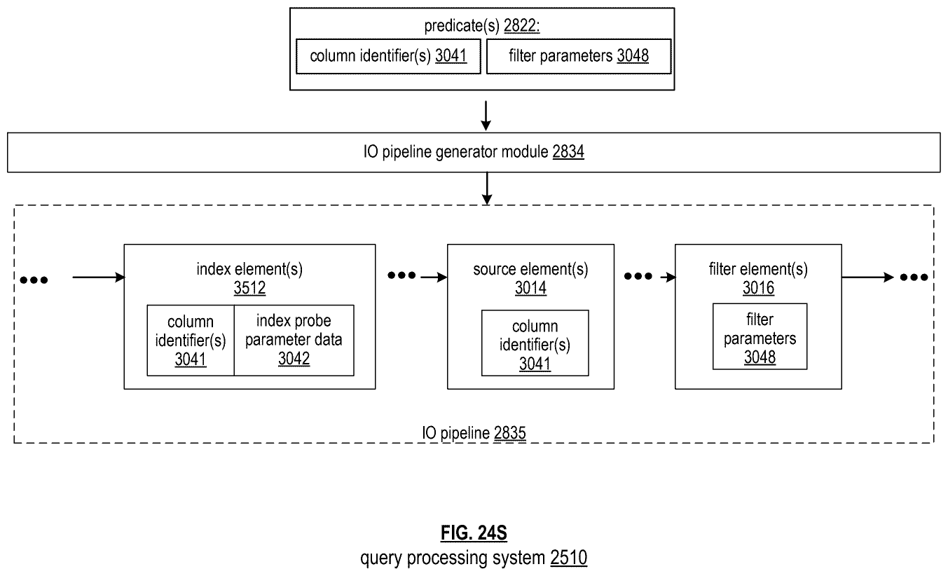

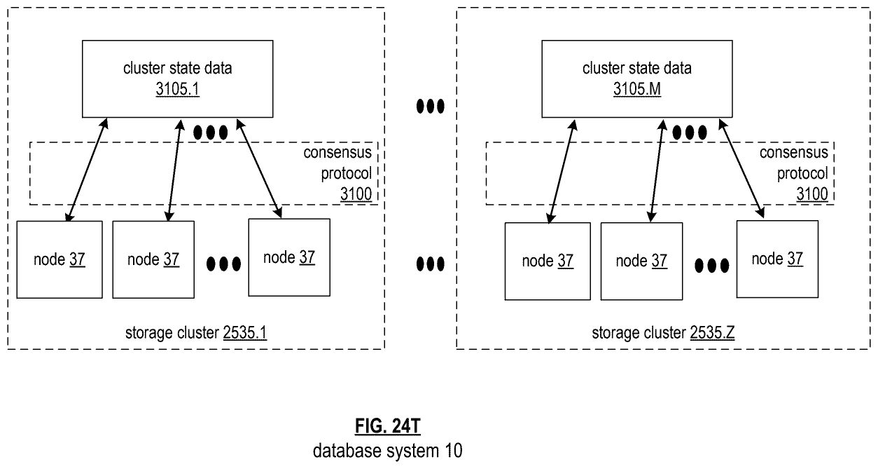

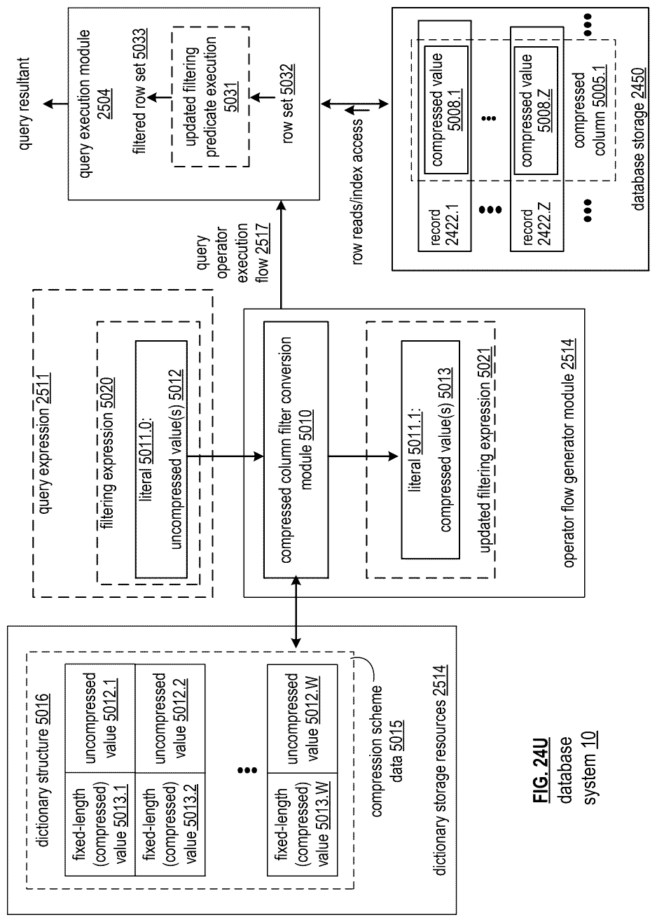

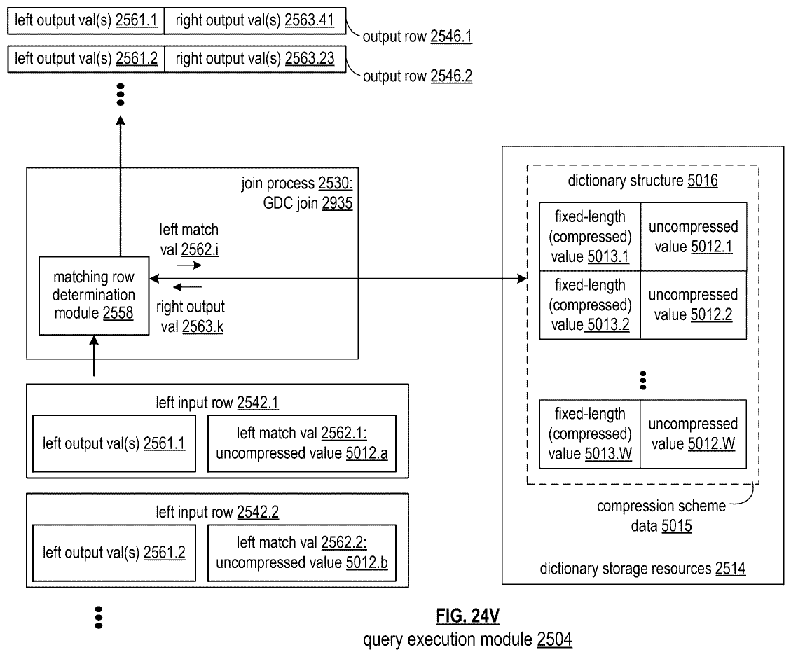

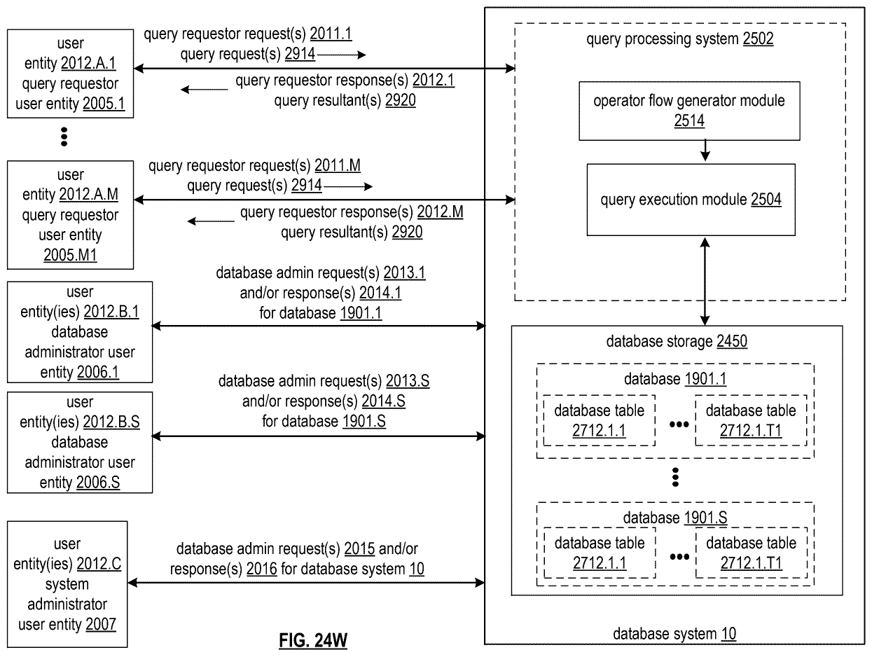

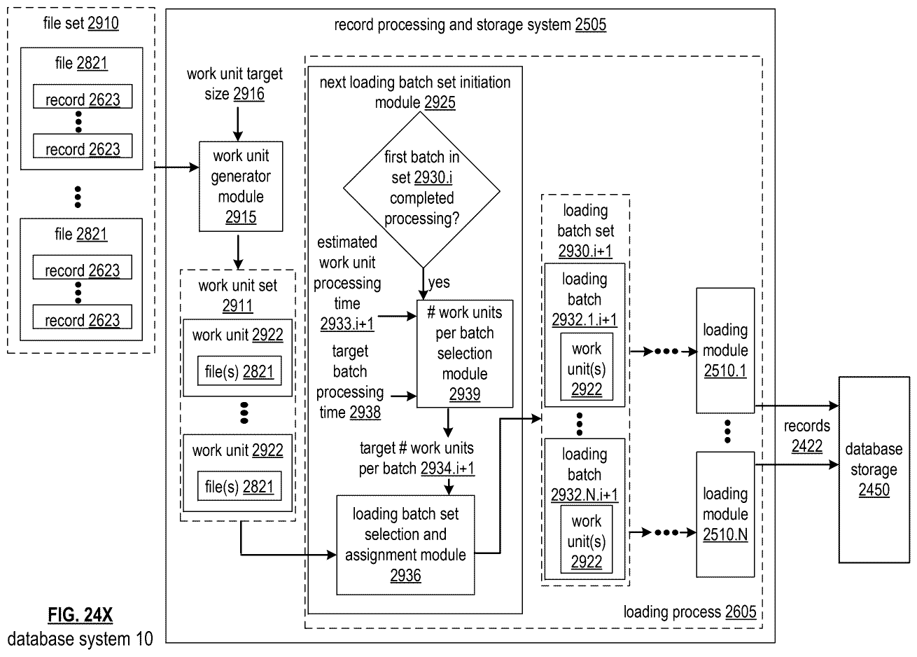

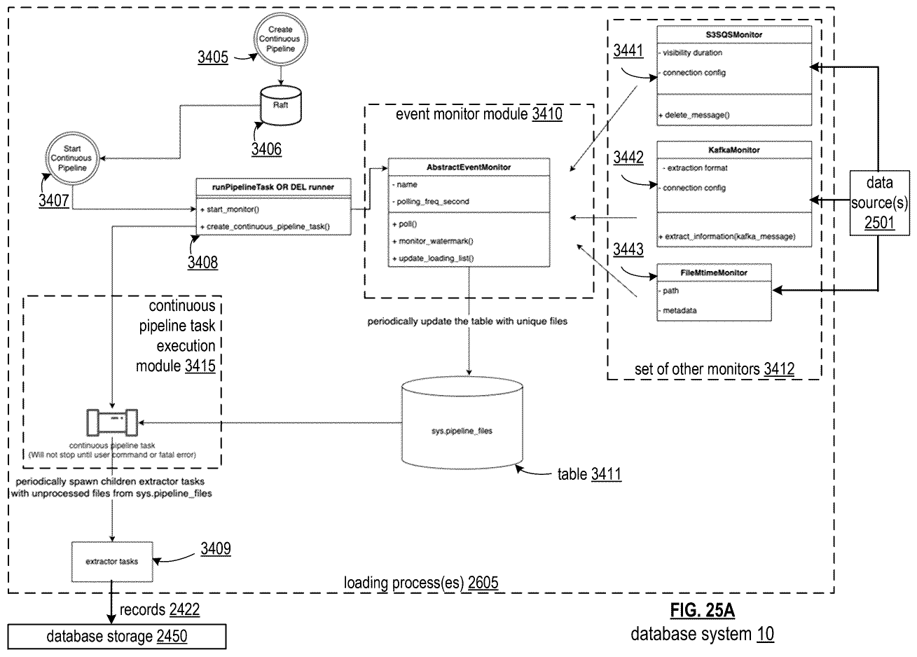

FIG. 24A illustrates an example of a query execution plan 2405 implemented by the database system 10 to execute one or more queries by utilizing a plurality of nodes 37. Each node 37 can be utilized to implement some or all of the plurality of nodes 37 of some or all computing devices 18-1-18-n, for example, of the of the parallelized data store, retrieve, and/or process sub-system 12, and/or of the parallelized query and results sub-system 13. The query execution plan can include a plurality of levels 2410. In this example, a plurality of H levels in a corresponding tree structure of the query execution plan 2405 are included. The plurality of levels can include a top, root level 2412; a bottom, IO level 2416, and one or more inner levels 2414. In some embodiments, there is exactly one inner level 2414, resulting in a tree of exactly three levels 2410.1, 2410.2, and 2410.3, where level 2410.H corresponds to level 2410.3. In such embodiments, level 2410.2 is the same as level 2410.H-1, and there are no other inner levels 2410.3-2410.H-2. Alternatively, any number of multiple inner levels 2414 can be implemented to result in a tree with more than three levels.

This illustration of query execution plan 2405 illustrates the flow of execution of a given query by utilizing a subset of nodes across some or all of the levels 2410. In this illustration, nodes 37 with a solid outline are nodes involved in executing a given query. Nodes 37 with a dashed outline are other possible nodes that are not involved in executing the given query, but could be involved in executing other queries in accordance with their level of the query execution plan in which they are included.

Each of the nodes of IO level 2416 can be operable to, for a given query, perform the necessary row reads for gathering corresponding rows of the query. These row reads can correspond to the segment retrieval to read some or all ofthe rows of retrieved segments determined to be required for the given query. Thus, the nodes 37 in level 2416 can include any nodes 37 operable to retrieve segments for query execution from its own storage or from storage by one or more other nodes; to recover segment for query execution via other segments in the same segment grouping by utilizing the redundancy error encoding scheme; and/or to determine which exact set of segments is assigned to the node for retrieval to ensure queries are executed correctly.

IO level 2416 can include all nodes in a given storage cluster 35 and/or can include some or all nodes in multiple storage clusters 35, such as all nodes in a subset of the storage clusters 35-1-35-z and/or all nodes in all storage clusters 35-1-35-z. For example, all nodes 37 and/or all currently available nodes 37 of the database system 10 can be included in level 2416. As another example, IO level 2416 can include a proper subset of nodes in the database system, such as some or all nodes that have access to stored segments and/or that are included in a segment set. In some cases, nodes 37 that do not store segments included in segment sets, that do not have access to stored segments, and/or that are not operable to perform row reads are not included at the IO level, but can be included at one or more inner levels 2414 and/or root level 2412.

The query executions discussed herein by nodes in accordance with executing queries at level 2416 can include retrieval of segments; extracting some or all necessary rows from the segments with some or all necessary columns; and sending these retrieved rows to a node at the next level 2410.H-1 as the query resultant generated by the node 37. For each node 37 at IO level 2416, the set of raw rows retrieved by the node 37 can be distinct from rows retrieved from all other nodes, for example, to ensure correct query execution. The total set of rows and/or corresponding columns retrieved by nodes 37 in the IO level for a given query can be dictated based on the domain of the given query, such as one or more tables indicated in one or more SELECT statements of the query, and/or can otherwise include all data blocks that are necessary to execute the given query.

Each inner level 2414 can include a subset of nodes 37 in the database system 10. Each level 2414 can include a distinct set of nodes 37 and/or some or more levels 2414 can include overlapping sets of nodes 37. The nodes 37 at inner levels are implemented, for each given query, to execute queries in conjunction with operators for the given query. For example, a query operator execution flow can be generated for a given incoming query, where an ordering of execution of its operators is determined (e.g. as an acyclic directed graph of operators), and this ordering is utilized to assign one or more operators of the query operator execution flow to each node in a given inner level 2414 for execution. For example, each node at a same inner level can be operable to execute a same set of operators for a given query, in response to being selected to execute the given query, upon incoming resultants generated by nodes at a directly lower level to generate its own resultants sent to a next higher level. In particular, each node at a same inner level can be operable to execute a same portion of a same query operator execution flow for a given query. In cases where there is exactly one inner level, each node selected to execute a query at a given inner level performs some or all of the given query's operators upon the raw rows received as resultants from the nodes at the IO level, such as the entire query operator execution flow and/or the portion of the query operator execution flow performed upon data that has already been read from storage by nodes at the IO level. In some cases, some operators beyond row reads are also performed by the nodes at the IO level. Each node at a given inner level 2414 can further perform a gather function to collect, union, and/or aggregate resultants sent from a previous level, for example, in accordance with one or more corresponding operators of the given query.

The root level 2412 can include exactly one node for a given query that gathers resultants from every node at the top-most inner level 2414. The node 37 at root level 2412 can perform additional query operators of the query and/or can otherwise collect, aggregate, and/or union the resultants from the top-most inner level 2414 to generate the final resultant of the query, which includes the resulting set of rows and/or one or more aggregated values, in accordance with the query, based on being performed on all rows required by the query. The root level node can be selected from a plurality of possible root level nodes, where different root nodes are selected for different queries. Alternatively, the same root node can be selected for all queries.

As depicted in FIG. 24A, resultants are sent by nodes upstream with respect to the tree structure of the query execution plan as they are generated, where the root node generates a final resultant of the query. While not depicted in FIG. 24A, nodes at a same level can share data and/or send resultants to each other, for example, in accordance with operators of the query at this same level dictating that data is sent between nodes.

In some cases, the IO level 2416 always includes the same set of nodes 37, such as a full set of nodes and/or all nodes that are in a storage cluster 35 that stores data required to process incoming queries. In some cases, the lowest inner level corresponding to level 2410.H-1 includes at least one node from the IO level 2416 in the possible set of nodes. In such cases, while each selected node in level 2410.H-1 is depicted to process resultants sent from other nodes 37 in FIG. 24A, each selected node in level 2410.H-1 that also operates as a node at the IO level further performs its own row reads in accordance with its query execution at the IO level, and gathers the row reads received as resultants from other nodes at the IO level with its own row reads for processing via operators of the query. One or more inner levels 2414 can also include nodes that are not included in IO level 2416, such as nodes 37 that do not have access to stored segments and/or that are otherwise not operable and/or selected to perform row reads for some or all queries.

The node 37 at root level 2412 can be fixed for all queries, where the set of possible nodes at root level 2412 includes only one node that executes all queries at the root level of the query execution plan. Alternatively, the root level 2412 can similarly include a set of possible nodes, where one node selected from this set of possible nodes for each query and where different nodes are selected from the set of possible nodes for different queries. In such cases, the nodes at inner level 2410.2 determine which of the set of possible root nodes to send their resultant to. In some cases, the single node or set of possible nodes at root level 2412 is a proper subset of the set of nodes at inner level 2410.2, and/or is a proper subset of the set of nodes at the IO level 2416. In cases where the root node is included at inner level 2410.2, the root node generates its own resultant in accordance with inner level 2410.2, for example, based on multiple resultants received from nodes at level 2410.3, and gathers its resultant that was generated in accordance with inner level 2410.2 with other resultants received from nodes at inner level 2410.2 to ultimately generate the final resultant in accordance with operating as the root level node.

In some cases where nodes are selected from a set of possible nodes at a given level for processing a given query, the selected node must have been selected for processing this query at each lower level of the query execution tree. For example, if a particular node is selected to process a node at a particular inner level, it must have processed the query to generate resultants at every lower inner level and the IO level. In such cases, each selected node at a particular level will always use its own resultant that was generated for processing at the previous, lower level, and will gather this resultant with other resultants received from other child nodes at the previous, lower level. Alternatively, nodes that have not yet processed a given query can be selected for processing at a particular level, where all resultants being gathered are therefore received from a set of child nodes that do not include the selected node.

The configuration of query execution plan 2405 for a given query can be determined in a downstream fashion, for example, where the tree is formed from the root downwards. Nodes at corresponding levels are determined from configuration information received from corresponding parent nodes and/or nodes at higher levels, and can each send configuration information to other nodes, such as their own child nodes, at lower levels until the lowest level is reached. This configuration information can include assignment of a particular subset of operators of the set of query operators that each level and/or each node will perform for the query. The execution of the query is performed upstream in accordance with the determined configuration, where IO reads are performed first, and resultants are forwarded upwards until the root node ultimately generates the query result.

Some or all features and/or functionality of FIG. 24A can be performed via at least one node 37 in conjunction with system metadata applied across a plurality of nodes 37, for example, where at least one node 37 participates in some or all features and/or functionality of FIG. 24A based on receiving and storing the system metadata in local memory of the at least one node 37 as configuration data and/or based on further accessing and/or executing this configuration data to participate in a query execution plan of FIG. 24A as part of its database functionality accordingly. Performance of some or all features and/or functionality of FIG. 24A can optionally change and/or be updated over time, and/or a set of nodes participating in executing some or all features and/or functionality of FIG. 24A can have changing nodes over time, based on the system metadata applied across the plurality of nodes 37 being updated over time, based on nodes on updating their configuration data stored in local memory to reflect changes in the system metadata based on receiving data indicating these changes to the system metadata, and/or based on nodes being added and/or removed from the plurality of nodes over time.

FIG. 24B illustrates an embodiment of a node 37 executing a query in accordance with the query execution plan 2405 by implementing a query processing module 2435. The query processing module 2435 can be operable to execute a query operator execution flow 2433 determined by the node 37, where the query operator execution flow 2433 corresponds to the entirety of processing of the query upon incoming data assigned to the corresponding node 37 in accordance with its role in the query execution plan 2405. This embodiment of node 37 that utilizes a query processing module 2435 can be utilized to implement some or all of the plurality of nodes 37 of some or all computing devices 18-1-18-n, for example, of the of the parallelized data store, retrieve, and/or process sub-system 12, and/or of the parallelized query and results sub-system 13.

As used herein, execution of a particular query by a particular node 37 can correspond to the execution of the portion of the particular query assigned to the particular node in accordance with full execution of the query by the plurality of nodes involved in the query execution plan 2405. This portion of the particular query assigned to a particular node can correspond to execution plurality of operators indicated by a query operator execution flow 2433 (e.g. as an acyclic directed graph of operators). In particular, the execution of the query for a node 37 at an inner level 2414 and/or root level 2412 corresponds to generating a resultant by processing all incoming resultants received from nodes at a lower level of the query execution plan 2405 that send their own resultants to the node 37. The execution of the query for a node 37 at the IO level corresponds to generating all resultant data blocks by retrieving and/or recovering all segments assigned to the node 37.

Thus, as used herein, a node 37's full execution of a given query corresponds to only a portion of the query's execution across all nodes in the query execution plan 2405. In particular, a resultant generated by an inner level node 37's execution of a given query may correspond to only a portion of the entire query result, such as a subset of rows in a final result set, where other nodes generate their own resultants to generate other portions of the full resultant of the query. In such embodiments, a plurality of nodes at this inner level can fully execute queries on different portions of the query domain independently in parallel by utilizing the same query operator execution flow 2433. Resultants generated by each of the plurality of nodes at this inner level 2414 can be gathered into a final result of the query, for example, by the node 37 at root level 2412 if this inner level is the top-most inner level 2414 or the only inner level 2414. As another example, resultants generated by each of the plurality of nodes at this inner level 2414 can be further processed via additional operators of a query operator execution flow 2433 being implemented by another node at a consecutively higher inner level 2414 of the query execution plan 2405, where all nodes at this consecutively higher inner level 2414 all execute their own same query operator execution flow 2433.

As discussed in further detail herein, the resultant generated by a node 37 can include a plurality of resultant data blocks generated via a plurality of partial query executions. As used herein, a partial query execution performed by a node corresponds to generating a resultant based on only a subset of the query input received by the node 37. In particular, the query input corresponds to all resultants generated by one or more nodes at a lower level of the query execution plan that send their resultants to the node. However, this query input can correspond to a plurality of input data blocks received over time, for example, in conjunction with the one or more nodes at the lower level processing their own input data blocks received over time to generate their resultant data blocks sent to the node over time. Thus, the resultant generated by a node's full execution of a query can include a plurality of resultant data blocks, where each resultant data block is generated by processing a subset of all input data blocks as a partial query execution upon the subset of all data blocks via the query operator execution flow 2433.

As illustrated in FIG. 24B, the query processing module 2435 can be implemented by a single processing core resource 48 of the node 37. In such embodiments, each one of the processing core resources 48-1-48-n of a same node 37 can be executing at least one query concurrently via their own query processing module 2435, where a single node 37 implements each of set of operator processing modules 2435-1-2435-n via a corresponding one of the set of processing core resources 48-1-48-n. A plurality of queries can be concurrently executed by the node 37, where each of its processing core resources 48 can each independently execute at least one query within a same temporal period by utilizing a corresponding at least one query operator execution flow 2433 to generate at least one query resultant corresponding to the at least one query.

Some or all features and/or functionality of FIG. 24B can be performed via a corresponding node 37 in conjunction with system metadata applied across a plurality of nodes 37 that includes the given node, for example, where the given node 37 participates in some or all features and/or functionality of FIG. 24B based on receiving and storing the system metadata in local memory of given node 37 as configuration data and/or based on further accessing and/or executing this configuration data to process data blocks via a query processing module as part of its database functionality accordingly. Performance of some or all features and/or functionality of FIG. 24B can optionally change and/or be updated over time, based on the system metadata applied across a plurality of nodes 37 that includes the given node being updated over time, and/or based on the given node updating its configuration data stored in local memory to reflect changes in the system metadata based on receiving data indicating these changes to the system metadata.

FIG. 24C illustrates a particular example of a node 37 at the 10 level 2416 of the query execution plan 2405 of FIG. 24A. A node 37 can utilize its own memory resources, such as some or all of its disk memory 38 and/or some or all of its main memory 40 to implement at least one memory drive 2425 that stores a plurality of segments 2424. Memory drives 2425 of a node 37 can be implemented, for example, by utilizing disk memory 38 and/or main memory 40. In particular, a plurality of distinct memory drives 2425 of a node 37 can be implemented via the plurality of memory devices 42-1-42-n of the node 37's disk memory 38.

Each segment 2424 stored in memory drive 2425 can be generated as discussed previously in conjunction with FIGS. 15-23. A plurality of records 2422 can be included in and/or extractable from the segment, for example, where the plurality of records 2422 of a segment 2424 correspond to a plurality of rows designated for the particular segment 2424 prior to applying the redundancy storage coding scheme as illustrated in FIG. 17. The records 2422 can be included in data of segment 2424, for example, in accordance with a column-format and/or other structured format. Each segments 2424 can further include parity data 2426 as discussed previously to enable other segments 2424 in the same segment group to be recovered via applying a decoding function associated with the redundancy storage coding scheme, such as a RAID scheme and/or erasure coding scheme, that was utilized to generate the set of segments of a segment group.

Thus, in addition to performing the first stage of query execution by being responsible for row reads, nodes 37 can be utilized for database storage, and can each locally store a set of segments in its own memory drives 2425. In some cases, a node 37 can be responsible for retrieval of only the records stored in its own one or more memory drives 2425 as one or more segments 2424. Executions of queries corresponding to retrieval of records stored by a particular node 37 can be assigned to that particular node 37. In other embodiments, a node 37 does not use its own resources to store segments. A node 37 can access its assigned records for retrieval via memory resources of another node 37 and/or via other access to memory drives 2425, for example, by utilizing system communication resources 14.

The query processing module 2435 of the node 37 can be utilized to read the assigned by first retrieving or otherwise accessing the corresponding redundancy-coded segments 2424 that include the assigned records its one or more memory drives 2425. Query processing module 2435 can include a record extraction module 2438 that is then utilized to extract or otherwise read some or all records from these segments 2424 accessed in memory drives 2425, for example, where record data of the segment is segregated from other information such as parity data included in the segment and/or where this data containing the records is converted into row-formatted records from the column-formatted row data stored by the segment. Once the necessary records of a query are read by the node 37, the node can further utilize query processing module 2435 to send the retrieved records all at once, or in a stream as they are retrieved from memory drives 2425, as data blocks to the next node 37 in the query execution plan 2405 via system communication resources 14 or other communication channels.

Some or all features and/or functionality of FIG. 24C can be performed via a corresponding node 37 in conjunction with system metadata applied across a plurality of nodes 37 that includes the given node, for example, where the given node 37 participates in some or all features and/or functionality of FIG. 24C based on receiving and storing the system metadata in local memory of given node 37 as configuration data and/or based on further accessing and/or executing this configuration data to read segments and/or extract rows from segments via a query processing module as part of its database functionality accordingly. Performance of some or all features and/or functionality of FIG. 24C can optionally change and/or be updated over time, based on the system metadata applied across a plurality of nodes 37 that includes the given node being updated over time, and/or based on the given node updating its configuration data stored in local memory to reflect changes in the system metadata based on receiving data indicating these changes to the system metadata.

FIG. 24D illustrates an embodiment of a node 37 that implements a segment recovery module 2439 to recover some or all segments that are assigned to the node for retrieval, in accordance with processing one or more queries, that are unavailable. Some or all features of the node 37 of FIG. 24D can be utilized to implement the node 37 of FIGS. 24B and 24C, and/or can be utilized to implement one or more nodes 37 of the query execution plan 2405 of FIG. 24A, such as nodes 37 at the IO level 2416. A node 37 may store segments on one of its own memory drives 2425 that becomes unavailable, or otherwise determines that a segment assigned to the node for execution of a query is unavailable for access via a memory drive the node 37 accesses via system communication resources 14. The segment recovery module 2439 can be implemented via at least one processing module of the node 37, such as resources of central processing module 39. The segment recovery module 2439 can retrieve the necessary number of segments 1-K in the same segment group as an unavailable segment from other nodes 37, such as a set of other nodes 37-1-37-K that store segments in the same storage cluster 35. Using system communication resources 14 or other communication channels, a set of external retrieval requests 1-K for this set of segments 1-K can be sent to the set of other nodes 37-1-37-K, and the set of segments can be received in response. This set of K segments can be processed, for example, where a decoding function is applied based on the redundancy storage coding scheme utilized to generate the set of segments in the segment group and/or parity data of this set of K segments is otherwise utilized to regenerate the unavailable segment. The necessary records can then be extracted from the unavailable segment, for example, via the record extraction module 2438, and can be sent as data blocks to another node 37 for processing in conjunction with other records extracted from available segments retrieved by the node 37 from its own memory drives 2425.

Note that the embodiments of node 37 discussed herein can be configured to execute multiple queries concurrently by communicating with nodes 37 in the same or different tree configuration of corresponding query execution plans and/or by performing query operations upon data blocks and/or read records for different queries. In particular, incoming data blocks can be received from other nodes for multiple different queries in any interleaving order, and a plurality of operator executions upon incoming data blocks for multiple different queries can be performed in any order, where output data blocks are generated and sent to the same or different next node for multiple different queries in any interleaving order. IO level nodes can access records for the same or different queries any interleaving order. Thus, at a given point in time, a node 37 can have already begun its execution of at least two queries, where the node 37 has also not yet completed its execution of the at least two queries.

A query execution plan 2405 can guarantee query correctness based on assignment data sent to or otherwise communicated to all nodes at the IO level ensuring that the set of required records in query domain data of a query, such as one or more tables required to be accessed by a query, are accessed exactly one time: if a particular record is accessed multiple times in the same query and/or is not accessed, the query resultant cannot be guaranteed to be correct. Assignment data indicating segment read and/or record read assignments to each of the set of nodes 37 at the IO level can be generated, for example, based on being mutually agreed upon by all nodes 37 at the IO level via a consensus protocol executed between all nodes at the IO level and/or distinct groups of nodes 37 such as individual storage clusters 35. The assignment data can be generated such that every record in the database system and/or in query domain of a particular query is assigned to be read by exactly one node 37. Note that the assignment data may indicate that a node 37 is assigned to read some segments directly from memory as illustrated in FIG. 24C and is assigned to recover some segments via retrieval of segments in the same segment group from other nodes 37 and via applying the decoding function of the redundancy storage coding scheme as illustrated in FIG. 24D.

Assuming all nodes 37 read all required records and send their required records to exactly one next node 37 as designated in the query execution plan 2405 for the given query, the use of exactly one instance of each record can be guaranteed. Assuming all inner level nodes 37 process all the required records received from the corresponding set of nodes 37 in the IO level 2416, via applying one or more query operators assigned to the node in accordance with their query operator execution flow 2433, correctness of their respective partial resultants can be guaranteed. This correctness can further require that nodes 37 at the same level intercommunicate by exchanging records in accordance with JOIN operations as necessary, as records received by other nodes may be required to achieve the appropriate result of a JOIN operation. Finally, assuming the root level node receives all correctly generated partial resultants as data blocks from its respective set of nodes at the penultimate, highest inner level 2414 as designated in the query execution plan 2405, and further assuming the root level node appropriately generates its own final resultant, the correctness of the final resultant can be guaranteed.

In some embodiments, each node 37 in the query execution plan can monitor whether it has received all necessary data blocks to fulfill its necessary role in completely generating its own resultant to be sent to the next node 37 in the query execution plan. A node 37 can determine receipt of a complete set of data blocks that was sent from a particular node 37 at an immediately lower level, for example, based on being numbered and/or have an indicated ordering in transmission from the particular node 37 at the immediately lower level, and/or based on a final data block of the set of data blocks being tagged in transmission from the particular node 37 at the immediately lower level to indicate it is a final data block being sent. A node 37 can determine the required set of lower level nodes from which it is to receive data blocks based on its knowledge of the query execution plan 2405 of the query. A node 37 can thus conclude when a complete set of data blocks has been received each designated lower level node in the designated set as indicated by the query execution plan 2405. This node 37 can therefore determine itself that all required data blocks have been processed into data blocks sent by this node 37 to the next node 37 and/or as a final resultant if this node 37 is the root node. This can be indicated via tagging of its own last data block, corresponding to the final portion of the resultant generated by the node, where it is guaranteed that all appropriate data was received and processed into the set of data blocks sent by this node 37 in accordance with applying its own query operator execution flow 2433.

In some embodiments, if any node 37 determines it did not receive all of its required data blocks, the node 37 itself cannot fulfill generation of its own set of required data blocks. For example, the node 37 will not transmit a final data block tagged as the “last” data block in the set of outputted data blocks to the next node 37, and the next node 37 will thus conclude there was an error and will not generate a full set of data blocks itself. The root node, and/or these intermediate nodes that never received all their data and/or never fulfilled their generation of all required data blocks, can independently determine the query was unsuccessful. In some cases, the root node, upon determining the query was unsuccessful, can initiate re-execution of the query by re-establishing the same or different query execution plan 2405 in a downward fashion as described previously, where the nodes 37 in this re-established query execution plan 2405 execute the query accordingly as though it were a new query. For example, in the case of a node failure that caused the previous query to fail, the new query execution plan 2405 can be generated to include only available nodes where the node that failed is not included in the new query execution plan 2405.

Some or all features and/or functionality of FIG. 24D can be performed via a corresponding node 37 in conjunction with system metadata applied across a plurality of nodes 37 that includes the given node, for example, where the given node 37 participates in some or all features and/or functionality of FIG. 24D based on receiving and storing the system metadata in local memory of given node 37 as configuration data and/or based on further accessing and/or executing this configuration data to recover segments via external retrieval requests and performing a rebuilding process upon corresponding segments as part of its database functionality accordingly. Performance of some or all features and/or functionality of FIG. 24D can optionally change and/or be updated over time, based on the system metadata applied across a plurality of nodes 37 that includes the given node being updated over time, and/or based on the given node updating its configuration data stored in local memory to reflect changes in the system metadata based on receiving data indicating these changes to the system metadata.

FIG. 24E illustrates an embodiment of an inner level 2414 that includes at least one shuffle node set 2485 of the plurality of nodes assigned to the corresponding inner level. A shuffle node set 2485 can include some or all of a plurality of nodes assigned to the corresponding inner level, where all nodes in the shuffle node set 2485 are assigned to the same inner level. In some cases, a shuffle node set 2485 can include nodes assigned to different levels 2410 of a query execution plan. A shuffle node set 2485 at a given time can include some nodes that are assigned to the given level, but are not participating in a query at that given time, as denoted with dashed outlines and as discussed in conjunction with FIG. 24A. For example, while a given one or more queries are being executed by nodes in the database system 10, a shuffle node set 2485 can be static, regardless of whether all of its members are participating in a given query at that time. In other cases, shuffle node set 2485 only includes nodes assigned to participate in a corresponding query, where different queries that are concurrently executing and/or executing in distinct time periods have different shuffle node sets 2485 based on which nodes are assigned to participate in the corresponding query execution plan. While FIG. 24E depicts multiple shuffle node sets 2485 of an inner level 2414, in some cases, an inner level can include exactly one shuffle node set, for example, that includes all possible nodes of the corresponding inner level 2414 and/or all participating nodes of the of the corresponding inner level 2414 in a given query execution plan.

While FIG. 24E depicts that different shuffle node sets 2485 can have overlapping nodes 37, in some cases, each shuffle node set 2485 includes a distinct set of nodes, for example, where the shuffle node sets 2485 are mutually exclusive. In some cases, the shuffle node sets 2485 are collectively exhaustive with respect to the corresponding inner level 2414, where all possible nodes of the inner level 2414, or all participating nodes of a given query execution plan at the inner level 2414, are included in at least one shuffle node set 2485 of the inner level 2414. If the query execution plan has multiple inner levels 2414, each inner level can include one or more shuffle node sets 2485. In some cases, a shuffle node set 2485 can include nodes from different inner levels 2414, or from exactly one inner level 2414. In some cases, the root level 2412 and/or the IO level 2416 have nodes included in shuffle node sets 2485. In some cases, the query execution plan 2405 includes and/or indicates assignment of nodes to corresponding shuffle node sets 2485 in addition to assigning nodes to levels 2410, where nodes 37 determine their participation in a given query as participating in one or more levels 2410 and/or as participating in one or more shuffle node sets 2485, for example, via downward propagation of this information from the root node to initiate the query execution plan 2405 as discussed previously.

The shuffle node sets 2485 can be utilized to enable transfer of information between nodes, for example, in accordance with performing particular operations in a given query that cannot be performed in isolation. For example, some queries require that nodes 37 receive data blocks from its children nodes in the query execution plan for processing, and that the nodes 37 additionally receive data blocks from other nodes at the same level 2410. In particular, query operations such as JOIN operations of a SQL query expression may necessitate that some or all additional records that were accessed in accordance with the query be processed in tandem to guarantee a correct resultant, where a node processing only the records retrieved from memory by its child IO nodes is not sufficient.

In some cases, a given node 37 participating in a given inner level 2414 of a query execution plan may send data blocks to some or all other nodes participating in the given inner level 2414, where these other nodes utilize these data blocks received from the given node to process the query via their query processing module 2435 by applying some or all operators of their query operator execution flow 2433 to the data blocks received from the given node. In some cases, a given node 37 participating in a given inner level 2414 of a query execution plan may receive data blocks to some or all other nodes participating in the given inner level 2414, where the given node utilizes these data blocks received from the other nodes to process the query via their query processing module 2435 by applying some or all operators of their query operator execution flow 2433 to the received data blocks.

This transfer of data blocks can be facilitated via a shuffle network 2480 of a corresponding shuffle node set 2485. Nodes in a shuffle node set 2485 can exchange data blocks in accordance with executing queries, for example, for execution of particular operators such as JOIN operators of their query operator execution flow 2433 by utilizing a corresponding shuffle network 2480. The shuffle network 2480 can correspond to any wired and/or wireless communication network that enables bidirectional communication between any nodes 37 communicating with the shuffle network 2480. In some cases, the nodes in a same shuffle node set 2485 are operable to communicate with some or all other nodes in the same shuffle node set 2485 via a direct communication link of shuffle network 2480, for example, where data blocks can be routed between some or all nodes in a shuffle network 2480 without necessitating any relay nodes 37 for routing the data blocks. In some cases, the nodes in a same shuffle set can broadcast data blocks.

In some cases, some nodes in a same shuffle node set 2485 do not have direct links via shuffle network 2480 and/or cannot send or receive broadcasts via shuffle network 2480 to some or all other nodes 37. For example, at least one pair of nodes in the same shuffle node set cannot communicate directly. In some cases, some pairs of nodes in a same shuffle node set can only communicate by routing their data via at least one relay node 37. For example, two nodes in a same shuffle node set do not have a direct communication link and/or cannot communicate via broadcasting their data blocks. However, if these two nodes in a same shuffle node set can each communicate with a same third node via corresponding direct communication links and/or via broadcast, this third node can serve as a relay node to facilitate communication between the two nodes. Nodes that are “further apart” in the shuffle network 2480 may require multiple relay nodes.

Thus, the shuffle network 2480 can facilitate communication between all nodes 37 in the corresponding shuffle node set 2485 by utilizing some or all nodes 37 in the corresponding shuffle node set 2485 as relay nodes, where the shuffle network 2480 is implemented by utilizing some or all nodes in the nodes shuffle node set 2485 and a corresponding set of direct communication links between pairs of nodes in the shuffle node set 2485 to facilitate data transfer between any pair of nodes in the shuffle node set 2485. Note that these relay nodes facilitating data blocks for execution of a given query within a shuffle node sets 2485 to implement shuffle network 2480 can be nodes participating in the query execution plan of the given query and/or can be nodes that are not participating in the query execution plan of the given query. In some cases, these relay nodes facilitating data blocks for execution of a given query within a shuffle node sets 2485 are strictly nodes participating in the query execution plan of the given query. In some cases, these relay nodes facilitating data blocks for execution of a given query within a shuffle node sets 2485 are strictly nodes that are not participating in the query execution plan of the given query.

Different shuffle node sets 2485 can have different shuffle networks 2480. These different shuffle networks 2480 can be isolated, where nodes only communicate with other nodes in the same shuffle node sets 2485 and/or where shuffle node sets 2485 are mutually exclusive. For example, data block exchange for facilitating query execution can be localized within a particular shuffle node set 2485, where nodes of a particular shuffle node set 2485 only send and receive data from other nodes in the same shuffle node set 2485, and where nodes in different shuffle node sets 2485 do not communicate directly and/or do not exchange data blocks at all. In some cases, where the inner level includes exactly one shuffle network, all nodes 37 in the inner level can and/or must exchange data blocks with all other nodes in the inner level via the shuffle node set via a single corresponding shuffle network 2480.

Alternatively, some or all of the different shuffle networks 2480 can be interconnected, where nodes can and/or must communicate with other nodes in different shuffle node sets 2485 via connectivity between their respective different shuffle networks 2480 to facilitate query execution. As a particular example, in cases where two shuffle node sets 2485 have at least one overlapping node 37, the interconnectivity can be facilitated by the at least one overlapping node 37, for example, where this overlapping node 37 serves as a relay node to relay communications from at least one first node in a first shuffle node sets 2485 to at least one second node in a second first shuffle node set 2485. In some cases, all nodes 37 in a shuffle node set 2485 can communicate with any other node in the same shuffle node set 2485 via a direct link enabled via shuffle network 2480 and/or by otherwise not necessitating any intermediate relay nodes. However, these nodes may still require one or more relay nodes, such as nodes included in multiple shuffle node sets 2485, to communicate with nodes in other shuffle node sets 2485, where communication is facilitated across multiple shuffle node sets 2485 via direct communication links between nodes within each shuffle node set 2485.

Note that these relay nodes facilitating data blocks for execution of a given query across multiple shuffle node sets 2485 can be nodes participating in the query execution plan of the given query and/or can be nodes that are not participating in the query execution plan of the given query. In some cases, these relay nodes facilitating data blocks for execution of a given query across multiple shuffle node sets 2485 are strictly nodes participating in the query execution plan of the given query. In some cases, these relay nodes facilitating data blocks for execution of a given query across multiple shuffle node sets 2485 are strictly nodes that are not participating in the query execution plan of the given query.

In some cases, a node 37 has direct communication links with its child node and/or parent node, where no relay nodes are required to facilitate sending data to parent and/or child nodes of the query execution plan 2405 of FIG. 24A. In other cases, at least one relay node may be required to facilitate communication across levels, such as between a parent node and child node as dictated by the query execution plan. Such relay nodes can be nodes within a and/or different same shuffle network as the parent node and child node, and can be nodes participating in the query execution plan of the given query and/or can be nodes that are not participating in the query execution plan of the given query.

Some or all features and/or functionality of FIG. 24E can be performed via at least one node 37 in conjunction with system metadata applied across a plurality of nodes 37, for example, where at least one node 37 participates in some or all features and/or functionality of FIG. 24E based on receiving and storing the system metadata in local memory of the at least one node 37 as configuration data and/or based on further accessing and/or executing this configuration data to participate in one or more shuffle node sets of FIG. 24E as part of its database functionality accordingly. Performance of some or all features and/or functionality of FIG. 24E can optionally change and/or be updated over time, and/or a set of nodes participating in executing some or all features and/or functionality of FIG. 24E can have changing nodes over time, based on the system metadata applied across the plurality of nodes 37 being updated over time, based on nodes on updating their configuration data stored in local memory to reflect changes in the system metadata based on receiving data indicating these changes to the system metadata, and/or based on nodes being added and/or removed from the plurality of nodes over time.

FIG. 24F illustrates an embodiment of a database system that receives some or all query requests from one or more external requesting entities 2912. The external requesting entities 2912 can be implemented as a client device such as a personal computer and/or device, a server system, or other external system that generates and/or transmits query requests 2914. A query resultant 2920 can optionally be transmitted back to the same or different external requesting entity 2912. Some or all query requests processed by database system 10 as described herein can be received from external requesting entities 2912 and/or some or all query resultants generated via query executions described herein can be transmitted to external requesting entities 2912.

For example, a user types or otherwise indicates a query for execution via interaction with a computing device associated with and/or communicating with an external requesting entity. The computing device generates and transmits a corresponding query request 2914 for execution via the database system 10, where the corresponding query resultant 2920 is transmitted back to the computing device, for example, for storage by the computing device and/or for display to the corresponding user via a display device.

As another example, a query is automatically generated for execution via processing resources via a computing device and/or via communication with an external requesting entity implemented via at least one computing device. For example, the query is automatically generated and/or modified from a request generated via user input and/or received from a requesting entity in conjunction with implementing a query generator system, a query optimizer, generative artificial intelligence (AI), and/or other artificial intelligence and/or machine learning techniques. The computing device generates and transmits a corresponding query request 2914 for execution via the database system 10, where the corresponding query resultant 2920 is transmitted back to the computing device, for example, for storage by the computing device, transmission to another system, and/or for display to at least one corresponding user via a display device.

Some or all features and/or functionality of FIG. 24F can be performed via at least one node 37 in conjunction with system metadata applied across a plurality of nodes 37, for example, where at least one node 37 participates in some or all features and/or functionality of FIG. 24F based on receiving and storing the system metadata in local memory of the at least one node 37 as configuration data, and/or based on further accessing and/or executing this configuration data to generate query execution plan data from query requests by implementing some or all of the operator flow generator module 2514 as part of its database functionality accordingly, and/or to participate in one or more query execution plans of a query execution module 2504 as part of its database functionality accordingly. Performance of some or all features and/or functionality of FIG. 24F can optionally change and/or be updated over time, and/or a set of nodes participating in executing some or all features and/or functionality of FIG. 24F can have changing nodes over time, based on the system metadata applied across the plurality of nodes 37 being updated over time, based on nodes on updating their configuration data stored in local memory to reflect changes in the system metadata based on receiving data indicating these changes to the system metadata, and/or based on nodes being added and/or removed from the plurality of nodes over time.

FIG. 24G illustrates an embodiment of a query processing system 2502 that generates a query operator execution flow 2517 from a query expression 2509 for execution via a query execution module 2504. The query processing system 2502 can be implemented utilizing, for example, the parallelized query and/or response sub-system 13 and/or the parallelized data store, retrieve, and/or process subsystem 12. The query processing system 2502 can be implemented by utilizing at least one computing device 18, for example, by utilizing at least one central processing module 39 of at least one node 37 utilized to implement the query processing system 2502. The query processing system 2502 can be implemented utilizing any processing module and/or memory of the database system 10, for example, communicating with the database system 10 via system communication resources 14.

As illustrated in FIG. 24G, an operator flow generator module 2514 of the query processing system 2502 can be utilized to generate a query operator execution flow 2517 for the query indicated in a query expression 2509. This can be generated based on a plurality of query operators indicated in the query expression and their respective sequential, parallelized, and/or nested ordering in the query expression (e.g. as an acyclic directed graph of operators), and/or based on optimizing the execution of the plurality of operators of the query expression. This query operator execution flow 2517 can include and/or be utilized to determine the query operator execution flow 2433 assigned to nodes 37 at one or more particular levels of the query execution plan 2405 and/or can include the operator execution flow to be implemented across a plurality of nodes 37, for example, based on a query expression indicated in the query request and/or based on optimizing the execution of the query expression.

In some cases, the operator flow generator module 2514 implements an optimizer to select the query operator execution flow 2517 based on determining the query operator execution flow 2517 is a most efficient and/or otherwise most optimal one of a set of query operator execution flow options and/or that arranges the operators in the query operator execution flow 2517 such that the query operator execution flow 2517 compares favorably to a predetermined efficiency threshold. For example, the operator flow generator module 2514 selects and/or arranges the plurality of operators of the query operator execution flow 2517 to implement the query expression in accordance with performing optimizer functionality, for example, by perform a deterministic function upon the query expression to select and/or arrange the plurality of operators in accordance with the optimizer functionality. This can be based on known and/or estimated processing times of different types of operators. This can be based on known and/or estimated levels of record filtering that will be applied by particular filtering parameters of the query. This can be based on selecting and/or deterministically utilizing a conjunctive normal form and/or a disjunctive normal form to build the query operator execution flow 2517 from the query expression. This can be based on selecting a determining a first possible serial ordering of a plurality of operators to implement the query expression based on determining the first possible serial ordering of the plurality of operators is known to be or expected to be more efficient than at least one second possible serial ordering of the same or different plurality of operators that implements the query expression. This can be based on ordering a first operator before a second operator in the query operator execution flow 2517 based on determining executing the first operator before the second operator results in more efficient execution than executing the second operator before the first operator. For example, the first operator is known to filter the set of records upon which the second operator would be performed to improve the efficiency of performing the second operator due to being executed upon a smaller set of records than if performed before the first operator. This can be based on other optimizer functionality that otherwise selects and/or arranges the plurality of operators of the query operator execution flow 2517 based on other known, estimated, and/or otherwise determined criteria.

A query execution module 2504 of the query processing system 2502 can execute the query expression via execution of the query operator execution flow 2517 to generate a query resultant. For example, the query execution module 2504 can be implemented via a plurality of nodes 37 that execute the query operator execution flow 2517. In particular, the plurality of nodes 37 of a query execution plan 2405 of FIG. 24A can collectively execute the query operator execution flow 2517. In such cases, nodes 37 of the query execution module 2504 can each execute their assigned portion of the query to produce data blocks as discussed previously, starting from IO level nodes propagating their data blocks upwards until the root level node processes incoming data blocks to generate the query resultant, where inner level nodes execute their respective query operator execution flow 2433 upon incoming data blocks to generate their output data blocks. The query execution module 2504 can be utilized to implement the parallelized query and results sub-system 13 and/or the parallelized data store, receive and/or process sub-system 12.

Some or all features and/or functionality of FIG. 24G can be performed via at least one node 37 in conjunction with system metadata applied across a plurality of nodes 37, for example, where at least one node 37 participates in some or all features and/or functionality of FIG. 24G based on receiving and storing the system metadata in local memory of the at least one node 37 as configuration data and/or based on further accessing and/or executing this configuration data to generate query execution plan data from query requests by executing some or all operators of a query operator flow 2517 as part of its database functionality accordingly. Performance of some or all features and/or functionality of FIG. 24G can optionally change and/or be updated over time, and/or a set of nodes participating in executing some or all features and/or functionality of FIG. 24G can have changing nodes over time, based on the system metadata applied across the plurality of nodes 37 being updated over time, based on nodes on updating their configuration data stored in local memory to reflect changes in the system metadata based on receiving data indicating these changes to the system metadata, and/or based on nodes being added and/or removed from the plurality of nodes over time.

FIG. 24H presents an example embodiment of a query execution module 2504 that executes query operator execution flow 2517. Some or all features and/or functionality of the query execution module 2504 of FIG. 24H can implement the query execution module 2504 of FIG. 24G and/or any other embodiment of the query execution module 2504 discussed herein. Some or all features and/or functionality of the query execution module 2504 of FIG. 24H can optionally be utilized to implement the query processing module 2435 of node 37 in FIG. 24B and/or to implement some or all nodes 37 at inner levels 2414 of a query execution plan 2405 of FIG. 24A.

The query execution module 2504 can execute the determined query operator execution flow 2517 by performing a plurality of operator executions of operators 2520 of the query operator execution flow 2517 in a corresponding plurality of sequential operator execution steps. Each operator execution step of the plurality of sequential operator execution steps can correspond to execution of a particular operator 2520 of a plurality of operators 2520-1-2520-M of a query operator execution flow 2433.

In some embodiments, a single node 37 executes the query operator execution flow 2517 as illustrated in FIG. 24H as their operator execution flow 2433 of FIG. 24B, where some or all nodes 37 such as some or all inner level nodes 37 utilize the query processing module 2435 as discussed in conjunction with FIG. 24B to generate output data blocks to be sent to other nodes 37 and/or to generate the final resultant by applying the query operator execution flow 2517 to input data blocks received from other nodes and/or retrieved from memory as read and/or recovered records. In such cases, the entire query operator execution flow 2517 determined for the query as a whole can be segregated into multiple query operator execution sub-flows 2433 that are each assigned to the nodes of each of a corresponding set of inner levels 2414 of the query execution plan 2405, where all nodes at the same level execute the same query operator execution flows 2433 upon different received input data blocks. In some cases, the query operator execution flows 2433 applied by each node 37 includes the entire query operator execution flow 2517, for example, when the query execution plan includes exactly one inner level 2414. In other embodiments, the query processing module 2435 is otherwise implemented by at least one processing module the query execution module 2504 to execute a corresponding query, for example, to perform the entire query operator execution flow 2517 of the query as a whole.

A single operator execution by the query execution module 2504, such as via a particular node 37 executing its own query operator execution flows 2433, by executing one of the plurality of operators of the query operator execution flow 2433. As used herein, an operator execution corresponds to executing one operator 2520 of the query operator execution flow 2433 on one or more pending data blocks 2537 in an operator input data set 2522 of the operator 2520. The operator input data set 2522 of a particular operator 2520 includes data blocks that were outputted by execution of one or more other operators 2520 that are immediately below the particular operator in a serial ordering of the plurality of operators of the query operator execution flow 2433. In particular, the pending data blocks 2537 in the operator input data set 2522 were outputted by the one or more other operators 2520 that are immediately below the particular operator via one or more corresponding operator executions of one or more previous operator execution steps in the plurality of sequential operator execution steps. Pending data blocks 2537 of an operator input data set 2522 can be ordered, for example as an ordered queue, based on an ordering in which the pending data blocks 2537 are received by the operator input data set 2522. Alternatively, an operator input data set 2522 is implemented as an unordered set of pending data blocks 2537.

If the particular operator 2520 is executed for a given one of the plurality of sequential operator execution steps, some or all of the pending data blocks 2537 in this particular operator 2520's operator input data set 2522 are processed by the particular operator 2520 via execution of the operator to generate one or more output data blocks. For example, the input data blocks can indicate a plurality of rows, and the operation can be a SELECT operator indicating a simple predicate. The output data blocks can include only proper subset of the plurality of rows that meet the condition specified by the simple predicate.

Once a particular operator 2520 has performed an execution upon a given data block 2537 to generate one or more output data blocks, this data block is removed from the operator's operator input data set 2522. In some cases, an operator selected for execution is automatically executed upon all pending data blocks 2537 in its operator input data set 2522 for the corresponding operator execution step. In this case, an operator input data set 2522 of a particular operator 2520 is therefore empty immediately after the particular operator 2520 is executed. The data blocks outputted by the executed data block are appended to an operator input data set 2522 of an immediately next operator 2520 in the serial ordering of the plurality of operators of the query operator execution flow 2433, where this immediately next operator 2520 will be executed upon its data blocks once selected for execution in a subsequent one of the plurality of sequential operator execution steps.

Operator 2520.1 can correspond to a bottom-most operator 2520 in the serial ordering of the plurality of operators 2520.1-2520.M. As depicted in FIG. 24G, operator 2520.1 has an operator input data set 2522.1 that is populated by data blocks received from another node as discussed in conjunction with FIG. 24B, such as a node at the IO level of the query execution plan 2405. Alternatively these input data blocks can be read by the same node 37 from storage, such as one or more memory devices that store segments that include the rows required for execution of the query. In some cases, the input data blocks are received as a stream over time, where the operator input data set 2522.1 may only include a proper subset of the full set of input data blocks required for execution of the query at a particular time due to not all of the input data blocks having been read and/or received, and/or due to some data blocks having already been processed via execution of operator 2520.1. In other cases, these input data blocks are read and/or retrieved by performing a read operator or other retrieval operation indicated by operator 2520.

Note that in the plurality of sequential operator execution steps utilized to execute a particular query, some or all operators will be executed multiple times, in multiple corresponding ones of the plurality of sequential operator execution steps. In particular, each of the multiple times a particular operator 2520 is executed, this operator is executed on set of pending data blocks 2537 that are currently in their operator input data set 2522, where different ones of the multiple executions correspond to execution of the particular operator upon different sets of data blocks that are currently in their operator queue at corresponding different times.

As a result of this mechanism of processing data blocks via operator executions performed over time, at a given time during the query's execution by the node 37, at least one of the plurality of operators 2520 has an operator input data set 2522 that includes at least one data block 2537. At this given time, one more other ones of the plurality of operators 2520 can have input data sets 2522 that are empty. For example, a given operator's operator input data set 2522 can be empty as a result of one or more immediately prior operators 2520 in the serial ordering not having been executed yet, and/or as a result of the one or more immediately prior operators 2520 not having been executed since a most recent execution of the given operator.

Some types of operators 2520, such as JOIN operators or aggregating operators such as SUM, AVERAGE, MAXIMUM, or MINIMUM operators, require knowledge of the full set of rows that will be received as output from previous operators to correctly generate their output. As used herein, such operators 2520 that must be performed on a particular number of data blocks, such as all data blocks that will be outputted by one or more immediately prior operators in the serial ordering of operators in the query operator execution flow 2517 to execute the query, are denoted as “blocking operators.” Blocking operators are only executed in one of the plurality of sequential execution steps if their corresponding operator queue includes all of the required data blocks to be executed. For example, some or all blocking operators can be executed only if all prior operators in the serial ordering of the plurality of operators in the query operator execution flow 2433 have had all of their necessary executions completed for execution of the query, where none of these prior operators will be further executed in accordance with executing the query.

Some operator output generated via execution of an operator 2520, alternatively or in addition to being added to the input data set 2522 of a next sequential operator in the sequential ordering of the plurality of operators of the query operator execution flow 2433, can be sent to one or more other nodes 37 in a same shuffle node set as input data blocks to be added to the input data set 2522 of one or more of their respective operators 2520. In particular, the output generated via a node's execution of an operator 2520 that is serially before the last operator 2520.M of the node's query operator execution flow 2433 can be sent to one or more other nodes 37 in a same shuffle node set as input data blocks to be added to the input data set 2522 of a respective operators 2520 that is serially after the last operator 2520.1 of the query operator execution flow 2433 of the one or more other nodes 37.

As a particular example, the node 37 and the one or more other nodes 37 in a shuffle node set all execute queries in accordance with the same, common query operator execution flow 2433, for example, based on being assigned to a same inner level 2414 of the query execution plan 2405. The output generated via a node's execution of a particular operator 2520.i this common query operator execution flow 2433 can be sent to the one or more other nodes 37 in a same shuffle node set as input data blocks to be added to the input data set 2522 the next operator 2520.i+1, with respect to the serialized ordering of the query of this common query operator execution flow 2433 of the one or more other nodes 37. For example, the output generated via a node's execution of a particular operator 2520.i is added input data set 2522 the next operator 2520.i+1 of the same node's query operator execution flow 2433 based on being serially next in the sequential ordering and/or is alternatively or additionally added to the input data set 2522 of the next operator 2520.i+1 of the common query operator execution flow 2433 of the one or more other nodes in a same shuffle node set based on being serially next in the sequential ordering.

In some cases, in addition to a particular node sending this output generated via a node's execution of a particular operator 2520.i to one or more other nodes to be input data set 2522 the next operator 2520.i+1 in the common query operator execution flow 2433 of the one or more other nodes 37, the particular node also receives output generated via some or all of these one or more other nodes' execution of this particular operator 2520.i in their own query operator execution flow 2433 upon their own corresponding input data set 2522 for this particular operator. The particular node adds this received output of execution of operator 2520.i by the one or more other nodes to the be input data set 2522 of its own next operator 2520.i+1.

This mechanism of sharing data can be utilized to implement operators that require knowledge of all records of a particular table and/or of a particular set of records that may go beyond the input records retrieved by children or other descendants of the corresponding node. For example, JOIN operators can be implemented in this fashion, where the operator 2520.i+1 corresponds to and/or is utilized to implement JOIN operator and/or a custom-join operator of the query operator execution flow 2517, and where the operator 2520.i+1 thus utilizes input received from many different nodes in the shuffle node set in accordance with their performing of all of the operators serially before operator 2520.i+1 to generate the input to operator 2520.i+1.

Some or all features and/or functionality of FIG. 24H can be performed via at least one node 37 in conjunction with system metadata applied across a plurality of nodes 37, for example, where at least one node 37 participates in some or all features and/or functionality of FIG. 24H based on receiving and storing the system metadata in local memory of the at least one node 37 as configuration data and/or based on further accessing and/or executing this configuration data execute some or all operators of a query operator flow 2517 as part of its database functionality accordingly. Performance of some or all features and/or functionality of FIG. 24H can optionally change and/or be updated over time, and/or a set of nodes participating in executing some or all features and/or functionality of FIG. 24H can have changing nodes over time, based on the system metadata applied across the plurality of nodes 37 being updated over time, based on nodes on updating their configuration data stored in local memory to reflect changes in the system metadata based on receiving data indicating these changes to the system metadata, and/or based on nodes being added and/or removed from the plurality of nodes over time.

FIG. 24I illustrates an example embodiment of multiple nodes 37 that execute a query operator execution flow 2433. For example, these nodes 37 are at a same level 2410 of a query execution plan 2405, and receive and perform an identical query operator execution flow 2433 in conjunction with decentralized execution of a corresponding query. Each node 37 can determine this query operator execution flow 2433 based on receiving the query execution plan data for the corresponding query that indicates the query operator execution flow 2433 to be performed by these nodes 37 in accordance with their participation at a corresponding inner level 2414 of the corresponding query execution plan 2405 as discussed in conjunction with FIG. 24G. This query operator execution flow 2433 utilized by the multiple nodes can be the full query operator execution flow 2517 generated by the operator flow generator module 2514 of FIG. 24G. This query operator execution flow 2433 can alternatively include a sequential proper subset of operators from the query operator execution flow 2517 generated by the operator flow generator module 2514 of FIG. 24G, where one or more other sequential proper subsets of the query operator execution flow 2517 are performed by nodes at different levels of the query execution plan.

Each node 37 can utilize a corresponding query processing module 2435 to perform a plurality of operator executions for operators of the query operator execution flow 2433 as discussed in conjunction with FIG. 24H. This can include performing an operator execution upon input data sets 2522 of a corresponding operator 2520, where the output of the operator execution is added to an input data set 2522 of a sequentially next operator 2520 in the operator execution flow, as discussed in conjunction with FIG. 24H, where the operators 2520 of the query operator execution flow 2433 are implemented as operators 2520 of FIG. 24H. Some or operators 2520 can correspond to blocking operators that must have all required input data blocks generated via one or more previous operators before execution. Each query processing module can receive, store in local memory, and/or otherwise access and/or determine necessary operator instruction data for operators 2520 indicating how to execute the corresponding operators 2520.

Some or all features and/or functionality of FIG. 24I can be performed via at least one node 37 in conjunction with system metadata applied across a plurality of nodes 37, for example, where at least one node 37 participates in some or all features and/or functionality of FIG. 24I based on receiving and storing the system metadata in local memory of the at least one node 37 as configuration data and/or based on further accessing and/or executing this configuration data to execute some or all operators of a query operator flow 2517 in parallel with other nodes, send data blocks to a parent node, and/or process data blocks from child nodes as part of its database functionality accordingly. Performance of some or all features and/or functionality of FIG. 24I can optionally change and/or be updated over time, and/or a set of nodes participating in executing some or all features and/or functionality of FIG. 24I can have changing nodes over time, based on the system metadata applied across the plurality of nodes 37 being updated over time, based on nodes on updating their configuration data stored in local memory to reflect changes in the system metadata based on receiving data indicating these changes to the system metadata, and/or based on nodes being added and/or removed from the plurality of nodes over time.

FIG. 24J illustrates an embodiment of a query execution module 2504 that executes each of a plurality of operators of a given operator execution flow 2517 via a corresponding one of a plurality of operator execution modules 3215. The operator execution modules 3215 of FIG. 24J can be implemented to execute any operators 2520 being executed by a query execution module 2504 for a given query as described herein.

In some embodiments, a given node 37 can optionally execute one or more operators, for example, when participating in a corresponding query execution plan 2405 for a given query, by implementing some or all features and/or functionality of the operator execution module 3215, for example, by implementing its operator processing module 2435 to execute one or more operator execution modules 3215 for one or more operators 2520 being processed by the given node 37. For example, a plurality of nodes of a query execution plan 2405 for a given query execute their operators based on implementing corresponding query processing modules 2435 accordingly.

FIG. 24K illustrates an embodiment of database storage 2450 operable to store a plurality of database tables 2712, such as relational database tables or other database tables as described previously herein. Database storage 2450 can be implemented via the parallelized data store, retrieve, and/or process sub-system 12, via memory drives 2425 of one or more nodes 37 implementing the database storage 2450, and/or via other memory and/or storage resources of database system 10. The database tables 2712 can be stored as segments as discussed in conjunction with FIGS. 15-23 and/or FIGS. 24B-24D. A database table 2712 can be implemented as one or more datasets and/or a portion of a given dataset, such as the dataset of FIG. 15.

A given database table 2712 can be stored based on being received for storage, for example, via the parallelized ingress sub-system 24 and/or via other data ingress. Alternatively or in addition, a given database table 2712 can be generated and/or modified by the database system 10 itself based on being generated as output of a query executed by query execution module 2504, such as a Create Table As Select (CTAS) query or Insert query.

A given database table 2712 can be in accordance with a schema 2409 defining columns of the database table, where records 2422 correspond to rows having values 2708 for some or all of these columns. Different database tables can have different numbers of columns and/or different datatypes for values stored in different columns. For example, the set of columns 2707.1A-2707.CA of schema 2709.A for database table 2712.A can have a different number of columns than and/or can have different datatypes for some or all columns of the set of columns 2707.1B-2707.CB of schema 2709.B for database table 2712.B. The schema 2409 for a given n database table 2712 can denote same or different datatypes for some or all of its set of columns. For example, some columns are variable-length and other columns are fixed-length. As another example, some columns are integers, other columns are binary values, other columns are Strings, and/or other columns are char types. The schema 2409 for a given database table can denote the name/identifier of a corresponding relational database table.

A given schema 2409 can indicate such schemas for a plurality of tables, for example, of a same dataset, same database, and/or same user entity (e.g. that has access to/supplied data for these tables under the given schema 2409). For example, a given schema 2409 is configured by/otherwise corresponds to a given user entity.

Row reads performed during query execution, such as row reads performed at the IO level of a query execution plan 2405, can be performed by reading values 2708 for one or more specified columns 2707 of the given query for some or all rows of one or more specified database tables, as denoted by the query expression defining the query to be performed. Filtering, join operations, and/or values included in the query resultant can be further dictated by operations to be performed upon the read values 2708 of these one or more specified columns 2707.

FIG. 24L illustrates an embodiment of a dataset 2502 having one or more columns 3023 implemented as array fields 2712. Some or all features and/or functionality of the dataset 2502 of FIG. 24L can be utilized to implement one or more of the database tables 2712 of FIG. 24K and/or any embodiment of any database table and/or dataset received, stored, and processed via the database system 10 as described herein.

Columns 3023 implemented as array fields 2712 can include array structures 2718 as values 3024 for some or all rows. A given array structure 2718 can have a set of elements 2709.1-2709.M. The value of M can be fixed for a given array field 2712, or can be different for different array structures 2718 of a given array field 2712. In embodiments where the number of elements is fixed, different array fields 2712 can have different fixed numbers of array elements 2709, for example, where a first array field 2712.A has array structures having M elements, and where a second array field 2712.B has array structures having N elements.

Note that a given array structure 2718 of a given array field can optionally have zero elements, where such array structures are considered as empty arrays satisfying the empty array condition. An empty array structure 2718 is distinct from a null value 3852, as it is a defined structure as an array 2718, despite not being populated with any values. For example, consider an example where an array field for rows corresponding to people is implemented to note a list of spouse names for all marriages of each person. An empty array for this array field for a first given row denotes a first corresponding person was never married, while a null value for this array field for a second given row denotes that it is unknown as to whether the second corresponding person was ever married, or who they were married to.

Array elements 2709 of a given array structure can have the same or different data type. In some embodiments, data types of array elements 2709 can be fixed for a given array field (e.g. all array elements 2709 of all array structures 2718 of array field 2712.A are string values, and all array elements 2709 of all array structures 2718 of array field 2712.B are integer values). In other embodiments, data types of array elements 2709 can be different for a given array field and/or a given array structure.

Some array structures 2718 that are non-empty can have one or more array elements having the null value 3852, where the corresponding value 3024 thus meets the null-inclusive array condition. This is distinct from the null value condition 3842, as the value 3024 itself is not null, but is instead an array structure 2718 having some or all of its array elements 2709 with values of null. Continuing example where an array field for rows corresponding to people is implemented to note a list of spouse names for all marriages of each person, a null value for this array field for the second given row denotes that it is unknown as to whether the second corresponding person was ever married or who they were married to, while a null value within an array structure for a third given row denotes that the name of the spouse for a corresponding one of a set of marriages of the person is unknown.

Some array structures 2718 that are non-empty can have all non-null values for its array elements 2709, where all corresponding array elements 2709 were populated and/or defined. Some array structures 2718 that are non-empty can have values for some of its array elements 2709 that are null, and values for others of its array elements 2709 that are non-null values.

Some array structures 2718 that are non-empty can have values for all of its array elements 2709 that are null. This is still distinct from the case where the value 3024 denotes a value of null with no array structure 2718. Continuing example where an array field for rows corresponding to people is implemented to note a list of spouse names for all marriages of each person, a null value for this array field for the second given row denotes that it is unknown as to whether the second corresponding person was ever married, how many times they were married or who they were married to, while the array structure for the third given row denotes a set of three null values and non-null values, denoting that the person was married three times, but the names of the spouses for all three marriages are unknown.

FIGS. 24M-24N illustrates an example embodiment of a query execution module 2504 of a database system 10 that executes queries via generation, storage, and/or communication of a plurality of column data streams 2968 corresponding to a plurality of columns. Some or all features and/or functionality of query execution module 2504 of FIGS. 24M-24N can implement any embodiment of query execution module 2504 described herein and/or any performance of query execution described herein. Some or all features and/or functionality of column data streams 2968 of FIGS. 24M-24N can implement any embodiment of data blocks 2537 and/or other communication of data between operators 2520 of a query operator execution flow 2517 when executed by a query execution module 2504, for example, via a corresponding plurality of operator execution modules 3215.

As illustrated in FIG. 24M, in some embodiments, data values of each given column 2915 are included in data blocks of their own respective column data stream 2968. Each column data stream 2968 can correspond to one given column 2915, where each given column 2915 is included in one data stream included in and/or referenced by output data blocks generated via execution of one or more operator execution module 3215, for example, to be utilized as input by one or more other operator execution modules 3215. Different columns can be designated for inclusion in different data streams. For example, different column streams are written do different portions of memory, such as different sets of memory fragments of query execution memory resources.

As illustrated in FIG. 24N, each data block 2537 of a given column data stream 2968 can include values 2918 for the respective column for one or more corresponding rows 2916. In the example of FIG. 24N, each data block includes values for V corresponding rows, where different data blocks in the column data stream include different respective sets of V rows, for example, that are each a subset of a total set of rows to be processed. In other embodiments, different data blocks can have different numbers of rows. The subsets of rows across a plurality of data blocks 2537 of a given column data stream 2968 can be mutually exclusive and collectively exhaustive with respect to the full output set of rows, for example, emitted by a corresponding operator execution module 3215 as output.

Values 2918 of a given row utilized in query execution are thus dispersed across different A given column 2915 can be implemented as a column 2707 having corresponding values 2918 implemented as values 2708 read from database table 2712 read from database storage 2450, for example, via execution of corresponding 10 operators. Alternatively or in addition, a given column 2915 can be implemented as a column 2707 having new and/or modified values generated during query execution, for example, via execution of an extend expression and/or other operation. Alternatively or in addition, a given column 2915 can be implemented as a new column generated during query execution having new values generated accordingly, for example, via execution of an extend expression and/or other operation. The set of column data streams 2968 generated and/or emitted between operators in query execution can correspond to some or all columns of one or more tables 2712 and/or new columns of an existing table and/or of a new table generated during query execution.

Additional column streams emitted by the given operator execution module can have their respective values for the same full set of output rows across for other respective columns. For example, the values across all column streams are in accordance with a consistent ordering, where a first row's values 2918.1.1-2918.1.C for columns 2915.1-2915.C are included first in every respective column data stream, where a second row's values 2918.2.1-2918.2.C for columns 2915.1-2915.C are included second in every respective column data stream, and so on. In other embodiments, rows are optionally ordered differently in different column streams. Rows can be identified across column streams based on consistent ordering of values, based on being mapped to and/or indicating row identifiers, or other means.

As a particular example, for every fixed-length column, a huge block can be allocated to initialize a fixed length column stream, which can be implemented via mutable memory as a mutable memory column stream, and/or for every variable-length column, another huge block can be allocated to initialize a binary stream, which can be implemented via mutable memory as a mutable memory binary stream. A given column data stream 2968 can be continuously appended with fixed length values to data runs of contiguous memory and/or may grow the underlying huge page memory region to acquire more contiguous runs and/or fragments of memory.

In other embodiments, rather than emitting data blocks with values 2918 for different columns in different column streams, values 2918 for a set of multiple columns can be emitted in a same multi-column data stream.

FIG. 24O illustrates an example of operator execution modules 3215.C that each write their output memory blocks to one or more memory fragments 2622 of query execution memory resources 3045 and/or that each read/process input data blocks based on accessing the one or more memory fragments 2622 Some or all features and/or functionality of the operator execution modules 3215 of FIG. 24O can implement the operator execution modules of FIG. 24J and/or can implement any query execution described herein. The data blocks 2537 can implement the data blocks of column streams of FIGS. 24M and/or 24N, and/or any operator 2520's input data blocks and/or output data blocks described herein.

A given operator execution module 3215.A for an operator that is a child operator of the operator executed by operator execution module 3215.B can emit its output data blocks for processing by operator execution module 3215.B based on writing each of a stream of data blocks 2537.1-2537.K of data stream 2917.A to contiguous or non-contiguous memory fragments 2622 at one or more corresponding memory locations 2951 of query execution memory resources 3045.

Operator execution module 3215.A can generate these data blocks 2537.1-2537.K of data stream 2917.A in conjunction with execution of the respective operator on incoming data. This incoming data can correspond to one or more other streams of data blocks 2537 of another data stream 2917 accessed in memory resources 3045 based on being written by one or more child operator execution modules corresponding to child operators of the operator executed by operator execution module 3215.A. Alternatively or in addition, the incoming data is read from database storage 2450 and/or is read from one or more segments stored on memory drives, for example, based on the operator executed by operator execution module 3215.A being implemented as an IO operator.

The parent operator execution module 3215.B of operator execution module 3215.A can generate its own output data blocks 2537.1-2537.J of data stream 2917.B based on execution of the respective operator upon data blocks 2537.1-2537.K of data stream 2917.A. Executing the operator can include reading the values from and/or performing operations toy filter, aggregate, manipulate, generate new column values from, and/or otherwise determine values that are written to data blocks 2537.1-2537.J.

In other embodiments, the operator execution module 3215.B does not read the values from these data blocks, and instead forwards these data blocks, for example, where data blocks 2537.1-2537.J include memory reference data for the data blocks 2537.1-2537.K to enable one or more parent operator modules, such as operator execution module 3215.C, to access and read the values from forwarded streams.

In the case where operator execution module 3215.A has multiple parents, the data blocks 2537.1-2537.K of data stream 2917.A can be read, forwarded, and/or otherwise processed by each parent operator execution module 3215 independently in a same or similar fashion. Alternatively or in addition, in the case where operator execution module 3215.B has multiple children, each child's emitted set of data blocks 2537 of a respective data stream 2917 can be read, forwarded, and/or otherwise processed by operator execution module 3215.B in a same or similar fashion.

The parent operator execution module 3215.C of operator execution module 3215.B can similarly read, forward, and/or otherwise process data blocks 2537.1-2537.J of data stream 2917.B based on execution of the respective operator to render generation and emitting of its own data blocks in a similar fashion. Executing the operator can include reading the values from and/or performing operations to filter, aggregate, manipulate, generate new column values from, and/or otherwise process data blocks 2537.1-2537.J to determine values that are written to its own output data. For example, the operator execution module 3215.C reads data blocks 2537.1-2537.K of data stream 2917.A and/or the operator execution module 3215.B writes data blocks 2537.1-2537.J of data stream 2917.B. As another example, the operator execution module 3215.C reads data blocks 2537.1-2537.K of data stream 2917.A, or data blocks of another descendent, based on having been forwarded, where corresponding memory reference information denoting the location of these data blocks is read and processed from the received data blocks data blocks 2537.1-2537.J of data stream 2917.B enable accessing the values from data blocks 2537.1-2537.K of data stream 2917.A. As another example, the operator execution module 3215.B does not read the values from these data blocks, and instead forwards these data blocks, for example, where data blocks 2537.1-2537.J include memory reference data for the data blocks 2537.1-2537.J to enable one or more parent operator modules to read these forwarded streams.

This pattern of reading and/or processing input data blocks from one or more children for use in generating output data blocks for one or more parents can continue until ultimately a final operator, such as an operator executed by a root level node, generates a query resultant, which can itself be stored as data blocks in this fashion in query execution memory resources and/or can be transmitted to a requesting entity for display and/or storage.

For example, rather than accessing this large data for some or all potential records prior to filtering in a query execution, for example, via IO level 2416 of a corresponding query execution plan 2405 as illustrated in FIGS. 24A and 24C, and/or rather than passing this large data to other nodes 37 for processing, for example, from IO level nodes 37 to inner level nodes 37 and/or between any nodes 37 as illustrated in FIGS. 24A, 24B, and 24C, this large data is not accessed until a final stage of a query. As a particular example, this large data of the projected field is simply joined at the end of the query for the corresponding outputted rows that meet query predicates of the query. This ensures that, rather than accessing and/or passing the large data of these fields for some or all possible records that may be projected in the resultant, only the large data of these fields for final, filtered set of records that meet the query predicates are accessed and projected.

FIG. 24P illustrates an embodiment of a database system 10 that implements a segment generator 2507 to generate segments 2424. Some or all features and/or functionality of the database system 10 of FIG. 24P can implement any embodiment of the database system 10 described herein. Some or all features and/or functionality of segments 2424 of FIG. 24P can implement any embodiment of segment 2424 described herein.

A plurality of records 2422.1-2422.Z of one or more datasets 2505 to be converted into segments can be processed to generate a corresponding plurality of segments 2424.1-2424.Y. Each segment can include a plurality of column slabs 2610.1-2610.C corresponding to some or all of the C columns of the set of records.

In some embodiments, the dataset 2505 can correspond to a given database table 2712. In some embodiments, the dataset 2505 can correspond to only portion of a given database table 2712 (e.g. the most recently received set of records of a stream of records received for the table over time), where other datasets 2505 are later processed to generate new segments as more records are received over time. In some embodiments, the dataset 2505 can correspond to multiple database tables. The dataset 2505 optionally includes non-relational records and/or any records/files/data that is received from/generated by a given data source multiple different data sources.

Each record 2422 of the incoming dataset 2505 can be assigned to be included in exactly one segment 2424. In this example, segment 2424.1 includes at least records 2422.3 and 2422.7, while segment 2424 includes at least records 2422.1 and 2422.9. All of the Z records can be guaranteed to be included in exactly one segment by segment generator 2507. Rows are optionally grouped into segments based on a cluster-key based grouping or other grouping by same or similar column values of one or more columns. Alternatively, rows are optionally grouped randomly, in accordance with a round robin fashion, or by any other means.

A given row 2422 can thus have all of its column values 2708.1-2708.C included in exactly one given segment 2424, where these column values are dispersed across different column slabs 2610 based on which columns each column value corresponds. This division of column values into different column slabs can implement the columnar-format of segments described herein. The generation of column slabs can optionally include further processing of each set of column values assigned to each column slab. For example, some or all column slabs are optionally compressed and stored as compressed column slabs.

The database storage 2450 can thus store one or more datasets as segments 2424, for example, where these segments 2424 are accessed during query execution to identify/read values of rows of interest as specified in query predicates, where these identified rows/the respective values are further filtered/processed/etc., for example, via operators 2520 of a corresponding query operator execution flow 2517, or otherwise accordance with the query to render generation of the query resultant.

FIG. 24Q illustrates an example embodiment of a segment generator 2507 of database system 10. Some or all features and/or functionality of the database system 10 of FIG. 24Q can implement any embodiment of the database system 10 described herein. Some or all features and/or functionality of the segment generator 2507 of FIG. 24Q can implement the segment generator 2507 of FIG. 24P and/or any embodiment of the segment generator 2507 described herein.

The segment generator 2507 can implement a cluster key-based grouping module 2620 to group records of a dataset 2505 by a predetermined cluster key 2607, which can correspond to one or more columns. The cluster key can be received, accessed in memory, configured via user input, automatically selected based on an optimization, or otherwise determined. This grouping by cluster key can render generation of a plurality of record groups 2625.1-2625.X.

The segment generator 2507 can implement a columnar rotation module 2630 to generate a plurality of column formatted record data (e.g. column slabs 2610 to be included in respective segments 2424). Each record group 2625 can have a corresponding set of J column-formatted record data 2565.1-2565.J generated, for example, corresponding to J segments in a given segment group.

A metadata generator module 2640 can further generate parity data, index data, statistical data, and/or other metadata to be included in segments in conjunction with the column-formatted record data. A set of X segment groups corresponding to the X record groups can be generated and stored in database storage 2450. For example, each segment group includes J segments, where parity data of a proper subset of segments in the segment group can be utilized to rebuild column-formatted record data of other segments in the same segment group as discussed previously.

In some embodiments, the segment generator 2507 implements some or all features and/or functionality of the segment generator disclosed by: U.S. Utility application Ser. No. 16/985,723, entitled “DELAYING SEGMENT GENERATION IN DATABASE SYSTEMS”, filed Aug. 5, 2020, which is hereby incorporated herein by reference in its entirety and made part of the present U.S. Utility Patent Application for all purposes; U.S. Utility application Ser. No. 16/985,957 entitled “PARALLELIZED SEGMENT GENERATION VIA KEY-BASED SUBDIVISION IN DATABASE SYSTEMS”, filed Aug. 5, 2020, which is hereby incorporated herein by reference in its entirety and made part of the present U.S. Utility Patent Application for all purposes; and/or U.S. Utility application Ser. No. 16/985,930, entitled “RECORD DEDUPLICATION IN DATABASE SYSTEMS”, filed Aug. 5, 2020, issued as U.S. Pat. No. 11,321,288 on May 3, 2022, which is hereby incorporated herein by reference in its entirety and made part of the present U.S. Utility Patent Application for all purposes. For example, the database system 10 implements some or all features and/or functionality of record processing and storage system of U.S. Utility application Ser. No. 16/985,723, U.S. Utility application Ser. No. 16/985,957, and/or U.S. Utility application Ser. No. 16/985,930.

FIG. 24R illustrates an embodiment of a query processing system 2510 that implements an IO pipeline generator module 2834 to generate a plurality of IO pipelines 2835.1-2835.R for a corresponding plurality of segments 2424.1-2424.R, where these IO pipelines 2835.1-2835.R are each executed by an IO operator execution module 2840 to facilitate generation of a filtered record set by accessing the corresponding segment. Some or all features and/or functionality of the query processing system 2510 of FIG. 24R can implement any embodiment of query processing system 2510, any embodiment of query execution module 2504, and/or any embodiment of executing a query described herein.

Each IO pipeline 2835 can be generated based on corresponding segment configuration data 2833 for the corresponding segment 2424, such as secondary indexing data for the segment, statistical data/cardinality data for the segment, compression schemes applied to the column slabs of the segment, or other information denoting how the segment is configured. For example, different segments 2424 have different IO pipelines 2835 generated for a given query based on having different secondary indexing schemes, different statistical data/cardinality data for its values, different compression schemes applied for some of all of the columns of its records, or other differences.

An IO operator execution module 2840 can execute each respective IO pipeline 2835. For example, the IO operator execution module 2840 is implemented by nodes 37 at the IO level of a corresponding query execution plan 2405, where a node 37 storing a given segment 2424 is responsible for accessing the segment as described previously, and thus executes the IO pipeline for the given segment.

This execution of IO pipelines 2835 by IO operator execution module 2840 correspond to executing IO operators 2421 of a query operator execution flow 2517. The output of IO operators 2421 can correspond to output of IO operators 2421 and/or output of IO level. This output can correspond to data blocks that are further processed via additional operators 2520, for example, by nodes at inner levels and/or the root level of a corresponding query execution plan.

Each IO pipeline 2835 can be generated based on pushing some or all filtering down to the IO level, where query predicates are applied via the IO pipeline based on accessing index structures, sourcing values, filtering rows, etc. Each IO pipeline 2835 can be generated to render semantically equivalent application of query predicates, despite differences in how the IO pipeline is arranged/executed for the given segment. For example, an index structure of a first segment is used to identify a set of rows meeting a condition for a corresponding column in a first corresponding IO pipeline while a second segment has its row values sourced and compared to a value to identify which rows meet the condition, for example, based on the first segment having the corresponding column indexed and the second segment not having the corresponding column indexed. As another example, the IO pipeline for a first segment applies a compressed column slab processing element to identify where rows are stored in a compressed column slab and to further facilitate decompression of the rows, while a second segment accesses this column slab directly for the corresponding column based on this column being compressed in the first segment and being uncompressed for the second segment.

FIG. 24S illustrates an example embodiment of an IO pipeline 2835 that is generated to include one or more index elements 3512, one or more source elements 3014, and/or one or more filter elements 3016. These elements can be arranged in a serialized ordering that includes one or more parallelized paths (e.g. the IO pipeline includes an acyclic directed graph of elements). These elements can implement sourcing and/or filtering of rows based on query predicates 2822 applied to one or more columns, identified by corresponding column identifiers 3041 and corresponding filter parameters 3048. Some or all features and/or functionality of the IO pipeline 2835 and/or IO pipeline generator module 2834 of FIG. 24S can implement the IO pipeline 2835 and/or IO pipeline generator module 2834 of FIG. 24R, and/or any embodiment of IO pipeline 2835, of IO pipeline generator module 2834, or of any query execution via accessing segments described herein.

In some embodiments, the IO pipeline generator module 2834, IO pipeline 2835, IO operator execution module 2840, and/or any embodiment of IO pipeline generation and/or IO pipeline execution described herein, implements some or all features and/or functionality of the IO pipeline generator module 2834, IO pipeline 2835, IO operator execution module 2840, and/or pushing of filtering and/or other operations to the IO level as disclosed by: U.S. Utility application Ser. No. 17/303,437, entitled “QUERY EXECUTION UTILIZING PROBABILISTIC INDEXING” and filed May 28, 2021; U.S. Utility application Ser. No. 17/450,109, entitled “MISSING DATA-BASED INDEXING IN DATABASE SYSTEMS” and filed Oct. 6, 2021; U.S. Utility application Ser. No. 18/310,177, entitled “OPTIMIZING AN OPERATOR FLOW FOR PERFORMING AGGREGATION VIA A DATABASE SYSTEM” and filed May 1, 2023; U.S. Utility application Ser. No. 18/355,505, entitled “STRUCTURING GEOSPATIAL INDEX DATA FOR ACCESS DURING QUERY EXECUTION VIA A DATABASE SYSTEM” and filed Jul. 20, 2023; and/or U.S. Utility application Ser. No. 18/485,861, entitled “QUERY PROCESSING IN A DATABASE SYSTEM BASED ON APPLYING A DISJUNCTION OF CONJUNCTIVE NORMAL FORM PREDICATES” and filed Oct. 12, 2023; all of which hereby incorporated herein by reference in its entirety and made part of the present U.S. Utility Patent Application for all purposes.

FIG. 24T presents an embodiment of a database system 10 that includes a plurality of storage clusters 2535. Storage clusters 2535.1-2535.Z of FIG. 24T can implement some or all features and/or functionality of storage clusters 35-1-35-Z described herein, and/or can implement some or all features and/or functionality of any embodiment of a storage cluster described herein. Some or all features and/or functionality of database system 10 of FIG. 24T can implement any embodiment of database system 10 described herein.

Each storage cluster 2535 can be implemented via a corresponding plurality of nodes 37. In some embodiments, a given node 37 of database system 10 is optionally included in exactly one storage cluster. In some embodiments, one or more nodes 37 of database system 10 are optionally included in no storage clusters (e.g. aren't configured to store segments). In some embodiments, one or more nodes 37 of database system 10 can be included in multiple storage clusters.

In some embodiments, some or all nodes 37 in a storage cluster 2535 participate at the IO level 2416 in query execution plans based on storing segments 2424 in corresponding memory drives 2425, and based on accessing these segments 2424 during query execution. This can include executing corresponding IO operators, for example, via executing an IO pipeline 2835 (and/or multiple IO pipelines 2835, where each IO pipeline is configured for each respective segment 2424). All segments in a given same segment group (e.g. a set of segments collectively storing parity data and/or replicated parts enabling any given segment in the segment group to be rebuilt/accessed as a virtual segment during query execution via access to some or all other segments in the same segment group as described previously) are optionally guaranteed to be stored in a same storage cluster 2535, where segment rebuilds and/or virtual segment use in query execution can thus be facilitated via communication between nodes in a given storage cluster 2535 accordingly, for example, in response to a node failing and/or a segment becoming unavailable.

Each storage cluster 2535 can further mediate cluster state data 3105 in accordance with a consensus protocol mediated via the plurality of nodes 37 of the given storage cluster. Cluster state data 3105 can implement any embodiment of state data and/or system metadata described herein. In some embodiments, cluster state data 3105 can indicate data ownership information indicating ownership of each segments stored by the cluster by exactly one node (e.g. as a physical segment or a virtual segment) to ensure queries are executed correctly via processing rows in each segment (e.g. of a given dataset against which the query is executed) exactly once.

Consensus protocol 3100 can be implemented via the raft consensus protocol and/or any other consensus protocol. Consensus protocol 3100 can be implemented be based on distributing a state machine across a plurality of nodes, ensuring that each node in the cluster agrees upon the same series of state transitions and/or ensuring that each node operates in accordance with the currently agreed upon state transition. Consensus protocol 3100 can implement any embodiment of consensus protocol described herein.

Coordination across different storage clusters 2535 can be minimal and/or non-existent, for example, based on each storage cluster coordinating state data and/or corresponding query execution separately. For example, state data 3105 across different storage clusters is optionally unrelated.

Each storage cluster's nodes 37 can perform various database tasks (e.g. participate in query execution) based on accessing/utilizing the state data 3105 of its given storage cluster, for example, without knowledge of state data of other storage clusters. This can include nodes syncing state data 3105 and/or otherwise utilizing the most recent version of state data 3105, for example, based on receiving updates from a leader node in the cluster, triggering a sync process in response to determining to perform a corresponding task requiring most recent state data, accessing/updating a locally stored copy of the state data, and/or otherwise determining updated state data.

In some embodiments, updating of state data (such as configuration data, system metadata, data shared via a consensus protocol, and/or any other state data described herein), for example, utilized by nodes to perform respective functionality over time, can be performed in conjunction with an event driven model. In some embodiments, such updating of state data over time can be performed in a same or similar fashion as updating of configuration data as disclosed by: U.S. Utility application Ser. No. 18/321,212, entitled COMMUNICATING UPDATES TO SYSTEM METADATA VIA A DATABASE SYSTEM, filed May 22, 2023; and/or U.S. Utility application Ser. No. 18/310,262, entitled “GENERATING A SEGMENT REBUILD PLAN VIA A NODE OF A DATABASE”, filed May 1, 2023; which are hereby incorporated herein by reference in their entirety and made part of the present U.S. Utility Patent Application for all purposes.

In some embodiments, system metadata can be generated and/or updated over time with different corresponding metadata sequence numbers (MSNs). For example, such generation/updating of metadata over time can be implemented via any features and/or functionality of the generation of data ownership information over time with corresponding OSNs as disclosed by U.S. Utility application Ser. No. 16/778,194, entitled “SERVICING CONCURRENT QUERIES VIA VIRTUAL SEGMENT RECOVERY”, filed Jan. 31, 2020, and issued as U.S. Pat. No. 11,061,910 on Jul. 13, 2021, which is hereby incorporated herein by reference in its entirety and made part of the present U.S. Utility Patent Application for all purposes. In some embodiments, the system metadata management system 2702 and/or a corresponding metadata system protocol can be implemented via a consensus protocols mediated via a plurality of nodes, for example, to update system metadata 2710, in a via any features and/or functionality of the execution of consensus protocols mediated via a plurality of nodes as disclosed by this U.S. Utility application Ser. No. 16/778,194. In some embodiments, each version of system metadata 2710 can assign nodes to different tasks and/or functionality via any features and/or functionality of assigning nodes to different segments for access in query execution in different versions of data ownership information as disclosed by this U.S. Utility application Ser. No. 16/778,194. In some embodiments, system metadata indicates a current version of data ownership information, where nodes utilize system metadata and corresponding system configuration data to determine their own ownership of segments for use in query execution accordingly, and/or to execute queries utilizing correct sets of segments accordingly, based on processing the denoted data ownership information as U.S. Utility application Ser. No. 16/778,194.

FIGS. 24U and 24V illustrate embodiments of a database system 10 that utilizes a dictionary structure to store compressed columns. Some or all features and/or functionality of the dictionary structure 5016 of FIGS. 24U and/or 24V can implement any compression scheme data and/or means of generating and/or accessing compressed columns described herein. Any other features and/or functionality of database system 10 of FIG. 24U and/or 24V can implement any other embodiment of database system 10 described herein.

In some embodiments, columns are compressed as compressed columns 5005 based on a globally maintained dictionary (e.g. dictionary structure 5016), for example, in conjunction with applying Global Dictionary Compression (GDC). Applying Global Dictionary Compression can include replaces variable length column values with fixed length integers on disk (e.g. in database storage 2450), where the globally maintained dictionary is stored elsewhere, for example, via different (e.g. slower/less efficient) memory resources of a different type/in a different location from the database storage 2450 that stores the compressed columns 5005 accessed during query execution.

The dictionary structure can store a plurality of fixed-length, compressed values 5013 (e.g. integers) each mapped to a single uncompressed value 5012 (e.g. variable-length values, such as strings). The mapping of compressed values 5013 to uncompressed values 5012 can be in accordance with a one-to-one mapping. The mapping of compressed values 5013 to uncompressed values 5012 can be based on utilizing the fixed-length values 5013 as keys of a corresponding map and/or dictionary data structure, and/or can be based on utilizing the uncompressed values 5012 as keys of a corresponding map and/or dictionary data structure.

A given uncompressed value 5012 that is included in many rows of one or more tables can be replaced (i.e. “compressed”) via a same corresponding compressed value 5013 mapped to this uncompressed value 5012 as the compressed value 5008 for these rows in compressed column 5005 in database storage. As new rows are received for storage over time, their column values for one or more compressed columns 5005 can be replaced via corresponding compressed values 5008 based on accessing the dictionary structure and determining whether the uncompressed value 5012 of this column is stored in the dictionary structure 5016. If yes, the compressed value 5013 mapped to the uncompressed value 5012 in this existing entry is stored as compressed value 5008 in the compressed column 5005 in the database storage 2450. If no, the dictionary structure 5016 can be updated to include a new entry that includes the uncompressed value 5012 and a new compressed value 5013 (e.g. different from all existing compressed values in the structure) generated for this uncompressed value 5012, where this new compressed value 5013 is stored as is applied as compressed value 5008 in the database storage 2450.

The dictionary structure 5016 can be stored in dictionary storage resources 2514, which can be different types of resources from and/or can be stored in a different location from the database storage 2450 storing the compressed columns for query execution. In some embodiments, the dictionary storage resources 2514 storing dictionary structure 5016 can be considered a portion/type of memory as of database storage 2450 that are accessed during query execution as necessary for decompressing column values. In some embodiments, the dictionary storage resources 2514 storing dictionary structure 5016 can be implemented as metadata storage resources, for example, implemented by a metadata consensus state mediated via a metadata storage cluster of nodes maintaining system metadata such as GDCs of the database system 10.

The dictionary structure 5016 can correspond to a given column 5005, where different columns optionally have their own dictionary structure 5016 build and maintained. Alternatively, a common dictionary structure 5016 can optionally be maintained for multiple columns of a same table/same dataset, and/or for multiple columns across different tables/different datasets. For example, a given uncompressed value 5012 appearing in different columns 5005 of the same or different table is compressed via the same fixed-length value 5013 as dictated by the dictionary structure 5016.

This dictionary structure 5016 can be globally maintained (e.g. across some or all nodes, indicating fixed length values mapped across one or more segments stored in conjunction with storing one or more relational database tables) and can be updated overtime (e.g. as more data is added with new variable length values requiring mapping to fixed length values). For example, the dictionary structure 5016 is maintained/stored in state data that is mediated/accessible by some or all nodes 37 of the database system 10 via the dictionary structure 5016 being included in any embodiment of state data described herein.

In some embodiments, dictionary compression via dictionary structure 5016 can implement the compression scheme utilized to generate (e.g. compress/decompress the values of) compressed columns 5005 of FIG. 24U based on implementing some or all features and/or functionality of the compression of data during ingress via a dictionary as disclosed by U.S. Utility application Ser. No. 16/985,723, entitled “DELAYING SEGMENT GENERATION IN DATABASE SYSTEMS”, filed Aug. 5, 2020, which is hereby incorporated herein by reference in its entirety and made part of the present U.S. Utility Patent Application for all purposes.

In some embodiments, dictionary compression via dictionary structure 5016 can implement the compression scheme utilized to generate (e.g. compress/decompress the values of) compressed columns 5005 of FIG. 24U based on implementing some or all features and/or functionality of global dictionary compression as disclosed by U.S. Utility application Ser. No. 16/220,454, entitled “DATA SET COMPRESSION WITHIN A DATABASE SYSTEM”, filed Dec. 14, 2018, issued as U.S. Pat. No. 11,256,696 on Feb. 22, 2022, which is hereby incorporated herein by reference in its entirety and made part of the present U.S. Utility Patent Application for all purposes.

In some embodiments, dictionary compression via dictionary structure 5016 can be utilized in performing GDC join processes during query execution to enable recovery of uncompressed values during query execution, for example, based on implementing some or all features and/or functionality of GDC joins as disclosed by U.S. Utility application Ser. No. 18/226,525, entitled “SWITCHING MODES OF OPERATION OF A ROW DISPERSAL OPERATION DURING QUERY EXECUTION”, filed Jul. 26, 2023, which is hereby incorporated herein by reference in its entirety and made part of the present U.S. Utility Patent Application for all purposes.

FIG. 24U illustrates an embodiment of database system 10 where a compressed column filter conversion module 5010 accesses a dictionary structure 5016 to generate an updated filtering expression 5021 in conjunction with query execution.

The compressed column filter conversion module 5010 can generate updated filtering expression 5021 based on updating one or more literals 5011.1 from corresponding literals 5011.0 based on replacing uncompressed values 5012 with compressed values 5013 mapped to these compressed values based on accessing dictionary structure 5016 and determining which fixed-length compressed value 5013 is mapped to each given uncompressed value 5012. Such functionality can be implemented for one or more queries executed by database system 10 to reduce access to the dictionary structure during query execution in conjunction with performing one or more optimizations of the query operator execution flow to improve query performance.

FIG. 24V illustrates an embodiment of executing a join process 2530 that is implemented as a global dictionary compression (GDC) join. This can include applying a matching row determination module 2558 via access to a dictionary structure 5016.

In some embodiments, unlike hash maps generated during query execution for access in conjunction with executing other types of JOIN operations (e.g. as described in U.S. Utility application Ser. No. 18/226,525), the dictionary structure 5016 can optionally be accessed during GDC join processes based on being globally maintained, and thus being generated prior to execution of the corresponding query. In particular, the dictionary structure 5016 can be implemented in conjunction with compressing one or more columns, such as a variable length values stored in one or more variable length columns, by mapping these variable length, uncompressed values (e.g. strings, other large values of a given column) to corresponding fixed-length, compressed values 5013 (e.g. integers or other fixed length values).

For example, segments can store the fixed length values to improve storage efficiency and/or queries can access and process these fixed length values, where the uncompressed variable length values are only required via access to dictionary structure 5016 to emit an uncompressed value 5012 for a given fixed-length value 5013 of a given input row. This functionality can be achieved via performing a corresponding join as described herein, where the matching condition 2519 is implemented for a compressed column and indicates matching by the value of the compressed column, such as simply emitting the uncompressed value mapped to the compressed column as the right output value 2563 for a given input row, implemented as a left input row 2542 of a join operation.

FIG. 24W illustrates an embodiment of database system 10 operable to communicate with a plurality of user entities. Some or all features and/or functionality of FIG. 24W can implement any embodiment of database system 10 described herein.

Various users can send data to and/or receive data from database system 10 over time, for example, as corresponding requests and/or responses. Requests can indicate requests for queries to be executed, requests that include data to be loaded/stored, requests that include configuration data configuring any values/functionality utilized by database system 10 to perform its functionality, data supplied in response to a request from database system 10, and/or other requests to database system 10 for processing by database system 10. Responses can indicate query resultants of executed queries, notifications/confirmation that requests were processed successfully or rendered failure, error notifications, data supplied in response to a request from user entity 2012, and/or other information.

Some or all user entities 2012 can be implemented as user entities corresponding to humans that communicate with database system 10 (e.g. requests are configured via user input to a corresponding computing device of database system 10 or communicating with database system 10); user entities corresponding to groups of multiple people, for example, corresponding to companies/establishments that communicate with database system 10; user entities corresponding to automated entities such as one or more computing devices and/or server systems (e.g. implemented via artificial intelligence, machine learning, and/or configured instructions to cause these automated entities to send requests and/or process responses; and/or corresponding to a given person and configured to send/receive data based on user input from a corresponding person); and/or other user entities. Some or all user entities 2012 can be implemented as humans and/or devices included in/associated with database system 10 (e.g. personnel/employees of a service provided by database system 10; computing devices implementing nodes/processing modules of database system 10 that communicate via internal communication resources of database system 10, etc.). Some or all user entities 2012 can be implemented as humans and/or devices external from database system 10 (e.g. humans/companies that are customers of a service provided by database system 10; computing devices external from the computing devices/nodes/processing resources of database system 10 that communicate with database system 10 via a corresponding communication interface, etc.)

User entities 2012 can include various type of user entities 2012, which can include one or more user entities 2012.A, one or more user entities 2012.B, and/or one or more user entities 2012.C. A given user entity can optionally implement multiple types of user entities 2012 (e.g. a given user entity 2012 operates as both a user entity 2012.A and a user entity 2012.B). Multiple different users (e.g. different people, different devices) can implement a given user entity 2012 (e.g. different employees of a given company implement a given user entity 2012 at different times; different devices associated with a given person or company implement a given user entity 2012 at different times, etc.).

In some embodiments, some or all user entities 2012 can configure/perform functionality corresponding to workload management (WLM).

User entities 2012 can include one or more user entities 2012.A.1-2012.A.M corresponding to query requestor user entities 2005.1-2005.M. Query requestor user entities 2005 can send query requests 2914 indicating queries for execution and/or receive query resultants in response 2920. User entities 2012 can optionally be implemented in a same or similar fashion as external requesting entity 2912.

User entities 2012 can include one or more user entities 2012.B.1-2012.B.S corresponding to database administrator user entities 2006 that request/configure/monitor loading/storage of/access to a corresponding database 1901 that stores a corresponding plurality of database tables 2712.1-2712-T (e.g. database administrator user entities 2006 optionally correspond to data sources that load their data to the system for use in query execution, where this data source sources data included in tables 2712 of a corresponding database 1901).

For example, in some embodiments, database system 10 can implement database storage 2450 to store various tables 2712 corresponding to multiple different databases 1902.1-1901.S, for example, each sourced by, accessible by, and/or configured via corresponding user entities 2012.B. Different databases 1901 can store same or different types of data, same or different numbers of tables 2712, etc. Some or all user entities 2012.A can correspond to a given database 1901 (e.g. based on being associated with the corresponding data source and/or user entities 2012.B) for example, where these user entities are only allowed to query against the given database 1901.

User entities 2012 can include one or more user entities 2012.C corresponding to system administrators of the database system 10 that request/configure/monitor loading/storage of/access to databases in query execution and/or otherwise configure/monitor functionality of database system 10 described herein.

Different user entities can have different corresponding permissions/privileges/access types, for example, indicated in corresponding user permissions data stored by and/or accessible by database system 10. In some embodiments, one or more given user entities can configure permissions of other user entities. Such permissions can configure types of requests that can be sent, restrictions on data included in responses, and/or which data can be accessed (e.g. in loading data and/or requesting data). For example, some user entities 2012.A can be restricted to certain types of queries/query functions be performed, access to only some databases 1902 and/or only some tables 2712, limits on how many queries be executed/how much data be returned, certain levels of query priority, certain service classes of query execution defining corresponding attributes of how queries be executed/how query execution be restricted, etc. As another example, some user entities 2012.B can be restricted to certain types/rates of data loading to a corresponding database 1901, certain permissions regarding how much configuration of database system 10 they can have power over, etc. As another example, different user entities 2012.C can have different permissions regarding how much configuration of database system 10 they can have power over, different functionalities/aspects of database system that they have permissions to configure, etc.

FIG. 24X illustrates an embodiment of a record processing and storage system 2505 that performs a loading process 2605 to process a plurality of files that each include a plurality of records for storage based on generating a plurality of work units in accordance with a work unit target size, and generating a plurality of loading batch sets for assignment to a set of loading modules for processing over time, for example, based on adapting a target number of work units per batch based on updates to estimated work unit processing time during processing. Some or all features and/or functionality of the record processing and storage system 2505, loading process 2605, and/or loading modules 2510 of FIGS. 24X can implement any embodiment of record processing and storage system 2505, loading process 2605, and/or loading modules 2510 described herein. Some or all features and/or functionality of processing and storing records included in files of FIG. 24X can implement any receipt, processing, transformation, loading, and/or storage of data described herein. Some or all features and/or functionality of FIG. 24X can implement any embodiment of database system 10 described herein.

In various embodiments of database system 10, when a file load is performed using multiple loaders (e.g. multiple loading modules 2510), it can be ideal to implement a means of splitting the files into batches such that each loader is engaged for the majority of the load. If some N number of files is assigned to each batch (e.g. with each batch being loaded by one task, and all the tasks being created up front), it can be possible to run into a scenario where all the larger files will be assigned to one batch, and that one batch will be oversized, leading to one loader having to perform 90% of the load while the other loaders are idle for most of that time. This can lead to the appearance of a “tail” in the load, where one loader is left processing a long tail of files.

Use of distributed tasks to orchestrate the load can help ameliorates this situation: tasks aren't assigned to loaders up front, so if there are enough tasks, then faster loaders will naturally execute more tasks, reducing the length of the tail. However, if the load consists of less than (number of loaders)*N number of files, and/or if the load is split into less tasks than loaders, then the problem can still persist.

FIG. 24X presents a solution to this problem that improves the technology of database systems based on rendering more efficient loading of data via a plurality of loaders. This can include dispersing the files into batches based on their file sizes, dynamically size these batches to adapt to the current conditions (e.g. of the cluster, network, and other aspects of the load environment), and/or not creating all the tasks up front.

As illustrated in FIG. 24X, the record processing and storage system 2505 can be operable to process a given file set 2910 (e.g. a bulk set of files determined up front, which can be optionally implemented a portion of or the entirety of one or more source datasets 2601, where the records in each file are optionally implemented as source records 2623) that includes a plurality of files 2821 that each include a plurality of records. A work unit generator module 2915 can generate a work unit set 2911 that includes a plurality of work units 2922 generated from the plurality of files, where each work unit 2922 includes a set of one or more files 2821 based on a work unit target size 2916 (e.g. target number of bytes/target number of records), where work units 2922 are built to meet/be as close to the work unit target size 2916 as possible. This can include different work units having different numbers of files 2821 based on different files 2821 being different sizes (e.g. one work unit has a few large files, another work unit has many small files, both work units have close to the same number of bytes close to the work unit target size 2916). Generating work units 2922 can be based on keeping files whole (e.g. a given file is placed in exactly one work unit).

As a particular example, after listing files at the start of a load as file set 2910, the files can be distributed up front into work units with a work unit target size 2916 of S bytes, for example, where S=(least common multiple of the numbers of cores for the loaders used)*(average size of files in this load), for example, where number of cores corresponds to processing core resources 48 of nodes 37 implementing the loading modules 2510.1-2510.N. Each work unit should contain at least one file. Since the work units should be approximately evenly sized, they can be utilized as the unit by which batches are measured.

The loading process 2605 can be implemented after the work unit set 2911 is created up front by implementing a next loading batch set initiation module 2925 that implements a loading batch set selection and assignment module 2936 to assign a given set of loading batches 2932.1-2932.N of a given loading batch set 2930.

For example, a given loading batch set 2930 includes only N loading batches 2932 (e.g. assigned via N corresponding tasks, such as N subtasks 3037.1-3037.N), where each of the N loading modules 2510 is thus assigned one of these batches 2932. A first loading batch 2930.1 can includes a first set of loading batches set of loading batches 2932.1.1-2932.1.N assigned to the N loading modules 2510.1-2510.N. Each of these N initial batches can be configured to include a same number of work units, such as exactly one work unit for the for the first loading batch processed by each loading module consists of one work unit (e.g. each task should process about S bytes worth of files).

The next loading batch set initiation module 2925 can determine when the first batch in a given (e.g. current) batch set 2930.i has completed processing by a corresponding loading module 2510 (e.g. a corresponding task is completed by the corresponding loading module), where the next loading batch set 2930.i+1 ofN batches to be assigned across the N loading modules is determined only once a first loading batch 2932.j.i in the given set 2930.i has completed processing.

A number of work units per batch selection module 2939 can be implemented to configure a target number of work units per batch 2934 for the next batch set 2930.i+1 enabling batches 2932 to have sizes that change dynamically over time. For example, an estimated work unit processing time 2933.i+1 for a current/upcoming time frame can be estimated based on current conditions, how long the most recent batch set took to process, changes to the network/memory/processing/storage/nodes of the system, etc. The target number of work units per batch 2934.i+1 to be applied in generating the next loading batch set 2930.i+1 can be generated as a function of configured work unit processing time 2933.i+1 (e.g. as an inverse function of estimated work unit processing time 2933.i+1. For example, all N loading batches 2932.i+1.1-2932.i+1.N can have a number of work units 2922 equal to and/or close to the target number of work units per batch 2934.i+1 selected based on the estimated work unit processing time 2933.i+1. As the estimated work unit processing time 2933 changes over time, the target number of work units per batch 2934 (and thus actual number of work units per batch) can change accordingly to adapt loading batch sizes to changing of conditions during the loading process 2605. As a particular example, the number of work units per batch selection module 2939 can generate the target number of work units per batch 2934.i+1 such that a target batch processing time 2938 is expected to be met, based on the estimated work unit processing time (e.g. include a number of work units in the batch such that processing time of the new batches is expect to get as close to target batch processing time 2938 as possible).

This process of generating loading batch sets 2930 to all have a number of work units configured based on the target number of work units per batch 2934 selected for the given loading batch set 2930 can continue until all work units of work unit set 2911 are assigned in loading batches.

As a particular example, once the first of the N tasks completes for a given loading batch set 2930.i, the next loading batch set initiation module 2925 can be implemented to:

First, recalculate the number of work units W (e.g. target number of work units per batch 2934) that should be in a batch as target number of work units per batch 2934.i+1, for example, such that each task has a predicted execution time of T, where T is some configurable value (e.g. target batch processing time 2938), for example, that defaults to 10 minutes or some other default. This can be based on applying the assumption that W is proportional to task execution time. This first step can be performed via implementing the number of work units per batch selection module 2939.

Second, create another set of N tasks (e.g. n loading batches 2932.1-2932.N). Each of these tasks should load a batch that consists of W work units (e.g. target number of work units per batch 2934). For example, each loading batch 2932/corresponding task should process about S*W bytes worth of files. This second step can be performed via implementing loading batch set selection and assignment module 2936.

Third, once the first of these new tasks completes, repeat the first and second step for this new set of N tasks. For example, the recalculation of W and task creation is only performed once per set of tasks (e.g. once per loading batch set 2930).

These first, second, and third steps can be repeated until there are no work units left. This implementation can limit the length of the tail to be about T (e.g. target batch processing time 2938).

In some embodiments, the loading process 2605 of FIG. 24X and/or any embodiment of loading process 2605 and/or loading of data into database system 10 described herein implements some or all features and/or functionality of the loading process 2605 disclosed by: U.S. Utility application Ser. No. 18/642,043, entitled “PERFORMING LOAD ERROR TRACKING DURING LOADING OF DATA FOR STORAGE VIA A DATABASE SYSTEM”, filed Apr. 22, 2024, which is hereby incorporated herein by reference in its entirety and made part of the present U.S. Utility Patent Application for all purposes. For example, any embodiment of loading process 2605 and/or loading of data into database system 10 can be implemented via a set of one or more loading modules 2510 and/or can be implemented via a record processing and storage system 2405, for example, via implementing any features and/or functionality of loading modules 2510 and/or can be implemented via a record processing and storage system 2405 disclosed by U.S. Utility application Ser. No. 18/642,043.

In some embodiments, the loading process 2605 of FIG. 24X and/or any embodiment of loading process 2605 and/or loading of data into database system 10 described herein implements some or all features and/or functionality of the loading modules 2510 and/or record processing and storage system 2405 disclosed by: U.S. Utility application Ser. No. 18/632,629, entitled “DATABASE SYSTEM PERFORMANCE OF A STORAGE REBALANCING PROCESS”, filed Apr. 11, 2024, which is hereby incorporated herein by reference in its entirety and made part of the present U.S. Utility Patent Application for all purposes. For example, any embodiment of loading process 2605 and/or loading of data into database system 10 can be implemented via a set of one or more loading modules 2510 and/or can be implemented via a record processing and storage system 2405, for example, via implementing any features and/or functionality of loading modules 2510 and/or can be implemented via a record processing and storage system 2405 disclosed by U.S. Utility application Ser. No. 18/632,629.

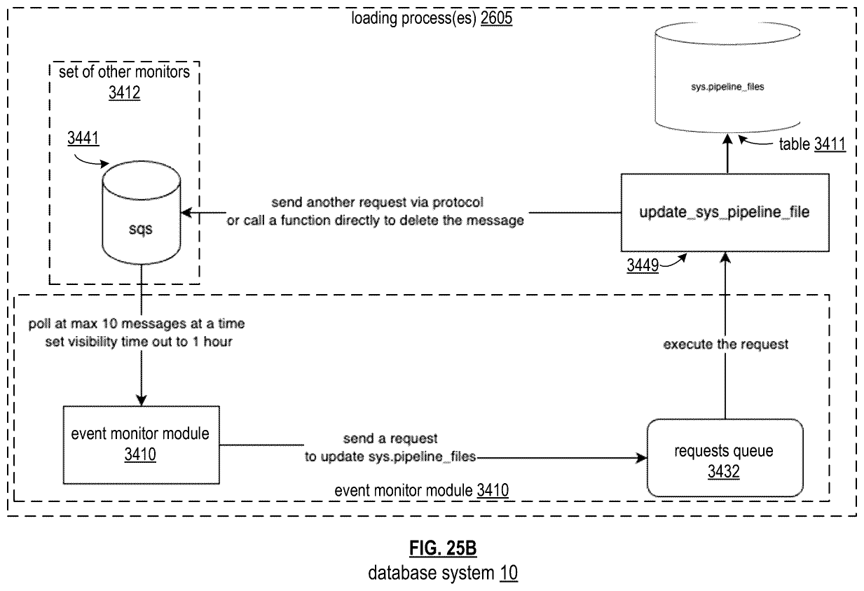

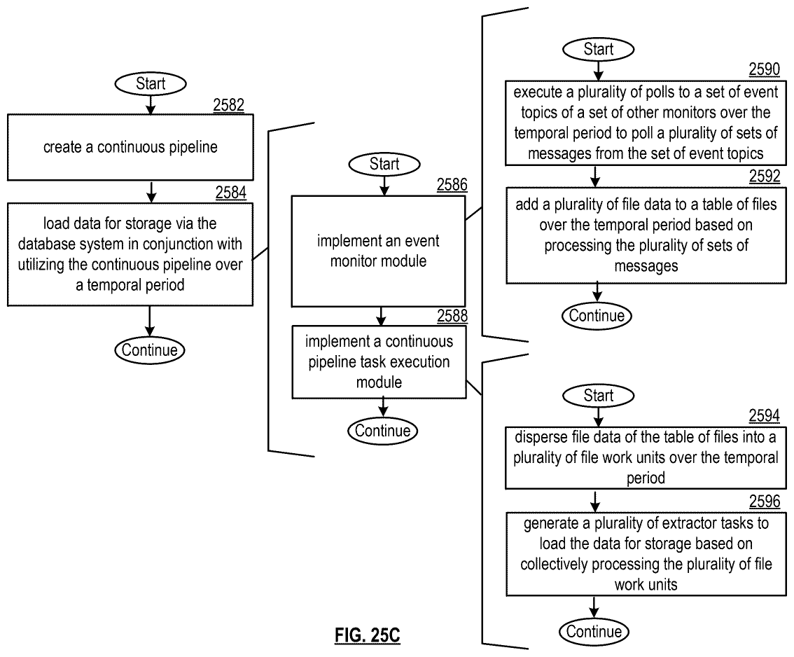

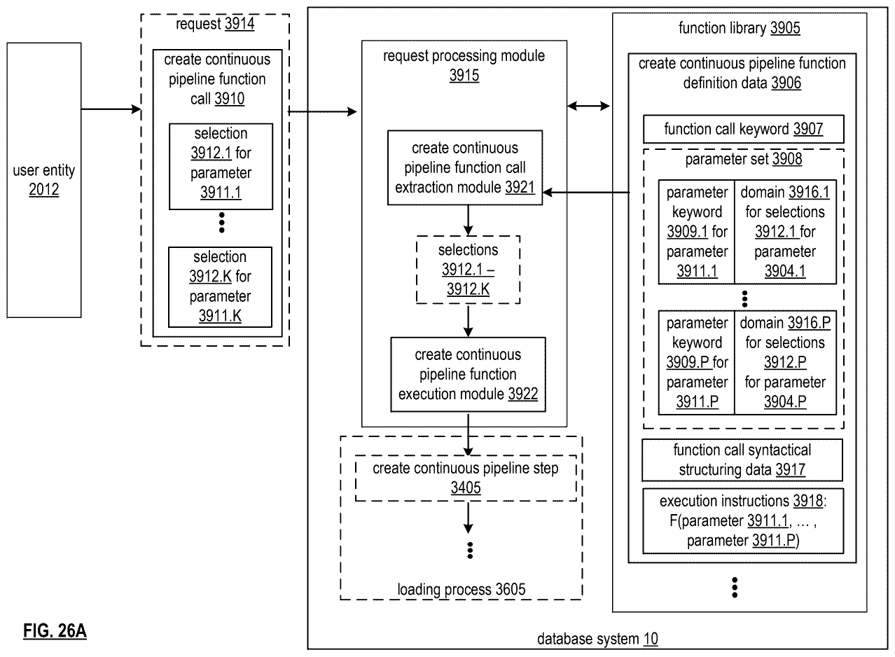

FIGS. 25A-27E present embodiments of a database system 10 that implements a continuous pipeline in conjunction with loading data for storage via one or more loading processes 2605. The embodiments illustrated in 25A-27E can be utilized to implement one or more nodes 37 of one or more computing devices 18 implementing database system 10. Some or all features and/or functionality of FIGS. 25A-27E can be utilized to implement any embodiment of database system 10 described herein.

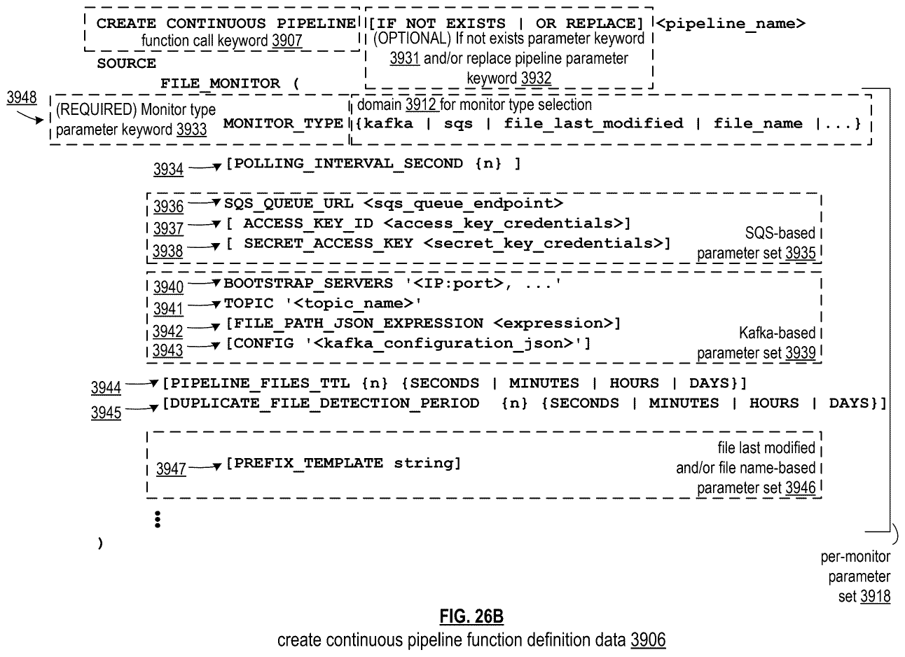

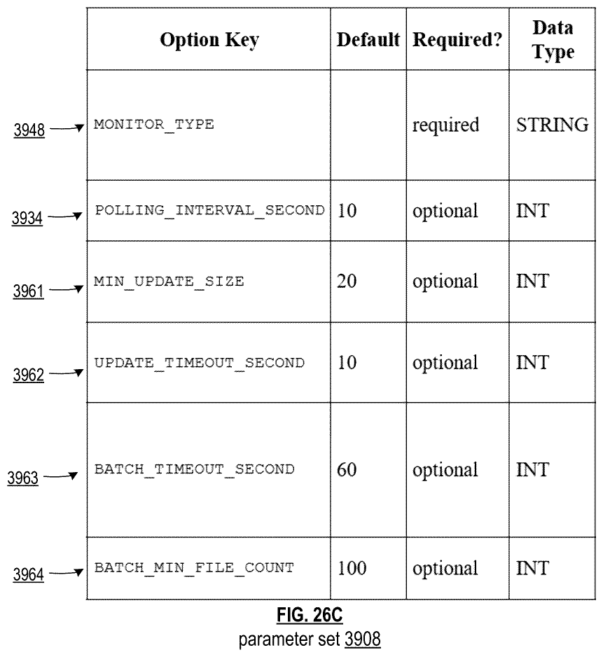

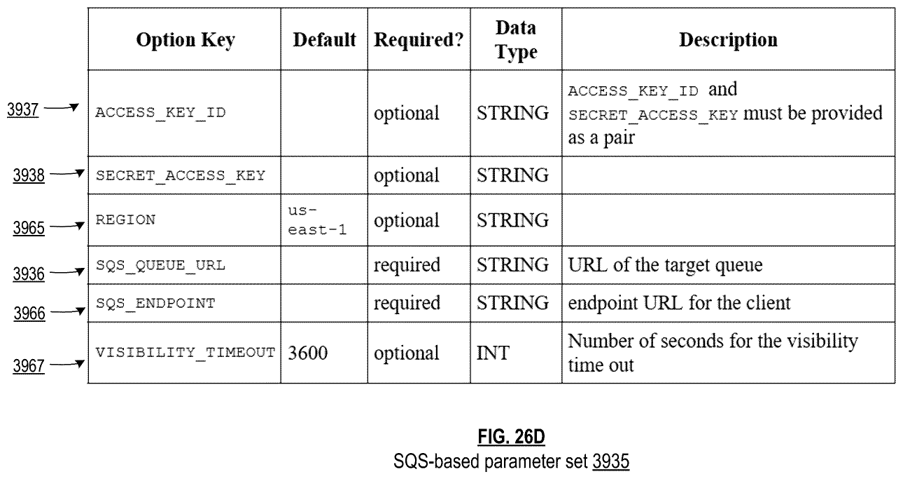

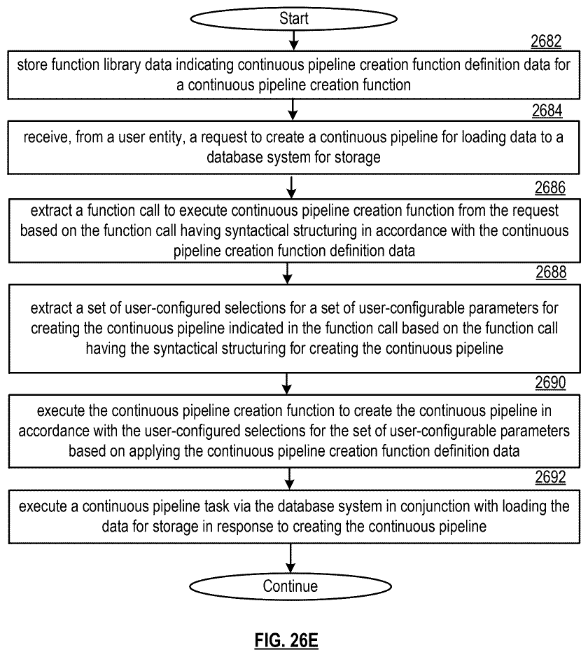

In some embodiments, the continuous pipeline is implemented via database system 10 in conjunction with implementing data definition language (DDL) event-driven continuous loading. In some embodiments, such DDL event-driven continuous loading is implemented to enable easy set up and installation (e.g. without external script), for example via corresponding custom DDL syntax (e.g. as discussed in conjunction with FIGS. 26A-26D) and/or without necessitating deploying packages. In some embodiments, such DDL event-driven continuous loading is implemented to improve the technology of database systems based on being generic enough to support several use cases and/or to list files (e.g. loading targets) efficiently, while supporting error handling, observability, throttling, resume commands, etc.

In some embodiments, the continuous pipeline is implemented via database system 10 in conjunction with performing continuous loading. In some embodiments, the continuous pipeline is implemented via database system 10 in conjunction with performing batch loading, and/or is implemented alongside one or more batch pipelines operable to perform batch loading. Batch loading and/or continuous loading can be performed via implementing some or all features and/or functionality of batch loading and/or continuous loading disclosed by U.S. Utility application Ser. No. 18/642,043 and/or U.S. Utility application Ser. No. 18/632,629.

FIG. 25A presents an embodiment of implementing a loading process 2605, for example, implemented by database system 10 in conjunction with implementing DDL event-driven continuous loading. Some or all features and/or functionality of loading process 2605 can implement any loading of data to database system 10 described herein. For example, performing loading process 2605 causes data (e.g. row data included in files in batches or continuous data streams) received from one or more data sources 2501 to be stored (e.g. durably) in database system 10, for example, as records 2422 stored in database storage 2450 (e.g. in pages 2515 and/or ultimately in segments 2424).

In some embodiments, a create continuous pipeline step 3405 is performed to create a continuous pipeline (e.g. via execution of a corresponding DDL command to create the continuous pipeline, for example, based on the command being received from a computing device based on being generated/configured via user input by a user entity), for example, maintained/established in state data 3105 and/or in conjunction with implementing a consensus protocol 3406, such as a raft consensus protocol mediated via a plurality of nodes 37.

In some embodiments, a start continuous pipeline step 3407 is performed to start a continuous pipeline that has been created via the create continuous pipeline step 3405 (e.g. via execution of a corresponding DDL command to start the continuous pipeline, for example, based on the command being received from a computing device based on being generated/configured via user input by a user entity, such as a same user entity that created the continuous pipeline).

In some embodiments, a run pipeline task 3408 (e.g. implemented as a runPipelineTask and/or a DEL runner ) is performed based on staring the continuous pipeline via the start continuous pipeline step 3407. Performing the run pipeline task 3408 can include initiating at least one event monitor module 3410, for example, via executing a start monitor function (e.g. “start monitoro”). Performing the run pipeline task 3408 can include initiating at least one continuous pipeline task execution module 3415, for example, via executing a create continuous pipeline task function (e.g. “create_continous_pipeline tasko”). In some embodiments, after the continuous pipeline is started (e.g. by a user entity) it runs continuously until the process is killed or encounters fatal errors. In some embodiments, runPipelineTask can be refactored into BATCH and CONTINUOUS types.

One or more event monitor modules 3410 can be implemented, for example, based on the run pipeline task 3408 executing the start monitor function. Event monitor module 3410 can be implemented as and/or in conjunction with implementing an abstract event monitor (e.g. “abstract event monitor”), for example, implemented as an abstract class representing means of acquiring new loading targets. A given event monitor module 3410 can be implemented to poll targets from event topics and store them in metadata. Event monitor module 3410 can be implemented as, and/or in conjunction with implementing, a corresponding loading queue of event topics (e.g. implemented via C++).

Event monitor module 3410 can be implemented based on performing polling, for example, via execution of a polling function (e.g. “poll( )”) of one or more other monitors in a set of other monitors 3412, where this polling can be performed to retrieve one or more file data (e.g. a corresponding one or more files, such as one or more files 2821, or underlying data, such as raw data, of the one or more files, such raw data that includes the records 2623 included in one or more files 2821) of a given monitor in the set of other monitors 3412 (e.g. in conjunction with interfacing with the given monitor in conjunction with a corresponding protocol for the given monitor that may be different from protocols for interfacing with some or all other monitors of the set of other monitors 3412), for example, where each file data is implemented as a corresponding loading topics or other event topic of the given other monitor. For example, each other monitor in the set of other monitors 3412 contains corresponding file data to be loaded as loading targets included in corresponding event topics, where this file data was optionally received from and/or generated by one or more data sources 2501, for example, as a stream of multiple file data received over time and/or as a batch of multiple file data received all at once. For example, each file data corresponds to a single file which can include a corresponding set of row data, such as data corresponding to one record 2422 or many records 2422.

In some embodiments, notifications upon configured events can be implemented (e.g. by event monitoring module 3410) via implementing at least one third-party event notification monitor, for example, based on utilized corresponding libraries to acquire these events and/or extract them into file lists. The set of other monitors 3412 can include such third-party event notification monitor, such as one or more SQS monitors 3441 and/or one or more Kafka monitors 3442.

The set of other monitors 3412 can include at least one SQS monitor 3441, for example, implemented as an Amazon S3 SQS Monitor (e.g. “S3SQSMonitor”). For example, SQS monitor 3441 is implemented based on implementing a corresponding visibility timeout (e.g. visibility duration) for visibility of its targets and/or based on corresponding connection configuration. Event monitor module can be configured to delete messages (e.g. via a delete message function such as “delete_messageo”) once they have been added to the table 3411, where these messages are deleted by SQS monitor if this deletion is requested within the visibility timeout of being polled by event monitor module 3410.

In some embodiments, the SQS monitor 3441 is implemented based on supporting FIFO and Standard queues. Standard queue can ensure at-least-once message delivery, where more than one copy of a message might be delivered. In some embodiments, FIFO queue is used based on enabling content-based deduplication.

This set of other monitors 3412 can alternatively or additionally include at least one Kafka Monitor 3442, such as an Apache Kafka monitor (e.g. “KafkaMonitor”). For example, targets are polled and/or loaded in accordance with an extraction format, and/or the Kafka monitor 3442 is implemented in accordance with a corresponding connection configuration. Event monitor module can be configured to extract information from Kafka messages in accordance with the extraction format (e.g. via an extract information function, such as “extract_information(kafka message)” applied to a given message “kafka message”).

In some embodiments, some object storages support event notification via Kafka, such as Minio. The user can configure Minio to send a message to the desired Kafka topic when an object is created. When using this type of external notifier, the user can specify the extraction format (e.g. via COMMON JSON), for example, based on implementing some or all of the following logic:

```
FILE_MONITOR (
  MONITOR_TYPE kafka,
  BOOTSTRAP_SERVERS ‘<IP:port>, ...’,
  TOPIC ‘<topic_name>’,
  $a.b.c as file name,
  $a.b.d as file m_time,
  $a.b.e[1] as size
)
```

In some embodiments, Kafka is utilized separately regardless of whether the object storage supports it. In some embodiments, event monitor module 3410 consumes messages from them and commit right after we store the file information in our table, for example, based on being stateful.

In some embodiments, a custom notification mechanism can be implemented for some data sources not utilizing third-party monitors such as SQS monitors or Kafka monitors, which can be implemented via at least one file last modified monitor 3443 and/or at least one file name monitor accordingly, implemented as custom monitors.

This set of other monitors 3412 can alternatively or additionally include at least one file last modified monitor 3443 (e.g. “FileMtimeMonitor”), for example, implementing event topics and/or monitoring based on modified timestamps (e.g. mtimes) of corresponding files and/or other data indicating when corresponding file data was last modified. For example, the file last modified monitor 3443 is configured via a corresponding path and/or corresponding metadata.

In some embodiments, mtime-based listing is implemented via file last modified monitor 3443 based on file last modified monitor 3443 listing the source data bucket and/or filtering out files whose last modification date is not within the range. Other metadata filtering can also be applied. In the following example logic, the file last modified monitor 3443 is configured to only accept files under bfio-tracking/2024-03-04/22/whose last modification date is between 2024-03-05 02:46:31˜02:50:31:

prefix:[
“bfio-tracking/2024-03-04/22/”,
],
“file_matcher_syntax”: “glob”,
“file_matcher_pattern”: “**.gz”,
“sort_type”: “metadata”,
“start_time”: “2024-03-05T02:46:31”,
“stop_time”: “2024-03-05T02:50:31”

While not illustrated, this set of other monitors 3412 can alternatively or additionally include at least one file name monitor, for example, implementing event topics and/or monitoring based on file name. File name monitor can be implemented based on a data source (e.g. corresponding user) following a certain naming pattern when uploading the files, where the file name monitor is implemented as a customized monitor to sort the file names.

The event monitor module 3410 can be further implemented to monitor a watermark, such as a high watermark and/or one or more additional watermarks, for example, via execution of a monitor watermark function (e.g. monitor watermarko). The high watermark can correspond to a total number of targets (e.g. file data) in an event queue maintained by the event monitor module 3410, and/or can be implemented based on enforcing a predetermined threshold maximum number of targets in the event queue. Some or all features and/or functionality of any embodiment of a high watermark or other watermark described herein can be implemented based on implementing some or all features and/or functionality of threshold maximum number of pages 2711 disclosed by U.S. Utility application Ser. No. 18/632,629 and/or any embodiment of a watermark disclosed by U.S. Utility application Ser. No. 18/632,629.

The event monitor module 3410 can be further implemented to update a loading list, such as a list of file data implemented via a table of files 3411 (e.g. “sys.pipeline files”) stored in metadata (e.g. as a persistent system table), for example, based on executing an updating loading list function (e.g. “update loading_listo”). For example, event monitor module 3410 is implemented to periodically update the table 3411 with unique files (e.g. corresponding file data), for example, based on having been polled from respective other monitors of the set of other monitors 3412.

In some embodiments, the event monitor module 3410 has the same lifespan as the pipeline. It can periodically check the configured event/location. After enough files have been accumulated (e.g. into a corresponding queue) or the patience runs out, the monitor can update the pending file list. New extractor tasks will consume unloaded messages from the list.

One or more continuous pipeline task execution modules 3415 can be implemented, for example, based on the run pipeline task 3408 executing the create continuous pipeline task function. A given continuous pipeline task execution modules 3415 can execute a corresponding continuous pipeline task, for example, that does not stop until either a user command is received indicating the continuous pipeline task be paused and/or completed, or a fatal error is encountered.

The continuous pipeline task execution module 3415 can be implemented to generate one or more extractor tasks 3409, which can be implemented to extract records 2422 for storage and/or to store these records 2422 in corresponding pages 2515 and/or segments 2424. For example, a given extractor task 3409 is performed by a given loading module 2510 and/or is executed via a group of loading modules 2510 via a leader loading module 2510 initiating the extractor task 3409 for execution via this group of loading modules 3409.

The continuous pipeline task execution modules 3415 can be implemented to construct file work units, for example, for processing in conjunction with the extractor tasks 3409. For example, the continuous pipeline task execution modules 3415 implements work unit generator module 2915, where extractor tasks 3409 are performed via loading modules processing respective loading batches, for example, based on implementing some or all features and/or functionality of loading process 2605 of FIG. 24X.

In some embodiments, the continuous pipeline task execution module 3415 and/or event monitoring module 3410 can be run as a single thread, which can render implementing a single consumer.

In some embodiments the database system 10 is configured to implement DDL event-driven continuous loading via one or more loading processes 2605 based on being configured to monitor manifest files, for example, based on storing a loading list when new files are uploaded, where the monitor scan the target directory and/or picks the oldest loading list (e.g. based on multiple loading lists being allowed to exist, for example to avoid race conditions). For example, after loading is done, the loaded list will be deleted/removed.

In some embodiments the database system 10 is configured to implement DDL event-driven continuous loading via one or more loading processes 2605 based on being configured to host an endpoint for the external source, where the file event is posted to notify the monitor when there are new files, and/or where this this event is processed, the file is persisted, and/or a notification (e.g. 200) is returned if it succeeds.

In some embodiments, table 3411 is implemented based on being queued files handled in consensus (e.g. as state data mediated via the consensus protocol) and/or historical log off disk-backed tables.

In some embodiments, table 3411 is implemented is used to indicate the files' statuses. When a new pipeline gets started, it can look for new files from sys.pipeline files. Monitors can update this table whenever there are new unique files ready. In some embodiments, SQS monitor 3441 supports 1˜10 messages for each consumption, where each message should be deleted from the queue after processing within a time frame (e.g. visibility timeout), which means the file list is updated frequently.

In some embodiments the database system 10 is configured to implement DDL event-driven continuous loading via one or more loading processes 2605 based on being configured to implement throttles to prevent disk spills. In some embodiments, individual pipeline sizes are throttled.

In some embodiments, error handling is handled based on, when transient errors and/or and node down errors occur: (1) the existing pipeline is deleted; (2) the raw tables for raw table setup are dropped and recreated; (3) any available loaders are attempted to be reused, and/or the pipeline is reconstructed (e.g. with the same ID for no raw table setup to utilize the deduplication feature) and restarted. In some embodiments, error handling is handled based on, when persistent errors and/or fatal errors occur: updating and/or persisting the checkpoint for resume, and/or exiting.

In some embodiments, the continuous pipeline can be resumed from a checkpoint based on information being persisted. When the user entity elects to resume a continuous pipeline, they can send a corresponding request (e.g. start pipeline x) and database system 10 resumes from where it left off. This can be based on persisting the monitor task to render the same consumer. This can be based on implementing a state object for custom monitors such as last file modified monitor 3443 and/or file name monitor to indicate what is the last listed mtime.

Monitors can be configured and/or state data maintained as a checkpoint can be implemented based on implementing some or all of the following logic;

```
message s3EventMonitorConfig {
    str end_point = 1;
    str access_key_id = 2;
    str secret_access_key = 3;
    str arn = 4;
    uint32 visibility_timeout_extension = 5;
}
message kafkaEventMonitorConfig {
    str bootstrap_servers = 1;
    str group_id = 2;
    str enable_auto_commit = 3;
    str auto_offset_reset = 4;
    uint32 heartbeat_interval_ms = 5;
    uint32 session_timeout_ms = 6;
    uint32 max_poll_interval_ms = 7;
    repeated str topic = 8;
}
message metadataEventMoitorConfig {
    enum metadataMonitor {
      MTIME = 1;
      FILENAME = 2;
    }
    str path = 1;
    metadataMonitor metadata = 2;
}
message EDLMonitorConfig {
    enum monitorType {
      SQS = 1;
      SNS = 2;
      Kafka = 3;
      FILE_META_MTIME = 4;
  }
    monitorType monitor_type = 1;
    float polling_interval = 2;
    oneof config {
      s3EventMonitorConfig s3_config = 3;
      kafkaEventMonitorConfig kafka_config = 4;
      metadataEventMonitorConfig metadata_config = 5;
    }
}
message EDLConfig {
    uint32 max_files_per_pipeline = 1;
    retryConfig retry_config = 2;
    uint32 pipelinefile_ttl = 3;
    uint32 duplicate_file_detection_hour = 4;
}
message EDLMonitorState {uint32 file_count = 2;
  uint64 file_total_size = 3;
  uint64 last_loaded_offset = 4;
  uint63 high_watermark = 5;
}
message monitorState {
      uint32 sequnenceNumber = 1;
      str last_listed_mtime = 2;
      uint32 time_window_second = 3;
}
```

In some embodiments, the database system 10 is configured to implement DDL event-driven continuous loading via one or more loading processes 2605 based on being configured to accept and process corresponding syntax in corresponding custom syntax (e.g. as discussed in conjunction with FIGS. 26A-26D).

In some embodiments, the database system 10 is configured to implement DDL event-driven continuous loading via one or more loading processes 2605 based on being configured to consume corresponding events from SQS monitor 3441 (e.g. consumed events are added to table 3411) and/or enable user configuration for implementing SQS monitor 3441 as one of the set of other monitors 3412 for loading files (e.g. as loading targets in one or more event topics).

In some embodiments, the database system 10 is configured to implement DDL event-driven continuous loading via one or more loading processes 2605 based on being configured to consume events from Kafka monitor 3442 (e.g. consumed events are added to table 3411) and/or enable user configuration for implementing Kafka monitor 3442 as one of the set of other monitors 3412 for loading files (e.g. as loading targets in one or more event topics).

In some embodiments, the database system 10 is configured to implement DDL event-driven continuous loading via one or more loading processes 2605 based on being configured to implement and consume events from one or more file mtime monitors (e.g. as file last modified monitors 3443), for example, as custom monitors where the corresponding event is defined, for example, in conjunction with implementing a loading queue.

In some embodiments, the database system 10 is configured to implement DDL event-driven continuous loading via one or more loading processes 2605 based on being configured to implement and consume events from one or more additional custom monitors implementing prefix filtering monitors (e.g. as file name monitors), for example, as custom monitors.

In some embodiments, the database system 10 is configured to implement DDL event-driven continuous loading via one or more loading processes 2605 based on being configured to allow user configured alterations to monitor configurations (e.g. a Kafka consumer group ID is altered via user input, etc.).

In some embodiments, the database system 10 is configured to implement DDL event-driven continuous loading via one or more loading processes 2605 based on being configured to create a parent task (e.g. a corresponding continuous pipeline task executed continually via continuous pipeline task execution module 3415) that will periodically spawn new child tasks (e.g. extractor tasks 3409) to load files.

In some embodiments, the database system 10 is configured to implement DDL event-driven continuous loading via one or more loading processes 2605 based on being configured to resume. For example, the corresponding continuous pipeline task executed continually via continuous pipeline task execution module 3415 and/or monitoring via event monitoring module 3410 resumes (e.g. after paused/stopped via a user command or due to a failure) based on being restarted, for example, via the start continuous pipeline step 3407.

In some embodiments, the database system 10 is configured to implement DDL event-driven continuous loading via one or more loading processes 2605 based on being configured to detect duplicate files and/or perform corresponding deduplication. For example, deduplication and/or querying of table 3411 is performed via DDL loading. In some embodiments, deduplication by file name is implemented in some or all cases. In some embodiments, deduplication is finalized with new tables. In some embodiments, roll-off policy and/or roll-off triggers are implemented.

In some embodiments, the database system 10 is configured to implement DDL event-driven continuous loading via one or more loading processes 2605 based on being configured to validate monitor configurations. For example, continuous monitors can have options for configuration (e.g. via a user entity) that can conflict with batch pipelines implemented via the database system. Such potential conflicts can be avoided automatically based on database system 10 being implemented to ensure no redundant and/or conflicting options exist/are selectable via user input and/or to ensure no such redundant and/or conflicting options that are selected via user input are applied.

In some embodiments, the database system 10 is configured to implement DDL event-driven continuous loading via one or more loading processes 2605 based on being configured to track metrics and/or make these metrics observable, for example, in one or more persistent system table (e.g. in addition to table 3411) and/or in metadata accessible via a user entity (e.g. via corresponding queries against these tables). In some embodiments, errors are logged in response to failing to extract information from an event topic. In some embodiments, errors relating to event monitor module 3410 and/or any of the set of other monitors 3412 are logged.

In some embodiments, the database system 10 is configured to implement DDL event-driven continuous loading via one or more loading processes 2605 based on being configured to perform system tests.

In some embodiments, the database system 10 is configured to implement DDL event-driven continuous loading via one or more loading processes 2605 based on being configured to implement a Kafka message extraction format, for example, in accordance with Apache Kafka. In some embodiments, the Kafka message extraction format is generalized to all monitors (e.g. messages are extracted from SQS monitor 3441, Kafka monitor 3442, one or more file last modified monitors 3443, and/or one or more file name monitors in conjunction with this generalization of this Kafka message extraction format).

In some embodiments, the database system 10 is configured to implement DDL event-driven continuous loading via one or more loading processes 2605 based on being configured to implement table Time to Live (TTL). For example, the database system 10 is configured to limit table sizes, such as virtual table sizes and/or persistent table sizes, for example, of any system table discussed herein.

In some embodiments, the database system 10 is configured to implement DDL event-driven continuous loading via one or more loading processes 2605 based on being configured to retry transient errors.

FIG. 25B illustrates an embodiment of performing loading process 2605 implementing SQS monitor 3441. Some or all features and/or functionality of the loading process of FIG. 25B can implement the loading process 2605 of FIG. 25A and/or any embodiment of loading process 2605 described herein.

In some embodiment, interfacing with SQS monitor 3441 requires the client (e.g. event monitor module 3410) to delete a message (e.g. a corresponding event target and/or file) after reception. A full cycle for processing a message can look like (1) message arrived at SQS monitor 3441 (e.g. from a data source 2501); (2) message pulled by the client (e.g. via polling by event monitor module 3410), for example where 1-10 messages are polled at a time, with a visibility time out set to 1 hour or another time; (3) client processing (e.g. event monitor module 3410 adds the message to table 3411 via an update system pipeline file function 3449 (e.g. update_sys_pipeline_file), for example, after first adding a request to add the message to table 3411 in a requests queue 3432, for example, implemented via file last modified monitor 3443; and/or (4) delete message from sqs monitor 3441 (e.g. a request is sent and/or a function is called to render deletion of the message once it has been added to the table 3441).

In some embodiments, if a message is not deleted within the configured visibility timeout (e.g. 1 hour), it will become visible to the client again via SQS monitor 3441. This means database system 10 has to persist the message in table 3411 timely (e.g. via the above steps 2-4). If the database system 10 fails to persist and delete the message within the timeout (e.g. 1 hour), the message is ultimately persistently stored without a problem because either (1) the message persisted but failed to delete, where the message will be re-polled, and ultimately deduplicated later via deduplication applied to the files in the table 3411; or (2) the message was not deleted because it was not persisted, where the message will be re-polled due to not having been deleted and need not be deduplicated due to not yet appearing in any pipeline due to not being persisted.

FIG. 25C illustrates a method for execution by at least one processing module of a database system 10. For example, the database system 10 can utilize at least one processing module of one or more nodes 37 of one or more computing devices 18, where the one or more nodes execute operational instructions stored in memory accessible by the one or more nodes, and where the execution of the operational instructions causes the one or more nodes 37 to execute, independently or in conjunction, the steps of FIG. 25C, for example, based on participating in execution of a query being executed by the database system 10. Some or all of the method of FIG. 25C can be performed by nodes executing a loading operation, for example, via one or more nodes 37 implemented as loading nodes 2510. In some embodiments, a node 37 can implement some or all of FIG. 26K based on implementing a corresponding plurality of processing core resources 48.1-48.W. Some or all of the steps of FIG. 25C can optionally be performed by any other one or more processing modules of the database system 10

Some or all steps of FIG. 25C can be performed in parallel and/or concurrently via a plurality of parallelized processing resources (e.g. implemented via a plurality of nodes 37 and/or a plurality of processing core resources 48). For example, multiple instances of any given step of FIG. 25C can be performed in parallel and/or concurrently via a plurality of parallelized processing resources, where each parallelized processing resource of the plurality of parallelized processing resources performs the given step in parallel with and/or concurrently with other ones of the plurality of parallelized processing resources also performing the given step. As another example, any given step of FIG. 25C can be performed based on a plurality of parallelized processing resources performing assigned portions of the given step in parallel and/or concurrently, where each parallelized processing resource of the plurality of parallelized processing resources performs their assigned portion of the step in parallel with and/or concurrently with other ones of the plurality of parallelized processing resources also performing their own assigned portions of the given step.

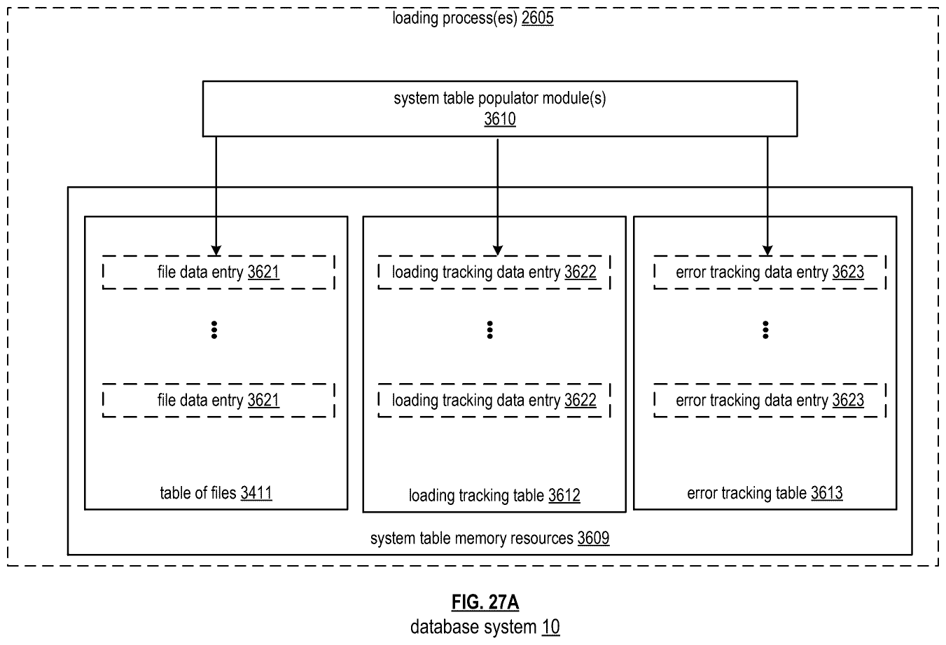

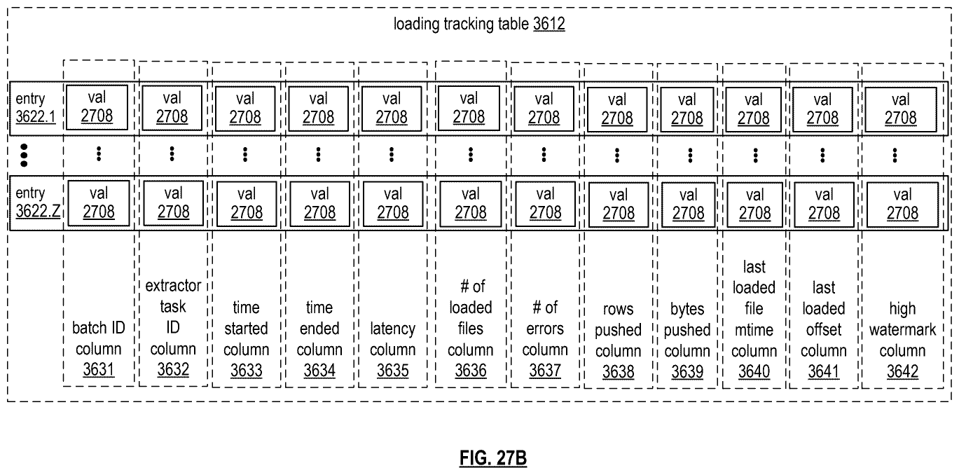

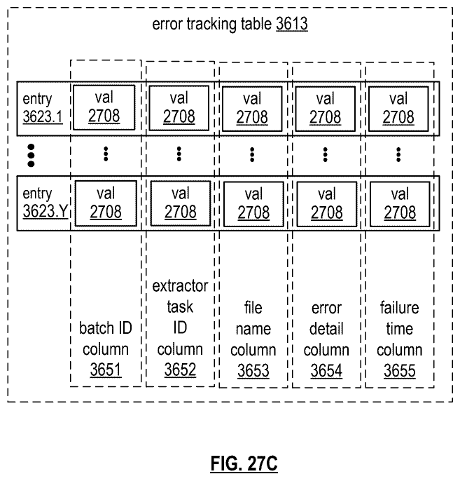

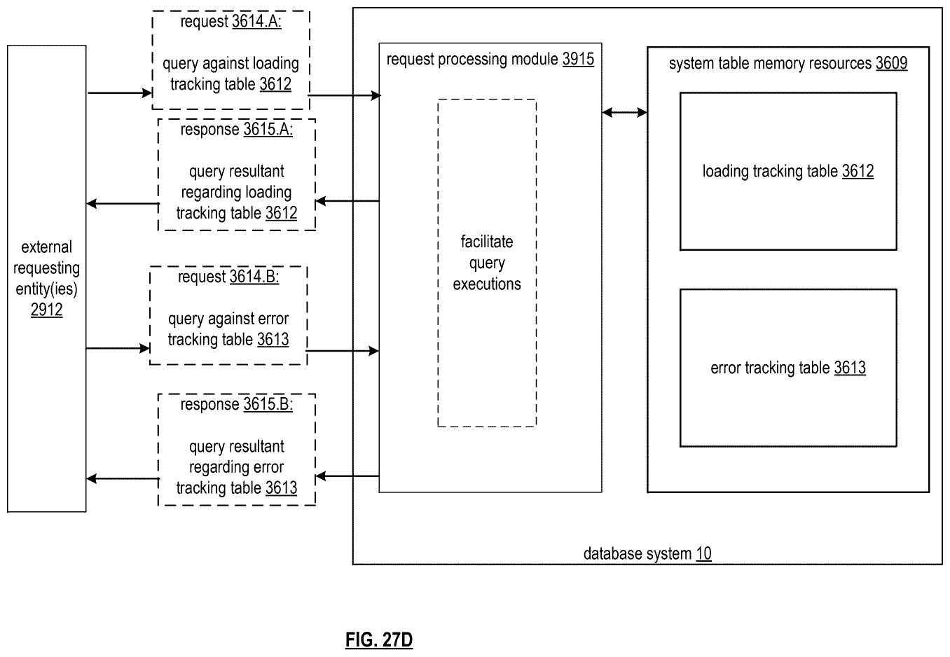

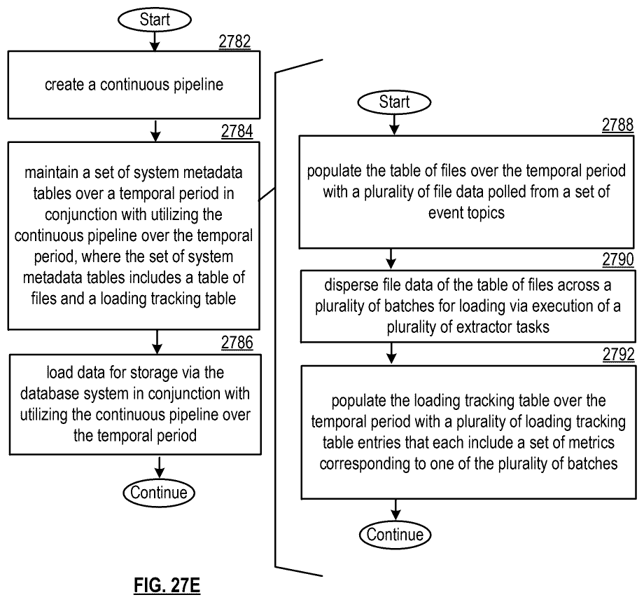

Some or all of the steps of FIG. 25C can be performed to implement some or all of the functionality of the database system 10 as described in conjunction with FIGS. 25A-25B and/or FIGS. 26A-27E, for example, by implementing some or all of the functionality of loading process 2605 (e.g. via implementing event monitor module 3410 and/or continuous pipeline task execution module 3415). Some or all steps of FIG. 25C can be performed by database system 10 in accordance with other embodiments of the database system 10 and/or nodes 37 discussed herein. Some or all of the steps of FIG. 25C can be performed in conjunction with performing some or all steps of any other method described herein.

Step 2582 includes creating a continuous pipeline. Step 2584 includes loading data for storage via the database system in conjunction with utilizing the continuous pipeline over a temporal period.

Performing step 2584 can include performing step 2586 and/or step 2588. Step 2586 includes implementing an event monitor module. Step 2584 includes implementing a implementing a continuous pipeline task execution module to execute a continuous pipeline task.

Performing step 2586 can include performing step 2590 and/or step 2992. For example, step 2590 and/or step 2592 are performed via the event monitor module. Step 2590 includes executing a plurality of polls to a set of event topics of a set of other monitors over the temporal period to poll a plurality of sets of messages from the set of event topics. In various examples, each poll of the plurality of polls is executed to poll a corresponding set of messages of the plurality of sets of messages from a corresponding one of the set of event topics. Step 2592 includes adding a plurality of file data to a table of files over the temporal period based on processing the plurality of sets of messages. In various examples, each set of messages of the plurality of sets of messages is processed to add corresponding file data of the plurality of file data to the table of files.

Performing step 2588 can include performing step 2594 and/or step 2596. For example, step 2594 and/or step 2596 are performed via the continuous pipeline task execution module. Step 2594 includes dispersing file data of the table of files into a plurality of file work units over the temporal period. Step 2596 includes generating a plurality of extractor tasks to load the data for storage based on collectively processing the plurality of file work units.

In various examples, the set of other monitors includes multiple monitors of multiple monitor types. In various examples, polling the messages from the set of event topics includes interfacing with each of the multiple monitors in accordance with a corresponding protocol for a corresponding one of the multiple monitor types.

In various examples, interfacing with a first monitor of the set of monitors includes executing a first subset of the plurality of polls to a corresponding first subset of the set of event topics corresponding to the first monitor. In various examples, each poll of the first subset of the plurality of polls is executed to poll a corresponding set of messages of a first subset of the plurality of sets of messages from a corresponding one of the corresponding first subset of the set of event topics.

In various examples, interfacing with a first monitor of the set of monitors further includes, after adding each corresponding file data to the table of files in response to processing each corresponding set of based messages of the first subset of the plurality of sets of messages, sending a request to the first monitor to delete the each corresponding set of messages of the first subset of the plurality of sets of messages.

In various examples, the set of corresponding set of messages of the first subset of the plurality of sets of messages polled via the each poll includes up to a predetermined maximum number of messages configured for interfacing with the first monitor. In various examples, the predetermined maximum number of messages is 10.

In various examples, a predetermined visibility timeout configured for interfacing with the first monitor is applied for deleting each corresponding set of messages of the first subset of the plurality of sets of messages polled via the each poll each poll of the first subset of the plurality of polls. In various examples, when the each corresponding set of messages is not deleted within the predetermined visibility timeout, the corresponding set of messages becomes again available for polling from the corresponding one of the corresponding first subset of the set of event topics. In various examples, the predetermined visibility timeout is set to one hour.

In various examples, the multiple monitor types include: a Simple Queue Service (SQS) monitor type, wherein a first one of the multiple monitors is an SQS monitor having the SQS monitor type, and/or a Kafka monitor type, wherein a second one of the multiple monitors is a Kafka monitor having the Kafka monitor type.

In various examples, interfacing with the SQS monitor includes executing an SQS-based subset of the plurality of polls to a corresponding SQS-based subset of the set of event topics corresponding to the SQS monitor. In various examples, each SQS-based poll of the SQS-based subset of the plurality of polls of polls is executed to poll a corresponding set of SQS-based messages of an SQS-based subset of the plurality of sets of messages from a corresponding one of the corresponding SQS-based subset of the set of event topics. In various examples, interfacing with the SQS monitor further includes, after adding each corresponding file data to the table of files in response to processing each corresponding set of SQS-based messages of an SQS-based subset, sending a request to the SQS monitor to delete the each corresponding set of SQS-based messages.

In various examples, loading data for storage via the database system in conjunction with utilizing the continuous pipeline over a temporal period is further based on deduplicating the plurality of file data based on identifying duplicate ones of the plurality of file data.

In various examples, the method further includes suspending the loading of data for storage via the database system at a first time during the temporal period based on pausing utilization of the continuous pipeline at the first time. In various examples, the method further includes resuming the loading of data for storage via the database system at a second time (e.g. after the first time) during the temporal period based on restating utilization of the continuous pipeline at the second time.

In various examples, resuming the loading of data for storage is based on processing a start continuous pipeline function call received in a request from a user entity.

In various examples, loading the data for storage via the database system in conjunction with utilizing the continuous pipeline over the temporal period is further based on maintaining state data for the event monitor module. In various examples, resuming the loading of data for storage via the database system at the second time is based on accessing the state data for the event monitor module.

In various examples, maintaining the state data includes updating, in response to processing the each set of messages, at least one of a file count value; a file total size value; a lasted loaded offset value; a high watermark value; a sequence number; a lasted listed time; and/or a time window.

In various examples, the loading of data for storage via the database system is suspended at the first time in response to encountering an error.

In various examples, the table of files is maintained as a relational database table stored in system metadata of the database system.

In various examples, the method further includes maintaining a plurality of additional relational database tables in the system metadata that includes: a loading tracking table indicating at least one loading metric tracked in conjunction with loading the data; and/or an error tracking table indicating at least one error encountered in conjunction with loading the data.

In various examples, the data is loaded across a plurality of batches. In various examples, each batch includes a corresponding subset of the plurality of file work units and is loaded by a corresponding one of the plurality of extractor tasks. In various examples, the loading tracking table is populated with a first plurality of entries based on logging a corresponding entry of the first plurality of entries in response to processing each batch of the plurality of batches. In various examples, the error tracking table is populated with a second plurality of entries based on logging a corresponding entry of the second plurality of entries in response encounter in loading a batch of the plurality of batches.

In various examples, implementing the event monitor module includes generating event notifications based on at least one of generating a modification time-based file data listing based on filtering out file data of the plurality of file data with a last modification time outside a configured modification time range; and/or generating a file name-based file data listing based on sorting the file data of the plurality of file data by file name.

In various examples, the continuous pipeline is created in accordance with user-configured selections for a set of user-configurable parameters indicated in a continuous pipeline creation function call received in a request from a user entity.

In various examples, the set of user-configured selections includes at least one of: a selected monitor type for a monitor type parameter of the set of user-configurable parameters; a selected polling interval for a polling interval parameter of the set of user-configurable parameters; a selected minimum update size for a minimum update size parameter of the set of user-configurable parameters; a selected update timeout parameter for an update timeout parameter of the set of user-configurable parameters; a selected batch timeout for a batch timeout parameter of the set of user-configurable parameters; or a selected batch minimum file count for a batch minimum file count parameter of the set of user-configurable parameters.

In various embodiments, any one or more of the various examples listed above are implemented in conjunction with performing some or all steps of FIG. 25C. In various embodiments, any set of the various examples listed above can be implemented in tandem, for example, in conjunction with performing some or all steps of FIG. 25C, and/or in conjunction with performing some or all steps of any other method described herein.

In various embodiments, at least one memory device, memory section, and/or memory resource (e.g., a non-transitory computer readable storage medium) can store operational instructions that, when executed by one or more processing modules of one or more computing devices of a database system, cause the one or more computing devices to perform any or all of the method steps of FIG. 25C described above, for example, in conjunction with further implementing any one or more of the various examples described above.

In various embodiments, a database system includes at least one processor and at least one memory that stores operational instructions. In various embodiments, the operational instructions, when executed by the at least one processor, cause the database system to perform some or all steps of FIG. 25C, for example, in conjunction with further implementing any one or more of the various examples described above.

In various embodiments, the operational instructions, when executed by the at least one processor, cause the database system to create a continuous pipeline and load data for storage in conjunction with utilizing the continuous pipeline over a temporal period. In various embodiments, loading the data for storage in conjunction with utilizing the continuous pipeline over the temporal period is based on implementing an event monitor module based on: executing a plurality of polls to a set of event topics of a set of other monitors over the temporal period to poll a plurality of sets of messages from the set of event topics, where each poll of the plurality of polls is executed to poll a corresponding set of messages of the plurality of sets of messages from a corresponding one of the set of event topics; and/or adding a plurality of file data to a table of files over the temporal period based on processing the plurality of sets of messages, wherein each set of messages of the plurality of sets of messages is processed to add corresponding file data of the plurality of file data to the table of files. In various embodiments, loading the data for storage in conjunction with utilizing the continuous pipeline over the temporal period is alternatively or additionally based on implementing a continuous pipeline task execution module to execute a continuous pipeline task based on: partitioning file data of the table of files into a plurality of file work units over the temporal period; and/or generating a plurality of extractor tasks to load the data for storage based on collectively processing the plurality of file work units.

FIGS. 26A-26D illustrate embodiments of database system 10 that performs loading process 2605 (e.g. via some or all features and/or functionality described in conjunction with FIGS. 25A-25C) based on applying user-configured selections 3912 for one or more parameters 3911 configured in a request 3914 generated by and/or received from a user entity 2012. Some or all features and/or functionality of any combination of user-configurable parameters and/or corresponding options for implementing loading process 2605 can be applied to implement any embodiment of loading process 2605 (e.g. based on such a combination of selections being configured via a user entity 3012 in a corresponding request 3914). Some or all features and/or functionality of FIGS. 26A-26D can implement any embodiment of database system 10 described herein.

FIG. 26A illustrates an embodiment of a database system 10 that implements a request processing module 3915 to process a request 3914 generated by and/or received from user entity 2012. The request can indicate a create continuous pipeline function call 3910 indicating a set of user-configured selections 3912.1-3912.K for a set of user-configurable parameters 3911.1-3911.K.

The request processing module 3915 can process the create continuous pipeline function call 3910 of request 3914 in accordance with create continuous pipeline function definition data 3906 indicated in a function library 3905 (e.g. implemented via memory resources of database system 10). For example, the request processing module 3915 can process the create continuous pipeline function call 3910 based on applying the create continuous pipeline function definition data 3906 to identify and/or extract the create continuous pipeline function call 3910 and/or respective selections 3912 for the parameters 3911.1-3911.K based on implementing a create continuous pipeline function call extraction module 3912. The extracted selections 3912.1-3912.K can be processed via a create continuous pipeline function execution module to execute the create continuous pipeline function call 3910 an create a continuous pipeline accordingly via create continuous pipeline step 3405, which can trigger a corresponding loading process 3506 be performed in conjunction with implementing the created continuous pipeline, for example, as discussed in conjunction with FIG. 25A.

The create continuous pipeline function definition data 3906 can indicate a function call keyword 3907 for the create continuous pipeline function, which can be utilized to identify and extract the create continuous pipeline function call 3910 via request processing module 3915 when parsing the request 3914.

The create continuous pipeline function definition data 3906 can alternatively or additionally indicate a parameter set 3908 of a plurality of parameters 3911.1-3911.P. For example, for each given parameter 3911 in parameter set 3908, the create continuous pipeline function definition data 3906 indicates a corresponding parameter keyword 3909 identifying the given parameter 3911 and/or corresponding domain 3916 for selections 3912 for the given parameter (e.g. datatype of selection 3912 and/or discrete set of options for selection 3912). This can be utilized to identify and extract particular user-configured selections 3912 for one or more user-configurable parameters 3911 (e.g. identifying which parameters 3911 have been configured with which selections 3912, and/or whether or not these selections are valid as defined by the corresponding domain 3916) via request processing module 3915 when parsing the request 3914. For example, function call 3910 indicates configuration of a given parameter 3911 based on having corresponding text including its keyword 3909 followed by (e.g. immediately followed by) the selection 3912 falling within the corresponding domain 3916 (e.g. of the respective datatype and/or a particular string indicated in the discrete set of options).

In some embodiments, for each given parameter 3911 in parameter set 3908, the create continuous pipeline function definition data 3906 indicates whether the given parameter is required or optional. For example, the value ofK is less than the value of P in some or all cases, where only K selections 3912.1-3912.K for only K parameters 3911.1-3911.K are configured in a given request 3914 based on one or more other optional parameters 3911 of the parameter set 3908 not being configured. In some embodiments, for each given parameter 3911 in parameter set 3908, the create continuous pipeline function definition data 3906 indicates a default value for the given parameter to be applied if not indicated in a corresponding function call (e.g. based on being optional and the user electing not to configure this parameter), for example, where the P minus K parameters 3911 not set in request 3914 have their default values applied in processing and executing the request 3914.

The create continuous pipeline function definition data 3906 can alternatively or additionally indicate function call syntactical structuring data 3907 for create continuous pipeline function call 3910 (e.g. corresponding syntactical requirements) which can be further utilized to identify and extract the create continuous pipeline function call 3910 (and/or determine whether the create continuous pipeline function call 3910 is syntactically valid) and/or particular selections 3912 for some or all parameters 3911 via request processing module 3915 when parsing the request 3914.

The create continuous pipeline function definition data 3906 can alternatively or additionally indicate execution instructions 3918, which can indicate a set of instructions as a function F of selections 3912 for parameters 3911.1-3911.P. The create continuous pipeline function execution module 3922 can perform the create continuous pipeline step 3405 and/or otherwise execute the given create continuous pipeline function call 3910 as defined by the execution instructions 3918, applying the extracted selections 3912.1-3912.K accordingly.

FIG. 26B illustrates an example embodiment of create continuous pipeline function definition data 3906. Some or all features and/or functionality of the create continuous pipeline function definition data 3906 can implement the create continuous pipeline function definition data 3906 of FIG. 26A and/or any embodiment of creating a continuous pipeline described herein.

For example, the of create continuous pipeline function definition data 3906, and/or a corresponding create continuous pipeline function call 3910, can be implemented vis some or all of the following example code (e.g. implemented via DDL) and/or corresponding logic:

```
CREATE CONTINUOUS PIPELINE [IF NOT EXISTS | OR REPLACE] <pipeline_name>
SOURCE
  FILE_MONITOR (
  MONITOR_TYPE {kafka | sqs | file_last_modified | file_name | etc...}
  [POLLING_INTERVAL_SECOND {n} ]
  SQS_QUEUE_URL <sqs_queue_endpoint>
  [ ACCESS_KEY_ID <access_key_credentials>]
  [ SECRET_ACCESS_KEY <secret_key_credentials>]
  BOOTSTRAP_SERVERS ‘<IP:port>, ...’
  TOPIC ‘<topic_name>’
  [FILE_PATH_JSON_EXPRESSION <expression>]
  [CONFIG ‘<kafka_configuration_json>’]
[PIPELINE_FILES_TTL {n} {SECONDS | MINUTES | HOURS | DAYS}]
[DUPLICATE_FILE_DECTION_PERIOD {n} {SECONDS | MINUTES | HOURS | DAYS}]
[PREFIX_TEMPLATE string]
)
```

In some embodiments, optional parameters are denoted in function definition 3906 based on being enclosed in bracketing characters, such as ‘[’ and ‘]’.

As illustrated in FIG. 26B, functional call keyword 3907 is implemented as “CREATE CONTINUOUS PIPELINE”, or optionally a different keyword. The keyword 3907 can be a unique keyword and/or reserved keyword to enable identification and/or extraction of a corresponding create continuous pipeline function call 3910.

In some embodiments, <pipeline_name>denotes where a corresponding name of the corresponding pipeline be placed as a corresponding selection 3912 (e.g. as a string included in corresponding text of the function call 3910). As a particular example, the user creates a continuous pipeline called “my_pipeline” based on the text of the function call 3910 including “CREATE CONTINUOUS PIPELINE my_pipeline”.

In some embodiments, parameter set 3908 includes an if not exists parameter and/or a replace parameter. In some embodiments, an if not exists parameter keyword 3931 for the if not exists parameter of parameter set 3908 can be implemented as IF NOT EXISTS. Alternatively or in addition, a replace parameter keyword 3932 for replace parameter of parameter set 3908 can be implemented as REPLACE. In some embodiments, these parameters are optional. In some embodiments, only one of these corresponding parameters can be applied. In some embodiments, one of these corresponding parameters is required to be applied.

In some embodiments, the selection 3912 for the if not exists parameter is denoted as selecting to utilize this parameter via inclusion of if not exists parameter keyword 3931 in the function call (e.g. the text of the function call 3910 includes “CREATE CONTINUOUS PIPELINE IF NOT EXISTS my_pipeline” in the case where the name of the pipeline is “my_pipeline”).

In some embodiments, the selection 3912 for the replace parameter is denoted as selecting to utilize this parameter via inclusion of replace parameter keyword 3932 in the function call (e.g. the text of the function call 3910 includes “CREATE CONTINUOUS PIPELINE REPLACE my_pipeline” in the case where the name of the pipeline is “my_pipeline”).

In some embodiments, each of a set of file monitors utilized as sources (e.g. monitors of other set of monitors 3412) can be configured as corresponding sources (e.g. to which the event monitor module 3410 will poll) based on being configured as a corresponding source monitor via SOURCE and/or FILE MONITOR keywords. For example, a given monitor of the set of other monitors 3412 is configured via a corresponding per-monitor parameter set 3918 of configured selections 3912, where different monitors of the set of other monitors 3412 are optionally configured differently with different selections for some or all of the parameters of per-monitor parameter set 3918.

In some embodiments, parameter set 3908 includes a monitor type parameter 3448. In some embodiments, keyword 3909 for monitor type parameter of parameter set 3908 is implemented as “MONITOR TYPE”, or as a different keyword. In some embodiments, the monitor type parameter is a required parameter that must be configured in the function call 3910.

In some embodiments, the domain 3916 for a monitor type selection of the monitor type parameter indicates a discrete set of options, such as a set of strings from which the user must select to denote a corresponding selection 3912. For example, the set of strings of domain 3956 includes: “kafka” indicating selection of kafka monitor 3442; “sqs” indicating selection of sqs monitor 3441; “file last modified” indicating selection of file last modified monitor 3443; “file name” indicating selection of a file name monitor. One or more of these monitor types can be identified via different string values. One or more other monitor types can be identified via corresponding other string values indicated in domain 3956.

As a particular example, selection of the sqs monitor 3441 can be configured based on the text of the function call 3910 including “MONITOR TYPE sqs”, while selection of the file last modified monitor 3443 can be configured based on the text of the function call 3910 including “MONITOR TYPE file_last_modified”.

In some embodiments, only one monitor type selection can be made from the set of options in domain 3956 for a given file monitor. In some embodiments, multiple monitor type selection can be made from the set of options in domain 3956 for configuring multiple file monitors. For example, multiple file monitors are created via multiple instances of “FILE MONITOR”, each having different types and corresponding configurations. As a particular example, multiple monitors of the same or different type are configured in creating the continuous pipeline as sources via text of the function call including “SOURCE FILE MONITOR (MONITOR_TYPE kafka) FILE MONITOR (MONITOR_TYPE sqs)”

In some embodiments, parameter set 3908 includes a polling interval parameter 3934, for example, having keyword 3909 implemented as “POLLING_INTERVAL_SECOND,” or as a different keyword. The polling interval parameter 3934 can be an optional parameter (e.g. with a default number of seconds as 10 seconds). The domain 3916 for polling interval parameter 3934 can be any value of an integer or other numeric datatype (e.g. any value n), denoting a corresponding number of seconds for the polling interval (e.g. how often the event monitor module 3410 polls the respective monitor of the set of other monitors 3412). As a particular, example, the polling interval for the given monitor is set to 25 seconds based on text of the function call 3910 including “POLLING_INTERVAL_SECOND 25”.

In some embodiments, parameter set 3908 includes a pipeline files time to live (TTL) parameter 3944, for example, having keyword 3909 implemented as “PIPELINE_FILES_TTL,” or as a different keyword. The pipeline files TTL parameter 3944 can be an optional parameter. The domain 3916 for pipeline files TTL parameter 3944 can be any value of an integer or other numeric datatype (e.g. any value n), denoting a corresponding number of seconds, minutes, hours, or days for a TTL implemented for retention control (e.g. applied to table 3411 and/or corresponding files polled from the monitor to be included in the table 341, for example, to limit table size). Whether the respective value represents seconds, minutes, hours, or days can be based on the user further indicating a respective time units keyword (e.g. “SECONDS” is the keyword selected to represent seconds; “MINUTES” is the keyword selected to represent minutes; “HOURS” is the keyword selected to represent hours; and/or “DAYS” is the keyword selected to represent days), which can be included following the value. As a particular, example, the TTL is set to 2 hours based on text of the function call 3910 including “PIPELINE_FILES_TTL 2 HOURS”.

In some embodiments, parameter set 3908 includes a duplicate file detection period parameter 3945, for example, having keyword 3909 implemented as “DUPLICATE_FILE_DETECTION_PERIOD,” or as a different keyword. The duplicate file detection period parameter 3945 can be an optional parameter. The domain 3916 for duplicate file detection period parameter 3945 can be any value of an integer or other numeric datatype (e.g. any value n), denoting a corresponding number of seconds, minutes, hours, or days for a time period implemented for duplicate file detection (e.g. applied as a search scope when querying the table 3411). Whether the respective value represents seconds, minutes, hours, or days can be based on the user further indicating a respective time units keyword (e.g. “SECONDS” is the keyword selected to represent seconds; “MINUTES” is the keyword selected to represent minutes; “HOURS” is the keyword selected to represent hours; and/or “DAYS” is the keyword selected to represent days), which can be included following the value. As a particular, example, the time period is set to 5 minutes based on text of the function call 3910 including “DUPLICATE_FILE_DETECTION_PERIOD 5 MINUTES”.

In some embodiments, the function definition data 3906 specifies that monitor configuration is based on the selected monitor type value (e.g. the respective string selected from the domain 3956 for monitor type selection 3957), where some parameters are specific to a particular type of monitor. In some embodiments, if wrong parameters are specified with selections in the create continuous pipeline function call 3910, the corresponding parsing of the request renders an error.

In some embodiments, parameter set 3908 includes an SQS-based parameter set 3935, for example, that are only to be configured via corresponding selections 3912 when the monitor type parameter is selected as an SQS monitor 3441 (e.g. via selection of “sqs”). In some embodiments, parameter set 3908 alternatively or additionally includes a Kafka-based parameter set 3939, for example, that are only to be configured via corresponding selections 3912 when the monitor type parameter is selected as a Kafka monitor 3442 (e.g. via selection of “kafka”). In some embodiments, parameter set 3908 alternatively or additionally includes a file last modified and/or file name-based parameter set 3946, for example, that are only to be configured via corresponding selections 3912 when the monitor type parameter is selected as either a file last modified monitor 3443 (e.g. via selection of “file_last modified”) or a file name monitor (e.g. via selection of “file_name”).

The SQS-based parameter set 3935 can include an SQS queue URL parameter 3936, for example, having keyword 3909 implemented as “SQS_QUEUE URL”, or as a different keyword. The SQS queue URL parameter 3936 can be a required parameter (e.g. only required in the case where the monitor type parameter is configured as the SQS monitor type). The domain 3916 for SQS queue URL parameter 3936 can be a string value indicating the corresponding SQS queue endpoint (e.g. https://sqs.<region>.amazonaws.com/<account-id>/<queue-name>). For example, a particular sqs queue endpoint with region “abc”, account id “123” and queue name “def” is configured for the SQS monitor based on the text of the function call 3910 including “SQS QUEUE_URL https://sgs.abe.amazonaws.com/123/def”.

The SQS-based parameter set 3935 can alternatively or additionally include an access key identifier parameter 3937, for example, having keyword 3909 implemented as “ACCESS_KEY_ID”, or as a different keyword. The access key identifier parameter 3937 can be an optional parameter (e.g. only allowed in the case where the monitor type parameter is configured as the SQS monitor type). The domain 3916 for access key identifier parameter 3937 can be a string value indicating access key credentials (e.g. in accordance with a corresponding SQS protocol). For example, a particular access key identifier “456” is configured for the SQS monitor based on the text of the function call 3910 including “ACCESS_KEY_ID 456”.

The SQS-based parameter set 3935 can alternatively or additionally include a secret access key parameter 3938, for example, having keyword 3909 implemented as “SECRET_ACCESS_KEY”, or as a different keyword. The secret access key parameter 3937 can be an optional parameter (e.g. only allowed in the case where the monitor type parameter is configured as the SQS monitor type). The domain 3916 for secret access key parameter 3937 can be a string value indicating secret key credentials (e.g. in accordance with the corresponding SQS protocol). For example, a particular secret access key “789” is configured for the SQS monitor based on the text of the function call 3910 including “ACCESS_KEY_ID 789”.

The SQS-based parameter set 3935 can alternatively or additionally include other parameters for configuring a corresponding SQS monitor 3441.

The Kafka-based parameter set 3939 can include a bootstrap servers parameter 3940, for example, having keyword 3909 implemented as “BOOTSTRAP_SERVERS”, or as a different keyword. The bootstrap servers parameter 3940 can be a required parameter (e.g. only required in the case where the monitor type parameter is configured as the Kafka monitor type). The domain 3916 for bootstrap servers parameter 3940 can be at least one string value indicating an IP port and/or additional information(e.g. in accordance with a corresponding Kafka protocol).

The Kafka-based parameter set 3939 can alternatively or additionally include a topic parameter 3941, for example, having keyword 3909 implemented as “TOPIC”, or as a different keyword. The topic parameter 3941 can be a required parameter (e.g. only required in the case where the monitor type parameter is configured as the Kafka monitor type). The domain 3916 for topic parameter 3941 can be a string value indicating a topic name (e.g. in accordance with a corresponding Kafka protocol).

The Kafka-based parameter set 3939 can alternatively or additionally include a file path JavaScript Object Notation (JSON) expression parameter 3942, for example, having keyword 3909 implemented as “FILE_PATH_JSON_EXPRESSION”, or as a different keyword. The file path JSON expression parameter 3942 can be an optional parameter. The domain 3916 for file path JSON expression parameter 3942 can be a string value indicating a corresponding JSON expression (e.g. in accordance with the corresponding Kafka protocol).

The Kafka-based parameter set 3939 can alternatively or additionally include a configuration parameter 3943, for example, having keyword 3909 implemented as “CONFIG”, or as a different keyword. The configuration parameter 3943 can be an optional parameter. The domain 3916 for file path JSON expression parameter 3942 can be a string value indicating a corresponding JSON Kafka configuration (e.g. in accordance with the corresponding Kafka protocol).

The Kafka-based parameter set 3939 can alternatively or additionally include other parameters for configuring a corresponding Kafka monitor 3442.

The file last modified and/or file name-based parameter set 3946 can include a prefix template parameter 3947, which can be implemented to override the prefix dynamically. The prefix template parameter 3947 can have keyword 3909 implemented as “PREFIX_TEMPLATE”, or as a different keyword. The prefix template parameter 3947 can be an optional parameter (e.g. only allowed in the case where the monitor type parameter is configured as the file last modified monitor type or the file name monitor type). The domain 3916 for prefix template parameter 3947 can be a string value indicating a corresponding prefix (e.g. first substring of a corresponding file name).

In some embodiments, parameter set 3908 alternatively or additionally includes any other parameters. In some embodiments, parameter set 3908 alternatively or additionally includes some or all parameters listed in FIG. 26C and/or 26D.

FIG. 26C illustrates an example embodiment of a set of parameters of parameter set 3908. In some embodiments, the parameters of FIG. 26C constitute only some of the parameters of parameter set 3908.

The parameter set 3908 can include a monitor type parameter 3948. The monitor type parameter can have keyword 3909 (e.g. monitor type parameter keyword 3933) implemented as “MONITOR_TYPE”, or as a different keyword. The monitor type parameter can be a required parameter (e.g. with no default value due to being required). The domain 3916 of monitor type parameter can be implemented as a string datatype (e.g. selected from the discrete set of options of domain 3916 for monitor type selection). The selection 3912 for monitor type parameter can define the type of monitor, where if the given string is not one of the defined monitors, compilation optionally fails.

The parameter set 3908 can alternatively or additionally include a polling interval parameter 3934. The polling interval parameter can have keyword 3909 implemented as “POLLING_INTERVAL_SECOND”, or as a different keyword. The polling interval parameter can be an optional parameter (e.g. with a default value of 10, denoting 10 seconds). The domain 3916 of polling interval parameter can be implemented as an integer or other numeric datatype, , for example, denoting a corresponding number of seconds. The selection 3912 for polling interval parameter can define the number of second in which an event topic is consumed, and/or a number of seconds between polls.

The parameter set 3908 can alternatively or additionally include a minimum update size parameter 3961. The minimum update size parameter can have keyword 3909 implemented as “MIN_UPDATE_SIZE”, or as a different keyword. The minimum update size parameter can be an optional parameter (e.g. with a default value of 20, denoting a size of 20). The domain 3916 of minimum update size parameter can be implemented as an integer or other numeric datatype, , for example, denoting a corresponding number of files and/or corresponding size. The selection 3912 for minimum update size parameter can define the minimum number that database system 10 will persist consumed file to table 3411.

The parameter set 3908 can alternatively or additionally include an update timeout parameter 3962. The update timeout parameter can have keyword 3909 implemented as “UPDATE_TIMEOUT_SECOND”, or as a different keyword. The update timeout parameter can be an optional parameter (e.g. with a default value of 10, denoting 10 seconds) The domain 3916 of update timeout parameter can be implemented as an integer or other numeric datatype, for example, denoting a corresponding number of seconds. The selection 3912 for update timeout parameter can define the amount of time database system 10 waits before issuing another update request to table 3411.

The parameter set 3908 can alternatively or additionally include a batch timeout parameter 3963. The batch timeout parameter can have keyword 3909 implemented as “BATCH_TIMEOUT_SECOND”, or as a different keyword. The batch timeout parameter can be an optional parameter (e.g. with a default value of 60, denoting 60 seconds) The domain 3916 of batch timeout parameter can be implemented as an integer or other numeric datatype, for example, denoting a corresponding number of seconds. The selection 3912 for batch timeout parameter can define the amount of time database system 10 waits before creating another loading job if there are pending files and/or if the number of pending files is smaller than a value specified by batch minimum file count parameter 3964.

The parameter set 3908 can alternatively or additionally include a batch minimum file count parameter 3964. The batch minimum file count parameter can have keyword 3909 implemented as “BATCH_MIN_FILE_COUNT”, or as a different keyword. The batch minimum file count parameter can be an optional parameter (e.g. with a default value of 100, denoting 100 files) The domain 3916 of batch minimum file count parameter can be implemented as an integer or other numeric datatype, for example, denoting a corresponding number of files. The selection 3912 for batch minimum file count parameter can define the minimum number of pending files for starting a new loading.

FIG. 26D illustrates an example embodiment of a set of parameters of SQS-based parameter set 3935. In some embodiments, the parameters of FIG. 26D constitute only some of the parameters of parameter set 3908.

The SQS parameter set 3935 can include an access key identifier parameter 3937. The access key identifier parameter can have keyword 3909 implemented as “ACCESS_KEY_ID”, or as a different keyword. The access key identifier parameter can be an optional parameter (e.g. with no default value). The domain 3916 of access key identifier parameter can be implemented as a string datatype, for example, denoting a corresponding access key.

The SQS parameter set 3935 can alternatively or additionally include a secret access key parameter 3938. The secret access key parameter can have keyword 3909 implemented as “SECRET_ACCESS_KEY”, or as a different keyword. The secret access key parameter can be an optional parameter (e.g. with no default value). The domain 3916 of secret access key parameter can be implemented as a string datatype, for example, denoting a corresponding secret key.

In some embodiments, the access key identifier parameter 3937 and secret access key parameter 3938 are required to be supplied with selections 3912 as a pair. For example, the corresponding function call is invalid if a selection is provided for access key identifier parameter 3937 but not for secret access key parameter 3938, or vice versa.

The SQS parameter set 3935 can alternatively or additionally include a region parameter 3965. The region parameter can have keyword 3909 implemented as “REGION”, or as a different keyword. The region parameter can be an optional parameter (e.g. with default value “us-east-1”). The domain 3916 of region parameter can be implemented as a string datatype, for example, denoting a corresponding region (e.g. geographic region).

The SQS parameter set 3935 can alternatively or additionally include an SQS queue URL parameter 3936. The SQS queue URL parameter can have keyword 3909 implemented as “SQS_QUEUE URL”, or as a different keyword. The SQS queue URL parameter can be a required parameter (e.g. with no default value due to being required). The domain 3916 of SQS queue URL parameter can be implemented as a string datatype, for example, denoting a corresponding URL of the target queue.

The SQS parameter set 3935 can alternatively or additionally include an SQS endpoint parameter 3966. The SQS endpoint parameter can have keyword 3909 implemented as “SQS ENDPOINT”, or as a different keyword. The SQS endpoint parameter can be a required parameter (e.g. with no default value due to being required). The domain 3916 of SQS endpoint parameter can be implemented as a string datatype, for example, denoting a corresponding endpoint URL of the client.

The SQS parameter set 3935 can alternatively or additionally include a visibility timeout parameter 3967. The visibility timeout parameter can have keyword 3909 implemented as “VISIBILITY_TIMEOUT”, or as a different keyword. The visibility timeout parameter can be an optional parameter (e.g. with default value of 3600, denoting 3600 seconds i.e. 1 hour). The domain 3916 of visibility timeout parameter can be implemented as an integer or other numeric datatype, for example, denoting a corresponding amount of time (e.g. in seconds) for visibility to time out, which can be configured and/or implemented as discussed in conjunction with FIG. 25B.

FIG. 26E illustrates a method for execution by at least one processing module of a database system 10. For example, the database system 10 can utilize at least one processing module of one or more nodes 37 of one or more computing devices 18, where the one or more nodes execute operational instructions stored in memory accessible by the one or more nodes, and where the execution of the operational instructions causes the one or more nodes 37 to execute, independently or in conjunction, the steps of FIG. 26E, for example, based on participating in execution of a query being executed by the database system 10. Some or all of the method of FIG. 26E can be performed by nodes executing a loading operation, for example, via one or more nodes 37 implemented as loading nodes 2510. In some embodiments, a node 37 can implement some or all of FIG. 26E based on implementing a corresponding plurality of processing core resources 48.1-48.W. Some or all of the steps of FIG. 26E can optionally be performed by any other one or more processing modules of the database system 10

Some or all steps of FIG. 26E can be performed in parallel and/or concurrently via a plurality of parallelized processing resources (e.g. implemented via a plurality of nodes 37 and/or a plurality of processing core resources 48). For example, multiple instances of any given step of FIG. 26E can be performed in parallel and/or concurrently via a plurality of parallelized processing resources, where each parallelized processing resource of the plurality of parallelized processing resources performs the given step in parallel with and/or concurrently with other ones of the plurality of parallelized processing resources also performing the given step. As another example, any given step of FIG. 26E can be performed based on a plurality of parallelized processing resources performing assigned portions of the given step in parallel and/or concurrently, where each parallelized processing resource of the plurality of parallelized processing resources performs their assigned portion of the step in parallel with and/or concurrently with other ones of the plurality of parallelized processing resources also performing their own assigned portions of the given step.

Some or all of the steps of FIG. 26E can be performed to implement some or all of the functionality of the database system 10 as described in conjunction with FIGS. 26A-26D, for example, by implementing some or all of the functionality of request processing module 3915 processing create continuous pipeline function calls 3910 of requests 3914 via create continuous pipeline function definition data 3906. Some or all steps of FIG. 26E can be performed by database system 10 in accordance with other embodiments of the database system 10 and/or nodes 37 discussed herein. Some or all of the steps of FIG. 26E can be performed in conjunction with performing some or all steps of any other method described herein.

Step 2682 includes storing function library data indicating continuous pipeline creation function definition data for a continuous pipeline creation function. Step 2684 includes receiving, from a user entity, a request to create a continuous pipeline for loading data to a database system for storage. Step 2686 includes extracting a function call to execute continuous pipeline creation function from the request based on the function call having syntactical structuring in accordance with the continuous pipeline creation function definition data. Step 2688 includes extracting a set of user-configured selections for a set of user-configurable parameters for creating the continuous pipeline indicated in the function call based on the function call having the syntactical structuring for creating the continuous pipeline. Step 2690 includes executing the continuous pipeline creation function to create the continuous pipeline in accordance with the user-configured selections for the set of user-configurable parameters based on applying the continuous pipeline creation function definition data. Step 2692 includes executing a continuous pipeline task via the database system in conjunction with loading the data for storage in response to creating the continuous pipeline.

In various examples, the set of user-configurable parameters includes a monitor type parameter, wherein the set of user-configured selections includes a monitor type selection for the monitor type parameter.

In various examples, the continuous pipeline creation function definition data indicates a defined set of possible monitor types for the monitor type parameter as a defined set of string values, and wherein the monitor type parameter indicates one of the defined set of possible monitor types via a corresponding one of the defined set of string values.

In various examples, the defined set of possible monitor types includes: a Kafka monitor type; and/or a Simple Queue Service (SQS) monitor type.

In various examples, the continuous pipeline creation function definition data indicates a plurality of sets of monitor type-based parameters that includes a corresponding set of monitor type-based parameters for each of the set of monitor types. In various examples, the plurality of sets of monitor type-based parameters includes a set of Kafka-based monitor parameters and a set of SQS-based monitor parameters.

In various examples, the function call indicates the Kafka monitor type and/or the set of user-configured selections includes at least one Kafka-based user-configured selections for at least one of the set of Kafka-based monitor parameters.

In various examples, the function call indicates the SQS monitor type and the set of user-configured selections includes a set of SQS-based user-configured selections for at least some of the set of SQS-based monitor parameters.

In various examples, the set of SQS-based monitor parameters includes at least one of an access key identifier parameter (e.g. parameter 3937); a secret key access parameter (e.g. parameter 3938); a geographic region parameter (e.g. region parameter 3965); a target queue URL parameter (e.g. SQS queue URL parameter 3936); an endpoint URL parameter (e.g. SQS endpoint parameter 3966); or a visibility timeout parameter (e.g. parameter 3967).

In various examples, the set of user-configurable parameters includes a polling interval parameter. In various examples, the set of user-configured selections includes a configured integer value for the polling interval parameter. In various examples, executing the continuous pipeline task via the database system in conjunction with loading the data is based on consuming events from at least one corresponding monitor for a selected number of seconds denoted by the configured integer value for the polling interval parameter.

In various examples, the set of user-configurable parameters includes a minimum update size parameter. In various examples, the set of user-configured selections includes a configured integer value for the minimum update size parameter. In various examples, executing the continuous pipeline task via the database system in conjunction with loading the data is based on persisting consumed files in a pipeline files table in accordance with a selected minimum number of files indicated by the configured integer value for the minimum update size parameter.

In various examples, the set of user-configurable parameters includes an update timeout parameter. In various examples, the set of user-configured selections includes a configured integer value for the update timeout parameter. In various examples, executing the continuous pipeline task via the database system in conjunction with loading the data is based on waiting up to a selected number of seconds indicated by the configured integer value for the update timeout parameter before issuing a subsequent update request to a pipeline files table.

In various examples, the set of user-configurable parameters includes a batch minimum file count parameter. In various examples, the set of user-configured selections includes a configured integer value for the batch minimum file count parameter. In various example executing the continuous pipeline task via the database system in conjunction with loading the data includes starting a new loading task when at least a selected minimum number of pending files indicated by the configured integer value for the batch minimum file count parameter are pending.

In various examples, the set of user-configurable parameters includes a batch timeout parameter. In various examples, the set of user-configured selections includes a configured integer value for the batch timeout parameter. In various examples, executing the continuous pipeline task via the database system in conjunction with loading the data is based on waiting up to a selected number of seconds indicated by the configured integer value for the batch timeout parameter before creating a new loading job when there is a number of pending files smaller than the selected minimum number of pending files.

In various examples, the set of user-configurable parameters includes an if not exists parameter. In various examples, the set of user-configured selections includes selection to apply the if not exists parameter based on text of the function call including a keyword for the if not exists parameter. In various examples, executing the continuous pipeline creation function to create the continuous pipeline is based on first determining, based on the selection to apply the if not exists parameter, no continuous pipeline already exists.

In various examples, the set of user-configurable parameters includes a replace pipeline parameter. In various examples, the set of user-configured selections includes a pipeline name for the replace pipeline parameter. In various examples, executing the continuous pipeline creation function to create the continuous pipeline is based on replacing another continuous pipeline having the pipeline name with the continuous pipeline.

In various examples, the continuous pipeline creation function call is extracted based on text of the request including a corresponding reserved keyword uniquely identifying the continuous pipeline creation function call.

In various examples, the set of user-configured selections are extracted based on the text of the request further including, after the corresponding reserved keyword, a set of corresponding parameter keywords for the set of user-configurable parameters. In various examples, each user-configured selection of the set of user-configured selections is extracted based on being included in the text of the request after a corresponding one of the set of corresponding parameter keywords.

In various examples, the set of user-configurable parameters correspond to a proper subset of a full set of possible user-configurable parameters indicated in the continuous pipeline creation function definition data. In various examples, a second proper subset of the full set of possible user-configurable parameters are automatically configured with corresponding default values indicated in the continuous pipeline creation function definition data based on not being configured in the function call.

In various examples, a first subset of the full set of possible user-configurable parameters correspond to a required set of user-configurable parameters. In various examples, a second subset of the full set of possible user-configurable parameters correspond to an optional set of user-configurable parameters. In various examples, the set of user-configured selections includes corresponding user selections for all of the first subset of the full set of possible user-configurable parameters, the set of user-configured selections further includes corresponding user selections for at least first one of the second subset of the full set of possible user-configurable parameters. In various examples, the at least one second of the second subset of the full set of possible user-configurable parameters are not configured in the set of user-configured selections.

In various embodiments, any one or more of the various examples listed above are implemented in conjunction with performing some or all steps of FIG. 26E. In various embodiments, any set of the various examples listed above can be implemented in tandem, for example, in conjunction with performing some or all steps of FIG. 26E, and/or in conjunction with performing some or all steps of any other method described herein.

In various embodiments, at least one memory device, memory section, and/or memory resource (e.g., a non-transitory computer readable storage medium) can store operational instructions that, when executed by one or more processing modules of one or more computing devices of a database system, cause the one or more computing devices to perform any or all of the method steps of FIG. 26E described above, for example, in conjunction with further implementing any one or more of the various examples described above.

In various embodiments, a database system includes at least one processor and at least one memory that stores operational instructions. In various embodiments, the operational instructions, when executed by the at least one processor, cause the database system to perform some or all steps of FIG. 26E, for example, in conjunction with further implementing any one or more of the various examples described above.

In various embodiments, the operational instructions, when executed by the at least one processor, cause the database system to: store function library data indicating continuous pipeline creation function definition data for a continuous pipeline creation function; receive, from a user entity, a request to create a continuous pipeline for loading data to a database system for storage; extract a function call to execute continuous pipeline creation function from the request based on the function call having syntactical structuring in accordance with the continuous pipeline creation function definition data; extract a set of user-configured selections for a set of user-configurable parameters for creating the continuous pipeline indicated in the function call based on the function call having the syntactical structuring for creating the continuous pipeline; execute the continuous pipeline creation function to create the continuous pipeline in accordance with the user-configured selections for the set of user-configurable parameters based on applying the continuous pipeline creation function definition data; and/or execute a continuous pipeline task via the database system in conjunction with loading the data for storage in response to creating the continuous pipeline.

FIGS. 27A-27D present embodiments of a database system 10 that tracks metrics relating to loading process 2605, such as metrics regarding loading of individual batches and/or errors associated with loading of batches and/or individual files within batches. Some or all features and/or functionality of FIGS. 27A-27D can implement any embodiment of loading process 2605 described herein.

FIG. 27A illustrates an embodiment of database system 10 that implements one or more loading processes via populating a plurality of tables of system table memory resources 3609 via one or more system table populator modules 3610. One of these tables can correspond to the table of files 3411 (e.g. system table populator module 3610 is implemented as and/or in conjunction with implementing event monitor module 3410) that includes a plurality of file data entries 3621 (e.g. pending files to be loaded). Additional tables can be populated for purposes of tracking metrics relating to loading and/or error tracking.

In some embodiments, system table memory resources 3609 is implemented as system metadata and/or system state data 3105, for example, maintained via a consensus protocol mediated via a plurality of nodes. The system table memory resources 3609 can correspond to any other memory resources of database system 10.

A loading tracking table 3612 can be populated with loading tracking data entries 3622 (e.g. each relating to loading of a particular batch, such as a particular loading batch 2932). An error tracking table 3613 can be populated with error tracking data entries 3623 (e.g. each relating to error(s) encountered in loading a particular batch, such as a particular loading batch 2932). As progress is made in loading batches and/or as errors are encountered, the loading tracking table 3612 and/or error tracking table 3613 can be populated accordingly.

In some embodiments, the table of files 3411 (e.g. sys.pipeline files), the loading tracking table 3612 (e.g. sys.pipeline_loaded batches), the error tracking table 3613 (e.g. sys.pipeline_failed_batches), and/or any system metadata table or other table, for example, stored in system table memory resources 3609, can be implemented via any features and/or functionality of persistent system tables, metadata tables, and/or system metadata of disclosed by U.S. Utility application Ser. No. 18/632,629.

In some embodiments, any of the error tracking (e.g. via entries logged to error tracking table 3613) described herein implements some or all features and/or functionality of the error handling module 2810 disclosed by U.S. Utility application Ser. No. 18/642,043. In some embodiments, error tracking table entries 3623 can be implemented via some or all features and/or functionality of error entries 2629 disclosed by U.S. Utility application Ser. No. 18/642,043 and/or load error tracking data 2816 can be implemented via some or all features and/or functionality of load error tracking data 2816 disclosed by U.S. Utility application Ser. No. 18/642,043.

In some embodiments, the table of files 3411 (e.g. sys.pipeline_files) can be implemented via any embodiment of sys.pipeline_files disclosed by U.S. Utility application Ser. No. 18/642,043 and/or any other embodiment of any system tables, system metadata, and/or relational database tables disclosed by U.S. Utility application Ser. No. 18/642,043.

FIG. 27B illustrates an embodiment of loading tracking table 3612. Some or all features and/or functionality of loading tracking table 3612 of FIG. 27B can implement the loading tracking table 3612 of FIG. 27A and/or any other embodiment of loading tracking table described herein.

Entries 3622 can have values for some or all columns of the table 3612. For example, the loading tracking table 3612 is implemented as a relational database table of rows and columns. Each entry can have values for a set of columns to log metrics for loading of a given batch (e.g. loading batch 2932). In some embodiments, each batch that is loaded has exactly one corresponding entry 3622 logged in the loading tracking table 3612. In some embodiments, the entry for a given batch can optionally be logged without modification, based on being logged only after loading of the given batch completed or after a fatal error occurred in loaded the given batch, tracking progress of loading over time based on addition of entries denoting new batches have completed loading. In other embodiments, the entry for a given batch can optionally be updated multiple times, for example, after loading of the given batch initiated and prior to completion, to current track progress of loading of the given batch over time.

The set of columns of loading tracking table 3612 can include a batch identifier column 3631 (e.g. having column name “batch_id”). The batch identifier column 3631 can be implemented to have corresponding values 2708 having an integer datatype, indicating a corresponding batch identifier for a corresponding batch (e.g. corresponding loading batch 2932), for example, as a user-facing identifier and/or a monotonically increasing identifier. For example, a monotonically increasing integer is utilized to identify batches instead of a UUID to be more useful to users viewing/querying the table 3612.

The set of columns of loading tracking table 3612 can alternatively or additionally include an extractor task identifier column 3632 (e.g. having column name “extractor_task_id”), The extractor task identifier column 3632 can be implemented to have corresponding values 2708 having a UUID datatype identifying a corresponding extractor task 3409 (e.g. corresponding loading module 2510) assigned to process the given batch denoted in the batch identifier column 3631.

The set of columns of loading tracking table 3612 can alternatively or additionally include a time started column 3633 (e.g. having column name “started”), The time started column 3633 can be implemented to have corresponding values 2708 having a timestamp datatype identifying a corresponding start time of loading the given batch denoted in the batch identifier column 3631 via a corresponding extractor task 3409 identified in the extractor task column 3632.

The set of columns of loading tracking table 3612 can alternatively or additionally include a time ended column 3634 (e.g. having column name “ended”), The time ended column 3634 can be implemented to have corresponding values 2708 having a timestamp datatype identifying a corresponding end time of loading the given batch denoted in the batch identifier column 3631 via a corresponding extractor task 3409 identified in the extractor task column 3632.

The set of columns of loading tracking table 3612 can alternatively or additionally include a latency column 3635 (e.g. having column name “latency”), The latency column 3635 can be implemented to have corresponding values 2708 identifying a difference between start and end time (e.g. the value of time ended column 3634 minus the value of time started column 3633).

The set of columns of loading tracking table 3612 can alternatively or additionally include a number of loaded files column 3636 (e.g. having column name “num_loaded_files”), The number of loaded files column 3636 can be implemented to have corresponding values 2708 having a integer or other numeric datatype identifying a corresponding number of files loaded for the given batch denoted in the batch identifier column 3631 (e.g. so far if the loading of the given batch is not yet complete, or in total once the batch loading is complete).

The set of columns of loading tracking table 3612 can alternatively or additionally include a number of errors column 3637 (e.g. having column name “num_errors”), The number of errors column 3637 can be implemented to have corresponding values 2708 having an integer datatype identifying a number of errors (e.g. number of record-level errors and/or file-level errors, optionally denoting whether continuing on unrecoverable errors occurred encountered in loading the given batch denoted in the batch identifier column 3631 (e.g. so far if the loading of the given batch is not yet complete, or in total once the batch loading is complete).

The set of columns of loading tracking table 3612 can alternatively or additionally include a rows pushed column 3638 (e.g. having column name “rows pushed”), rows pushed column 3638 can be implemented to have corresponding values 2708 having an integer datatype identifying a corresponding number of rows pushed in loading the given batch denoted in the batch identifier column 3631 (e.g. so far if the loading of the given batch is not yet complete, or in total once the batch loading is complete).

The set of columns of loading tracking table 3612 can alternatively or additionally include a bytes pushed column 3639 (e.g. having column name “bytes_pushed”), The bytes pushed column 3639 can be implemented to have corresponding values 2708 having a integer datatype identifying a corresponding number of bytes pushed in loading the given batch denoted in the batch identifier column 3631 (e.g. so far if the loading of the given batch is not yet complete, or in total once the batch loading is complete).

The set of columns of loading tracking table 3612 can alternatively or additionally include a last loaded file modification time column 3640 (e.g. having column name “last_loaded_file mtime”), The last loaded file modification time column 3640 can be implemented to have corresponding values 2708 having a timestamp datatype or other datatype identifying modification time of the last loaded file of the given batch denoted in the batch identifier column 3631 (e.g. indicating freshness/recency of data of the given batch).

The set of columns of loading tracking table 3612 can alternatively or additionally include a last loaded offset column 3641 (e.g. having column name “last loaded offset”), The last loaded offset column 3641 can be implemented to have corresponding values 2708 identifying a corresponding offset of a last loaded target (e.g. file) the given batch denoted in the batch identifier column 3631.

The set of columns of loading tracking table 3612 can alternatively or additionally include a high watermark column 3642 (e.g. having column name “high watermark”), The high watermark column 3642 can be implemented to have corresponding values 2708 indicating a total number of targets in a corresponding event queue (e.g. in table 3411 and/or in requests queue 3432).

FIG. 27C illustrates an embodiment of error tracking table 3613. Some or all features and/or functionality of error tracking table 3613 of FIG. 27C can implement the error tracking table 3613 of FIG. 27A and/or any other embodiment of error tracking table described herein.

Entries 3623 can have values for some or all columns of the table 3613. For example, the error tracking table 3613 is implemented as a relational database table of rows and columns. Each entry can have values for a set of columns to log error metrics associated with errors encountered with loading of a given batch (e.g. loading batch 2932). In some embodiments, a given batch can have multiple entries in error tracking table based on multiple different errors occurring in loading the given batch. In some embodiments, another given batch has no entries in error tracking table based on not encountering any errors in loading.

The set of columns of error tracking table 3613 can include a batch identifier column 3651 (e.g. having column name “batch_id”). The batch identifier column 3651 can be implemented to have corresponding values 2708 having an integer datatype, indicating a corresponding batch identifier for a corresponding batch having an error logged in the given entry 3623.

The set of columns of error tracking table 3613 can alternatively or additionally include an extractor task identifier column 3652 (e.g. having column name “extractor_task id”), The extractor task identifier column 3652 can be implemented to have corresponding values 2708 having a UUID datatype identifying a corresponding extractor task 3409 (e.g. corresponding loading module 2510) assigned to process the given batch having the error logged in the given entry 3623.

The set of columns of error tracking table 3613 can alternatively or additionally include a file name column 3653 (e.g. having column name “file_name”), The file name column 3653 can be implemented to have corresponding values 2708 having identifying a unique loading target (e.g. given file) in the given batch having the error logged in the given entry 3623 based on this particular file failing to load (e.g. encountering a file-level error, where record-level errors optionally aren't logged when rectified in the loading process and/or where record-level errors are logged with the name of the corresponding file containing the respective records).

The set of columns of error tracking table 3613 can alternatively or additionally include an error detail column 3654 (e.g. having column name “error_detail”), The error detail column 3654 can be implemented to have corresponding values 2708 characterizing the error (e.g. type of error, etc.)

The set of columns of error tracking table 3613 can alternatively or additionally include a failure time column 3655 (e.g. having column name “failed at”), The failure time column 3655 can be implemented to have corresponding values 2708 having a timestamp datatype identifying a corresponding time the error logged in the given entry 3623 occurred.

FIG. 27D illustrates an embodiment of a database system that implements a request processing module 3914 to process requests 3614.A indicating queries against loading tracking table and/or requests 3614.B indicating queries against error tracking table 3613 (and/or requests indicating queries against both tables). The corresponding responses can indicate query resultants regarding the respective tables. For example, these queries involve simply emitting all entries of table, filtering entries of the table based on certain criteria (e.g. which batches were loaded/errors occurred in the last 30 minutes), aggregating some or all entries (e.g. how many batches were loaded), etc. These queries can be optionally implemented as SQL expressions indicated in the requests 3614 for execution (e.g. via some or all features and/or functionality of query execution module 2504, where the tables are stored and accessed in system table memory resources 3609 rather than in segments across drives on nodes 37). User entities 2012 (e.g. users associated with loading the data, administrators of the database system, etc.) can otherwise view tables in whole, or can view filtered/aggregated contents of these tables (e.g. user entities view the raw/filtered/aggregated contents of the tables based on the respective data being displayed via a display device of a corresponding computing device associated with the user entity that the respective data was sent to in a response).

FIG. 27E illustrates a method for execution by at least one processing module of a database system 10. For example, the database system 10 can utilize at least one processing module of one or more nodes 37 of one or more computing devices 18, where the one or more nodes execute operational instructions stored in memory accessible by the one or more nodes, and where the execution of the operational instructions causes the one or more nodes 37 to execute, independently or in conjunction, the steps of FIG. 27E, for example, based on participating in execution of a query being executed by the database system 10. Some or all of the method of FIG. 27E can be performed by nodes executing a loading operation, for example, via one or more nodes 37 implemented as loading nodes 2510. In some embodiments, a node 37 can implement some or all of FIG. 26E based on implementing a corresponding plurality of processing core resources 48.1-48.W. Some or all of the steps of FIG. 27E can optionally be performed by any other one or more processing modules of the database system 10

Some or all steps of FIG. 27E can be performed in parallel and/or concurrently via a plurality of parallelized processing resources (e.g. implemented via a plurality of nodes 37 and/or a plurality of processing core resources 48). For example, multiple instances of any given step of FIG. 27E can be performed in parallel and/or concurrently via a plurality of parallelized processing resources, where each parallelized processing resource of the plurality of parallelized processing resources performs the given step in parallel with and/or concurrently with other ones of the plurality of parallelized processing resources also performing the given step. As another example, any given step of FIG. 27E can be performed based on a plurality of parallelized processing resources performing assigned portions of the given step in parallel and/or concurrently, where each parallelized processing resource of the plurality of parallelized processing resources performs their assigned portion of the step in parallel with and/or concurrently with other ones of the plurality of parallelized processing resources also performing their own assigned portions of the given step.

Some or all of the steps of FIG. 27E can be performed to implement some or all of the functionality of the database system 10 as described in conjunction with FIGS. 27A-27D, for example, by implementing some or all of the functionality of loading process 2605 to populate one or more tables. Some or all steps of FIG. 27E can be performed by database system 10 in accordance with other embodiments of the database system 10 and/or nodes 37 discussed herein. Some or all of the steps of FIG. 27E can be performed in conjunction with performing some or all steps of any other method described herein.

Step 2782 includes creating a continuous pipeline. Step 2784 includes maintaining a set of system metadata tables over a temporal period in conjunction with utilizing the continuous pipeline over the temporal period. In various examples, the set of system metadata tables includes a table of files and a loading tracking table. Step 2786 includes loading data for storage via the database system in conjunction with utilizing the continuous pipeline over the temporal period.

Performing step 2786 can include performing step 2788, step 2790, and/or step 2792. Step 2788 includes populating the table of files over the temporal period with a plurality of file data polled from a set of event topics. Step 2790 includes dispersing file data of the table of files across a plurality of batches for loading via execution of a plurality of extractor tasks. Step 2792 includes populating the loading tracking table over the temporal period with a plurality of loading tracking table entries that each include a set of metrics corresponding to one of the plurality of batches.

In various examples, the method further includes facilitating user entity access to the loading tracking table. In various examples, the user entity views at least one of the set of metrics for at least one of the plurality of batches based on the at least one of the set of metrics for at least one of the plurality of batches being displayed via a display device of a computing device corresponding to the user entity based on the facilitating the user entity access to the loading tracking table.

In various examples, facilitating the user entity access to the loading tracking table is based on executing a query against the loading tracking table to generate a query resultant. In various examples, the at least one of the set of metrics for at least one of the plurality of batches is included in the query resultant, and wherein the query is indicated in a query request configured by the user entity via user input and received from the computing device.

In various examples, the continuous pipeline is created in accordance with user-configured selections for a set of user-configurable parameters indicated in a continuous pipeline creation function call received in a previous request from the user entity.

In various examples, the set of metrics correspond to a set of loading metric columns of the loading tracking table.

In various examples, the set of loading metric columns includes a batch identifier column, wherein each of the plurality of loading tracking table entries is identified via a batch identifier for the one of the plurality of batches indicated in the batch identifier column. In various examples, the batch identifier is a monotonically increasing integer value corresponding to an ordering of the plurality of batches.

In various examples, the set of loading metric columns includes an extractor task identifier column. In various examples, at least one of the plurality of loading tracking table entries includes an extractor task identifier value for the extractor task identifier column identifying a corresponding one of the plurality of extractor tasks to which the one of the plurality of batches is assigned for loading.

In various examples, the set of loading metric columns includes a time started column. In various examples, at least one of the plurality of loading tracking table entries includes a time started value for the time started column indicating a corresponding timestamp that loading began for the one of the plurality of batches.

In various examples, the set of loading metric columns includes a time ended column. In various examples, the at least one of the plurality of loading tracking table entries includes a time ended value for the time started column indicating a corresponding timestamp that loading completed for the one of the plurality of batches.

In various examples, the set of loading metric columns includes a latency column. In various examples, the at least one of the plurality of loading tracking table entries includes a latency value for the latency column indicating an amount of time that loading of the one of the plurality of batches required from start to end.

In various examples, the one of the plurality of batches includes a set of files corresponding to a corresponding subset of the plurality of file data. In various examples, loading the one of the plurality of batches includes storing a corresponding set of rows indicated by the set of files.

In various examples, the set of loading metric columns includes a number of loaded files column. In various examples, at least one of the plurality of loading tracking table entries includes a number of loaded files value for the number of loaded files column indicating a corresponding number of files in set of files for the one of the plurality of batches that have been loaded.

In various examples, the set of loading metric columns includes a number of errors column. In various examples, the at least one of the plurality of loading tracking table entries includes a number of errors value for the number of errors column indicating a corresponding number of errors encountered in loading the set of files for the one of the plurality of batches.

In various examples, the set of loading metric columns includes a rows pushed column. In various examples, the at least one of the plurality of loading tracking table entries includes a rows pushed value for the rows pushed column indicating a corresponding number of rows pushed in loading the set of files for one of the plurality of batches.

In various examples, the set of loading metric columns includes a bytes pushed column. In various examples, the at least one of the plurality of loading tracking table entries includes a bytes pushed value for the bytes pushed column indicating a corresponding number of bytes pushed in loading the set of files for the one of the plurality of batches.

In various examples, the set of loading metric columns includes a last loaded file modification time column. In various examples, the at least one of the plurality of loading tracking table entries includes a last loaded file modification time value for the last loaded file modification time column indicating a corresponding time that a last loaded file in the set of files was last modified.

In various examples, the set of loading metric columns includes a last loaded offset column. In various examples, the at least one of the plurality of loading tracking table entries includes a last loaded offset value for the last loaded offset column indicating a corresponding offset for the last loaded file in the set of files.

In various examples, the set of loading metric columns includes a high watermark column. In various examples, at least one of the plurality of loading tracking table entries includes a high watermark value for the high watermark column indicating a total number of file data of the plurality of file data currently included in an event queue. In various examples, the table of files corresponds to file data included in the event queue.

In various examples, the set of system metadata tables further includes an error tracking table. In various examples, the method further includes populating the error tracking table over the temporal period with a plurality of error tracking table entries that each indicate a corresponding batch of the plurality of batches that encountered at least one corresponding error in loading the data for storage.

In various examples, the error tracking table includes a set of error metrics for each corresponding batch of the plurality of batches that encountered the at least one corresponding error in loading the data for storage.

In various examples, the set of error metrics correspond to a set of loading error columns of the error tracking table.

In various examples, the set of error metric columns includes a batch identifier column. In various examples, each of the plurality of error tracking table entries is identified via a batch identifier for one of the plurality of batches indicated in the batch identifier column based on the one of the plurality of batches encouraging the at least one corresponding error.

In various examples, the set of error metric columns includes an extractor task identifier column. In various examples, each of the plurality of error tracking table entries includes an extractor task identifier for the extractor task identifier column identifying a corresponding one of the plurality of extractor tasks to which the one of the plurality of batches is assigned for loading.

In various examples, the one of the plurality of batches includes a set of files corresponding to a corresponding subset of the plurality of file data. In various examples, loading the one of the plurality of batches includes storing a corresponding set of rows indicated by the set of files. In various examples, the set of error metric columns includes a file name column. In various examples, at least one of the plurality of error tracking table entries includes at least one file name identifier for the extractor task identifier column identifying a corresponding at least one file of the set of files of the one of the plurality of batches encountering a corresponding error.

In various examples, the set of error metric columns includes an error detail column. In various examples, at least one of the plurality of error tracking table entries includes error detail data for the error detail column characterizing the corresponding error for the one of the plurality of batches. In various examples, the set of error metric columns includes a failure time column. In various examples, the at least one of the plurality of error tracking table entries includes a failure time value for the failure time column indicating a timestamp at which the corresponding error occurred for the one of the plurality of batches.

In various examples, the set of system metadata tables are implemented as a first set of relational database tables. In various examples, loading the data for storage includes populating a second set of relational database tables with a plurality of rows indicated in the plurality of file data. In various examples, the method further includes: executing a first set of queries against the first set of relational database tables to generate a set of query resultants regarding at least some of set of metrics for at least some of the set of batches; and/or executing a second set of queries against the second set of relational database tables regarding the plurality of rows indicated in the plurality of file data.

In various embodiments, any one of more of the various examples listed above are implemented in conjunction with performing some or all steps of FIG. 27E. In various embodiments, any set of the various examples listed above can be implemented in tandem, for example, in conjunction with performing some or all steps of FIG. 27E, and/or in conjunction with performing some or all steps of any other method described herein.

In various embodiments, at least one memory device, memory section, and/or memory resource (e.g., a non-transitory computer readable storage medium) can store operational instructions that, when executed by one or more processing modules of one or more computing devices of a database system, cause the one or more computing devices to perform any or all of the method steps of FIG. 27E described above, for example, in conjunction with further implementing any one or more of the various examples described above.

In various embodiments, a database system includes at least one processor and at least one memory that stores operational instructions. In various embodiments, the operational instructions, when executed by the at least one processor, cause the database system to perform some or all steps of FIG. 27E, for example, in conjunction with further implementing any one or more of the various examples described above.

In various embodiments, the operational instructions, when executed by the at least one processor, cause the database system to: create a continuous pipeline; maintain a set of system metadata tables over a temporal period in conjunction with utilizing the continuous pipeline over the temporal period, wherein the set of system metadata tables includes a table of files and a loading tracking table; and/or load data for storage via the database system in conjunction with utilizing the continuous pipeline over the temporal period. In various embodiments, loading data for storage via the database system in conjunction with utilizing the continuous pipeline over the temporal period is based on: populating the table of files over the temporal period with a plurality of file data polled from a set of event topics; dispersing file data of the table of files across a plurality of batches for loading via execution of a plurality of extractor tasks, and/or populating the loading tracking table over the temporal period with a plurality of loading tracking table entries that each include a set of metrics corresponding to one of the plurality of batches.

As used herein, an “AND operator” can correspond to any operator implementing logical conjunction. As used herein, an “OR operator” can correspond to any operator implementing logical disjunction.

It is noted that terminologies as may be used herein such as bit stream, stream, signal sequence, etc. (or their equivalents) have been used interchangeably to describe digital information whose content corresponds to any of a number of desired types (e.g., data, video, speech, text, graphics, audio, etc. any of which may generally be referred to as ‘data’).

As may be used herein, the terms “substantially” and “approximately” provides an industry-accepted tolerance for its corresponding term and/or relativity between items. For some industries, an industry-accepted tolerance is less than one percent and, for other industries, the industry-accepted tolerance is 10 percent or more. Other examples of industry-accepted tolerance range from less than one percent to fifty percent. Industry-accepted tolerances correspond to, but are not limited to, component values, integrated circuit process variations, temperature variations, rise and fall times, thermal noise, dimensions, signaling errors, dropped packets, temperatures, pressures, material compositions, and/or performance metrics. Within an industry, tolerance variances of accepted tolerances may be more or less than a percentage level (e.g., dimension tolerance of less than +/−1%). Some relativity between items may range from a difference of less than a percentage level to a few percent. Other relativity between items may range from a difference of a few percent to magnitude of differences.

As may also be used herein, the term(s) “configured to”, “operably coupled to”, “coupled to”, and/or “coupling” includes direct coupling between items and/or indirect coupling between items via an intervening item (e.g., an item includes, but is not limited to, a component, an element, a circuit, and/or a module) where, for an example of indirect coupling, the intervening item does not modify the information of a signal but may adjust its current level, voltage level, and/or power level. As may further be used herein, inferred coupling (i.e., where one element is coupled to another element by inference) includes direct and indirect coupling between two items in the same manner as “coupled to”.

As may even further be used herein, the term “configured to”, “operable to”, “coupled to”, or “operably coupled to” indicates that an item includes one or more of power connections, input(s), output(s), etc., to perform, when activated, one or more its corresponding functions and may further include inferred coupling to one or more other items. As may still further be used herein, the term “associated with”, includes direct and/or indirect coupling of separate items and/or one item being embedded within another item.

As may be used herein, the term “compares favorably”, indicates that a comparison between two or more items, signals, etc., indicates an advantageous relationship that would be evident to one skilled in the art in light of the present disclosure, and based, for example, on the nature of the signals/items that are being compared. As may be used herein, the term “compares unfavorably”, indicates that a comparison between two or more items, signals, etc., fails to provide such an advantageous relationship and/or that provides a disadvantageous relationship. Such an item/signal can correspond to one or more numeric values, one or more measurements, one or more counts and/or proportions, one or more types of data, and/or other information with attributes that can be compared to a threshold, to each other and/or to attributes of other information to determine whether a favorable or unfavorable comparison exists. Examples of such an advantageous relationship can include: one item/signal being greater than (or greater than or equal to) a threshold value, one item/signal being less than (or less than or equal to) a threshold value, one item/signal being greater than (or greater than or equal to) another item/signal, one item/signal being less than (or less than or equal to) another item/signal, one item/signal matching another item/signal, one item/signal substantially matching another item/signal within a predefined or industry accepted tolerance such as 1%, 5%, 10% or some other margin, etc. Furthermore, one skilled in the art will recognize that such a comparison between two items/signals can be performed in different ways. For example, when the advantageous relationship is that signal 1 has a greater magnitude than signal 2, a favorable comparison may be achieved when the magnitude of signal 1 is greater than that of signal 2 or when the magnitude of signal 2 is less than that of signal 1. Similarly, one skilled in the art will recognize that the comparison of the inverse or opposite of items/signals and/or other forms of mathematical or logical equivalence can likewise be used in an equivalent fashion. For example, the comparison to determine if a signal X>5 is equivalent to determining if-X<−5, and the comparison to determine if signal A matches signal B can likewise be performed by determining-A matches -B or not(A) matches not(B). As may be discussed herein, the determination that a particular relationship is present (either favorable or unfavorable) can be utilized to automatically trigger a particular action. Unless expressly stated to the contrary, the absence of that particular condition may be assumed to imply that the particular action will not automatically be triggered. In other examples, the determination that a particular relationship is present (either favorable or unfavorable) can be utilized as a basis or consideration to determine whether to perform one or more actions. Note that such a basis or consideration can be considered alone or in combination with one or more other bases or considerations to determine whether to perform the one or more actions. In one example where multiple bases or considerations are used to determine whether to perform one or more actions, the respective bases or considerations are given equal weight in such determination. In another example where multiple bases or considerations are used to determine whether to perform one or more actions, the respective bases or considerations are given unequal weight in such determination.

As may be used herein, one or more claims may include, in a specific form of this generic form, the phrase “at least one of a, b, and c” or of this generic form “at least one of a, b, or c”, with more or less elements than “a”, “b”, and “c”. In either phrasing, the phrases are to be interpreted identically. In particular, “at least one of a, b, and c” is equivalent to “at least one of a, b, or c” and shall mean a, b, and/or c. As an example, it means: “a” only, “b” only, “c” only, “a” and “b”, “a” and “c”, “b” and “c”, and/or “a”, “b”, and “c”.

As may also be used herein, the terms “processing module”, “processing circuit”, “processor”, “processing circuitry”, and/or “processing unit” may be a single processing device or a plurality of processing devices. Such a processing device may be a microprocessor, micro-controller, digital signal processor, microcomputer, central processing unit, field programmable gate array, programmable logic device, state machine, logic circuitry, analog circuitry, digital circuitry, and/or any device that manipulates signals (analog and/or digital) based on hard coding of the circuitry and/or operational instructions. The processing module, module, processing circuit, processing circuitry, and/or processing unit may be, or further include, memory and/or an integrated memory element, which may be a single memory device, a plurality of memory devices, and/or embedded circuitry of another processing module, module, processing circuit, processing circuitry, and/or processing unit. Such a memory device may be a read-only memory, random access memory, volatile memory, non-volatile memory, static memory, dynamic memory, flash memory, cache memory, and/or any device that stores digital information. Note that if the processing module, module, processing circuit, processing circuitry, and/or processing unit includes more than one processing device, the processing devices may be centrally located (e.g., directly coupled together via a wired and/or wireless bus structure) or may be distributedly located (e.g., cloud computing via indirect coupling via a local area network and/or a wide area network). Further note that if the processing module, module, processing circuit, processing circuitry and/or processing unit implements one or more of its functions via a state machine, analog circuitry, digital circuitry, and/or logic circuitry, the memory and/or memory element storing the corresponding operational instructions may be embedded within, or external to, the circuitry comprising the state machine, analog circuitry, digital circuitry, and/or logic circuitry. Still further note that, the memory element may store, and the processing module, module, processing circuit, processing circuitry and/or processing unit executes, hard coded and/or operational instructions corresponding to at least some of the steps and/or functions illustrated in one or more of the Figures. Such a memory device or memory element can be included in an article of manufacture.

One or more embodiments have been described above with the aid of method steps illustrating the performance of specified functions and relationships thereof. The boundaries and sequence of these functional building blocks and method steps have been arbitrarily defined herein for convenience of description. Alternate boundaries and sequences can be defined so long as the specified functions and relationships are appropriately performed. Any such alternate boundaries or sequences are thus within the scope and spirit of the claims. Further, the boundaries of these functional building blocks have been arbitrarily defined for convenience of description. Alternate boundaries could be defined as long as the certain significant functions are appropriately performed. Similarly, flow diagram blocks may also have been arbitrarily defined herein to illustrate certain significant functionality.

To the extent used, the flow diagram block boundaries and sequence could have been defined otherwise and still perform the certain significant functionality. Such alternate definitions of both functional building blocks and flow diagram blocks and sequences are thus within the scope and spirit of the claims. One of average skill in the art will also recognize that the functional building blocks, and other illustrative blocks, modules and components herein, can be implemented as illustrated or by discrete components, application specific integrated circuits, processors executing appropriate software and the like or any combination thereof.

In addition, a flow diagram may include a “start” and/or “continue” indication. The “start” and “continue” indications reflect that the steps presented can optionally be incorporated in or otherwise used in conjunction with one or more other routines. In addition, a flow diagram may include an “end” and/or “continue” indication. The “end” and/or “continue” indications reflect that the steps presented can end as described and shown or optionally be incorporated in or otherwise used in conjunction with one or more other routines. In this context, “start” indicates the beginning of the first step presented and may be preceded by other activities not specifically shown. Further, the “continue” indication reflects that the steps presented may be performed multiple times and/or may be succeeded by other activities not specifically shown. Further, while a flow diagram indicates a particular ordering of steps, other orderings are likewise possible provided that the principles of causality are maintained.

The one or more embodiments are used herein to illustrate one or more aspects, one or more features, one or more concepts, and/or one or more examples. A physical embodiment of an apparatus, an article of manufacture, a machine, and/or of a process may include one or more of the aspects, features, concepts, examples, etc. described with reference to one or more of the embodiments discussed herein. Further, from figure to figure, the embodiments may incorporate the same or similarly named functions, steps, modules, etc. that may use the same or different reference numbers and, as such, the functions, steps, modules, etc. may be the same or similar functions, steps, modules, etc. or different ones.

Unless specifically stated to the contra, signals to, from, and/or between elements in a figure of any of the figures presented herein may be analog or digital, continuous time or discrete time, and single-ended or differential. For instance, if a signal path is shown as a single-ended path, it also represents a differential signal path. Similarly, if a signal path is shown as a differential path, it also represents a single-ended signal path. While one or more particular architectures are described herein, other architectures can likewise be implemented that use one or more data buses not expressly shown, direct connectivity between elements, and/or indirect coupling between other elements as recognized by one of average skill in the art.

The term “module” is used in the description of one or more of the embodiments. A module implements one or more functions via a device such as a processor or other processing device or other hardware that may include or operate in association with a memory that stores operational instructions. A module may operate independently and/or in conjunction with software and/or firmware. As also used herein, a module may contain one or more sub-modules, each of which may be one or more modules.

As may further be used herein, a computer readable memory includes one or more memory elements. A memory element may be a separate memory device, multiple memory devices, or a set of memory locations within a memory device. Such a memory device may be a read-only memory, random access memory, volatile memory, non-volatile memory, static memory, dynamic memory, flash memory, cache memory, a quantum register or other quantum memory and/or any other device that stores data in a non-transitory manner. Furthermore, the memory device may be in a form of a solid-state memory, a hard drive memory or other disk storage, cloud memory, thumb drive, server memory, computing device memory, and/or other non-transitory medium for storing data. The storage of data includes temporary storage (i.e., data is lost when power is removed from the memory element) and/or persistent storage (i.e., data is retained when power is removed from the memory element). As used herein, a transitory medium shall mean one or more of: (a) a wired or wireless medium for the transportation of data as a signal from one computing device to another computing device for temporary storage or persistent storage; (b) a wired or wireless medium for the transportation of data as a signal within a computing device from one element of the computing device to another element of the computing device for temporary storage or persistent storage; (c) a wired or wireless medium for the transportation of data as a signal from one computing device to another computing device for processing the data by the other computing device; and (d) a wired or wireless medium for the transportation of data as a signal within a computing device from one element of the computing device to another element of the computing device for processing the data by the other element of the computing device. As may be used herein, a non-transitory computer readable memory is substantially equivalent to a computer readable memory. A non-transitory computer readable memory can also be referred to as a non-transitory computer readable storage medium.

One or more functions associated with the methods and/or processes described herein can be implemented via a processing module that operates via the non-human “artificial” intelligence (AI) of a machine. Examples of such AI include machines that operate via anomaly detection techniques, decision trees, association rules, expert systems and other knowledge-based systems, computer vision models, artificial neural networks, convolutional neural networks, support vector machines (SVMs), Bayesian networks, genetic algorithms, feature learning, sparse dictionary learning, preference learning, deep learning and other machine learning techniques that are trained using training data via unsupervised, semi-supervised, supervised and/or reinforcement learning, and/or other AI. The human mind is not equipped to perform such AI techniques, not only due to the complexity of these techniques, but also due to the fact that artificial intelligence, by its very definition—requires “artificial” intelligence—i.e. machine/non-human intelligence.

One or more functions associated with the methods and/or processes described herein can be implemented as a large-scale system that is operable to receive, transmit and/or process data on a large-scale. As used herein, a large-scale refers to a large number of data, such as one or more kilobytes, megabytes, gigabytes, terabytes or more of data that are received, transmitted and/or processed. Such receiving, transmitting and/or processing of data cannot practically be performed by the human mind on a large-scale within a reasonable period of time, such as within a second, a millisecond, microsecond, a real-time basis or other high speed required by the machines that generate the data, receive the data, convey the data, store the data and/or use the data.

One or more functions associated with the methods and/or processes described herein can require data to be manipulated in different ways within overlapping time spans. The human mind is not equipped to perform such different data manipulations independently, contemporaneously, in parallel, and/or on a coordinated basis within a reasonable period of time, such as within a second, a millisecond, microsecond, a real-time basis or other high speed required by the machines that generate the data, receive the data, convey the data, store the data and/or use the data.

One or more functions associated with the methods and/or processes described herein can be implemented in a system that is operable to electronically receive digital data via a wired or wireless communication network and/or to electronically transmit digital data via a wired or wireless communication network. Such receiving and transmitting cannot practically be performed by the human mind because the human mind is not equipped to electronically transmit or receive digital data, let alone to transmit and receive digital data via a wired or wireless communication network.

One or more functions associated with the methods and/or processes described herein can be implemented in a system that is operable to electronically store digital data in a memory device. Such storage cannot practically be performed by the human mind because the human mind is not equipped to electronically store digital data.

One or more functions associated with the methods and/or processes described herein may operate to cause an action by a processing module directly in response to a triggering event—without any intervening human interaction between the triggering event and the action. Any such actions may be identified as being performed “automatically”, “automatically based on” and/or “automatically in response to” such a triggering event. Furthermore, any such actions identified in such a fashion specifically preclude the operation of human activity with respect to these actions—even if the triggering event itself may be causally connected to a human activity of some kind.

While particular combinations of various functions and features of the one or more embodiments have been expressly described herein, other combinations of these features and functions are likewise possible. The present disclosure is not limited by the particular examples disclosed herein and expressly incorporates these other combinations.

What is claimed is:

1. A method for execution by a database system, comprising:
creating a continuous pipeline;
loading data for storage via the database system in conjunction with utilizing the continuous pipeline over a temporal period based on:
implementing an event monitor module based on:
executing a plurality of polls to a set of event topics of a set of other monitors over the temporal period to poll a plurality of sets of messages from the set of event topics, wherein each poll of the plurality of polls is executed to poll a corresponding set of messages of the plurality of sets of messages from a corresponding one of the set of event topics; and
adding a plurality of file data to a table of files over the temporal period based on processing the plurality of sets of messages, wherein each set of messages of the plurality of sets of messages is processed to add corresponding file data of the plurality of file data to the table of files; and
implementing a continuous pipeline task execution module to execute a continuous pipeline task based on:
dispersing file data of the table of files into a plurality of file work units over the temporal period; and
generating a plurality of extractor tasks to load the data for storage based on collectively processing the plurality of file work units.

2. The method of claim 1, wherein the set of other monitors includes multiple monitors of multiple monitor types, and wherein polling the messages from the set of event topics includes interfacing with each of the multiple monitors in accordance with a corresponding protocol for a corresponding one of the multiple monitor types.

3. The method of claim 2, wherein interfacing with a first monitor of the set of monitors includes:
executing a first subset of the plurality of polls to a corresponding first subset of the set of event topics corresponding to the first monitor, wherein each poll of the first subset of the plurality of polls is executed to poll a corresponding set of messages of a first subset of the plurality of sets of messages from a corresponding one of the corresponding first subset of the set of event topics; and
after adding each corresponding file data to the table of files in response to processing each corresponding set of based messages of the first subset of the plurality of sets of messages, sending a request to the first monitor to delete the each corresponding set of messages of the first subset of the plurality of sets of messages.

4. The method of claim 3, wherein the set of corresponding set of messages of the first subset of the plurality of sets of messages polled via the each poll includes up to a predetermined maximum number of messages configured for interfacing with the first monitor.

5. The method of claim 3, wherein a predetermined visibility timeout configured for interfacing with the first monitor is applied for deleting each corresponding set of messages of the first subset of the plurality of sets of messages polled via the each poll each poll of the first subset of the plurality of polls, and wherein, when the each corresponding set of messages is not deleted within the predetermined visibility timeout, the corresponding set of messages becomes again available for polling from the corresponding one of the corresponding first subset of the set of event topics.

6. The method of claim 3, wherein the multiple monitor types includes:
a Simple Queue Service (SQS) monitor type, wherein a first one of the multiple monitors is an SQS monitor having the SQS monitor type; and
a Kafka monitor type, wherein a second one of the multiple monitors is a Kafka monitor having the Kafka monitor type.

7. The method of claim 1, wherein loading data for storage via the database system in conjunction with utilizing the continuous pipeline over a temporal period is further based on:
deduplicating the plurality of file data based on identifying duplicate ones of the plurality of file data.

8. The method of claim 1, further comprising:
suspending the loading of data for storage via the database system at a first time during the temporal period based on pausing utilization of the continuous pipeline at the first time; and
resuming the loading of data for storage via the database system at a second time during the temporal period based on restating utilization of the continuous pipeline at the second time.

9. The method of claim 8, wherein resuming the loading of data for storage is based on processing a start continuous pipeline function call received in a request from a user entity.

10. The method of claim 8, wherein loading the data for storage via the database system in conjunction with utilizing the continuous pipeline over the temporal period is further based on:
maintaining state data for the event monitor module, wherein resuming the loading of data for storage via the database system at the second time is based on accessing the state data for the event monitor module.

11. The method of claim 10, wherein maintaining the state data includes updating, in response to processing the each set of messages, at least one of
a file count value;
a file total size value;
a lasted loaded offset value; or
a high watermark value.

12. The method of claim 8, wherein the loading of data for storage via the database system is suspended at the first time in response to encountering an error.

13. The method of claim 1, wherein the table of files is maintained as a relational database table stored in system metadata of the database system.

14. The method of claim 13, further comprising maintaining a plurality of additional relational database tables in the system metadata that includes:
a loading tracking table indicating at least one loading metric tracked in conjunction with loading the data; and
an error tracking table indicating at least one error encountered in conjunction with loading the data.

15. The method of claim 14, wherein the data is loaded across a plurality of batches, wherein each batch includes a corresponding subset of the plurality of file work units and is loaded by a corresponding one of the plurality of extractor tasks, wherein the loading tracking table is populated with a first plurality of entries based on logging a corresponding entry of the first plurality of entries in response to processing each batch of the plurality of batches, and wherein the error tracking table is populated with a second plurality of entries based on logging a corresponding entry of the second plurality of entries in response encounter in loading a batch of the plurality of batches.

16. The method of claim 1, wherein implementing the event monitor module includes generating event notifications based on at least one of:
generating a modification time-based file data listing based on filtering out file data of the plurality of file data with a last modification time outside a configured modification time range; or
generating a file name-based file data listing based on sorting the file data of the plurality of file data by file name.

17. The method of claim 1, wherein the continuous pipeline is created in accordance with user-configured selections for a set of user-configurable parameters indicated in a continuous pipeline creation function call received in a request from a user entity.

18. The method of claim 1, wherein the set of user-configured selections includes at least one of:
a selected monitor type for a monitor type parameter of the set of user-configurable parameters;
a selected polling interval for a polling interval parameter of the set of user-configurable parameters;
a selected minimum update size for a minimum update size parameter of the set of user-configurable parameters;
a selected update timeout parameter for an update timeout parameter of the set of user-configurable parameters;
a selected batch timeout for a batch timeout parameter of the set of user-configurable parameters; or
a selected batch minimum file count for a batch minimum file count parameter of the set of user-configurable parameters.

19. A database system includes:
at least one processor; and
at least one memory storing operational instructions that, when executed by the at least one processor, causes the database system to:
create a continuous pipeline;
load data for storage via the database system in conjunction with utilizing the continuous pipeline over a temporal period based on:
implementing an event monitor module based on:
executing a plurality of polls to a set of event topics of a set of other monitors over the temporal period to poll a plurality of sets of messages from the set of event topics, wherein each poll of the plurality of polls is executed to poll a corresponding set of messages of the plurality of sets of messages from a corresponding one of the set of event topics; and
adding a plurality of file data to a table of files over the temporal period based on processing the plurality of sets of messages, wherein each set of messages of the plurality of sets of messages is processed to add corresponding file data of the plurality of file data to the table of files; and
implementing a continuous pipeline task execution module to execute a continuous pipeline task based on:
partitioning file data of the table of files into a plurality of file work units over the temporal period; and
generating a plurality of extractor tasks to load the data for storage based on collectively processing the plurality of file work units.

20. A non-transitory computer readable storage medium comprises:
at least one memory section that stores operational instructions that, when executed by at least one processing module that includes a processor and a memory, causes the at least one processing module to:
create a continuous pipeline;
load data for storage in conjunction with utilizing the continuous pipeline over a temporal period based on:
implementing an event monitor module based on:
executing a plurality of polls to a set of event topics of a set of other monitors over the temporal period to poll a plurality of sets of messages from the set of event topics, wherein each poll of the plurality of polls is executed to poll a corresponding set of messages of the plurality of sets of messages from a corresponding one of the set of event topics; and
adding a plurality of file data to a table of files over the temporal period based on processing the plurality of sets of messages, wherein each set of messages of the plurality of sets of messages is processed to add corresponding file data of the plurality of file data to the table of files; and
implementing a continuous pipeline task execution module to execute a continuous pipeline task based on:
partitioning file data of the table of files into a plurality of file work units over the temporal period; and
generating a plurality of extractor tasks to load the data for storage based on collectively processing the plurality of file work units.
